(19) United States
(12) Patent Application Publication
(10) Pub. No.: US 2026/0192535 A1
(43) Pub. Date: Jul. 9, 2026

(54) METHOD FOR MANUFACTURING AT LEAST ONE OPTICAL ELEMENT, PARTICULARLY AT LEAST ONE OPTICAL ELEMENT FOR AN AUGMENTED AND/OR VIRTUAL REALITY DEVICE, AND/OR AN AUGMENTED AND/OR VIRTUAL REALITY DEVICE

(71) Applicant: XOLO GMBH, Berlin (DE)

(72) Inventors: Dirk Radzinski, Berlin (DE); Yves Garmshausen, Berlin (DE); Martin Herder, Berlin (DE); Niklas König, Berlin (DE); MARCUS REUTER, Berlin (DE)

(73) Assignee: XOLO GMBH, Berlin (DE)

(21) Appl. No.: 19/554,980

(22) Filed: Mar. 3, 2026

Related U.S. Application Data
(63) Continuation-in-part of application No. 19/104,772, filed on Feb. 27, 2024.

(30) Foreign Application Priority Data
Feb. 28, 2023 (DE) 10 2023 104 907.0

(51) Int. Cl. B29D 11/00; B29C 64/124; B29C 64/393; B29L 11/00; B33Y 10/00; B33Y 30/00; B33Y 40/20; B33Y 50/02; B33Y 80/00

(52) U.S. Cl. CPC B29D 11/00951; B29C 64/124; B29C 64/393; B33Y 10/00; B33Y 30/00; B33Y 40/20; B33Y 50/02; B33Y 80/00; B29L 2011/00

(57) ABSTRACT

A method for manufacturing at least one optical element for an augmented and/or virtual reality device.

### FIELD OF INVENTION

The invention relates to a method for manufacturing at least one optical element, particularly at least one optical element for an augmented and/or virtual reality device, and/or an augmented and/or virtual reality device, comprising at least one optical element.

### BACKGROUND ART

Manufacturing techniques for manufacturing optical elements, particularly optical elements for an augmented reality device and/or for a virtual reality device, such as e.g. smart glasses, have been generally known in the art. Known techniques for manufacturing respective optical elements comprise the implementation of established manufacturing techniques, such as particularly molding techniques, more particularly injection molding techniques.

While known manufacturing techniques generally facilitate manufacturing respective optical elements with good properties, there exists a need for further advanced manufacturing techniques for manufacturing respective optical elements which provide advantages over existing manufacturing techniques. Particularly, there exists a need for further advanced manufacturing techniques for manufacturing respective optical elements which allow for an efficient manufacturing, higher design freedom, and improved properties of the manufactured optical elements.

It is therefore, the object of the invention to provide an improved method for manufacturing at least one optical element, particularly at least one optical element for an augmented and/or virtual reality device, and/or an augmented and/or virtual reality device, comprising at least one optical element.

### SUMMARY OF THE INVENTION

A first aspect of the invention relates to a method for manufacturing at least one optical element, particularly at least one optical element for an augmented and/or virtual reality device. As such, the at least one optical element manufactured in accordance with the method can be used in an augmented reality device and/or a virtual reality device. The method can thus, be directed to a principle for manufacturing at least one optical element for an augmented reality device (hereinafter also referred to as “AR device”) and/or for a virtual reality device (hereinafter also referred to as “VR device”).

Non-limiting examples of a respective AR device and/or VR device generally comprise portable AR devices and/or VR devices, head-worn AR devices and/or VR devices, head-mounted AR devices and/or VR devices, etc. More concrete, yet still non-limiting examples of a respective AR device and/or VR device comprise glasses, particularly smart glasses, headsets, smartphones, tablets, laptops, televisions, particularly smart televisions, etc.

The method particularly, comprises implementing a volumetric printing process for manufacturing the at least one optical element. The volumetric printing process comprises irradiating a photopolymerizable material with light of the at least one wavelength or at least one wavelength range in a working volume. Notably, the expression “at least one first wavelength” also comprises “only one wavelength” such that the expression “at least one first wavelength” as used herein does not necessarily mean that the photopolymerizable material is also irradiated with light of a further wavelength or a further wavelength range, respectively. As such, the volumetric printing process can comprise irradiating the photopolymerizable material with light of only one wavelength or only one wavelength range in a working volume.

The terms “photocurable resin” and “photopolymerizable material” can be used interchangeably herein.

Particularly, the volumetric printing process can comprise irradiating the photopolymerizable material with light of the at least one wavelength in a working volume, wherein the working volume is moved relative to a radiation device of a volumetric printing apparatus, the at least one radiation device emitting the light of the at least one wavelength during the volumetric printing process. As such, the volumetric printing process can be a process in which the working volume is moved relative to at least one radiation device emitting the light of the at least one wavelength during the volumetric printing process. A respective motion of the working volume can be a translation motion along one or more translation axes, as implemented in so-called xolography processes or parallax volumetric manufacturing processes, and/or a rotational motion about a rotational axis, as implemented in computed axial lithography, CAL, processes, for instance. Such a volumetric printing process and/or apparatus for implementing such a volumetric printing process can be an independent aspect of the invention.

Particularly, the volumetric printing process can be a process in which one or more radiation devices are arranged on at least one support structure, wherein the at least one support structure is moveable relative to the working volume, which comprises the photopolymerizable material, in a first degree of freedom of motion, particularly in a plane above or below the working volume. Particularly, the one or more radiation devices can also be movable supported relative to the at least one support structure, particularly in a second degree of freedom of motion different from the first degree of freedom of motion. As an example, a respective first degree of freedom of motion can comprise a translatory motion in a first motion direction and a respective second degree of freedom of motion can comprise a second translatory motion in a second motion direction different from the first motion direction, particularly transverse to the first motion direction. Notably, a plurality of respective support structures can be provided, wherein each support structure supports at least one radiation device. Such a volumetric printing process and/or apparatus for implementing such a volumetric printing process can be an independent aspect of the invention.

Alternatively, the volumetric printing process can comprise irradiating the photopolymerizable material with light of the at least one wavelength in a working volume, wherein the working volume is not moved relative to at least one radiation device of a volumetric printing apparatus, the at least one radiation device emitting the light of the at least one wavelength during the volumetric printing process. As such, the volumetric printing process can be a process in which the working volume is not moved relative to at least one radiation device emitting the light of the at least one wavelength during the volumetric printing process. Such a volumetric printing process and/or apparatus for implementing such a volumetric printing process can be an independent aspect of the invention.

Generally, the volumetric printing process can comprise irradiating a working volume comprising the photopolymerizable material with light of a specific wavelength, which can comprise the first or further wavelength, from at least two different directions with a specific intensity or intensity distribution, respectively, wherein a polymerization of the photopolymerizable material occurs according to the resulting intensity distribution within the working volume. In an exemplary embodiment, irradiating the photopolymerizable material from the at least two different directions can comprise or can be achieved by at least one of: motion of the working volume relative to at least one radiation device emitting the light of the specific wavelength, wherein the at least one radiation device is static and not moveable, respectively and/or motion of at least one radiation device emitting the light of the specific wavelength relative to the working volume, wherein the working volume is static and not moveable, respectively. As such, the working volume and/or the at least one radiation device can be moveably supported in at least one degree of freedom of motion which can be or comprise a translatory and/or rotatory degree of freedom of motion. In another exemplary embodiment, irradiating the photopolymerizable material from at least two directions can comprise or can be achieved by irradiating a first light projection of first light images, particularly a sequence of first light images, particularly by at least one first radiation device, such as e.g. a first light projection device, into the working volume and irradiate a second light projection of at least one second light image, particularly at least one second light image in the shape of a straight line, particularly a horizontally or vertically oriented straight line, particularly by at least one second radiation device, such as e.g. a second light projection device, into the working volume, wherein the propagation direction of the light of the second light projection is at an angle of ca. 90° relative to the propagation direction of the light of the first light projection, and wherein the at least one second light image moves in a direction perpendicular to the propagation direction of the light of the second light projection. In either embodiment, irradiating the photopolymerizable material can be effected simultaneously or sequentially with moving the working volume relative to the at least one radiation device.

Typically, the resulting intensity distribution within the working volume depends from the intensity of the light, the irradiation direction, the irradiation location, and the absorption properties of the photopolymerizable material and the photopolymerized material, respectively. As such, the volumetric printing process can comprise irradiating the photopolymerizable material with light of at least one wavelength emitted from at least two directions, i.e. a first and a second direction, via one radiation device source, particularly one single radiation device. As an example, the first and second directions can be substantially orthogonal directions. As an example, the first direction can impinge on the surface of the photopolymerizable material at a first angle and the second direction can impinge on the surface of the photopolymerizable material at a second angle, which can be different from the first angle. As an example, the light emitted in/from the first direction can at least partially overlap with the light emitted in/from the second direction. Particularly, the (continuous) irradiation of the photopolymerizable material from at least two directions can result in generating portions of high accumulated intensity, particularly portions of high accumulated intensity in which the photopolymerizable material cures. Such a volumetric printing process and/or apparatus for implementing such a volumetric printing process can be an independent aspect of the invention.

Further, the volumetric printing process can comprise projecting one or more light images of light of a specific wavelength or wavelength range in one or more directions into the working volume. Each projected light image can comprise a plurality of image elements, such as e.g. pixels. Each image element can have a specific light intensity. At least two image elements of at least one light image can comprise different intensities, particularly different intensities each being different from zero. Additionally or alternatively, at least one image element of a first light image can have a different intensity than at least one image element of at least one further light image, particularly wherein the at least one image element of the first light image and the at least one image element of the at least one further light image each have an intensity different from zero. Particularly, the method can comprise modulating the intensity of at least one image element of at least one light image relative to the intensity of at least one other image element of the respective light image. Such a modulation can be implemented by applying one or more intensity profiles to the at least one light image. Additionally or alternatively, the method can comprise modulating the intensity of at least one image element of a first light image relative to the intensity of at least one image element of at least one further light image, particularly wherein the at least one image element of a first light image and the at least one image element of at least one further light image each have an intensity different from zero. Such a modulation can also be implemented by applying one or more intensity profiles to at least one of the first light image and the at least one further light image. Particularly, the at least one first light image can be irradiated towards the working volume from a first position, particularly a first angular position with respect to an axis of the working volume, and the at least one further light image can be irradiated towards the working volume from at least one further position, particularly at least one further angular position with respect to the axis of the working volume. As such, modulating the intensity of at least one image element of a first light image and at least one further light image, wherein the first light image and the at least one further light image are irradiated towards the working volume from different positions and different directions, respectively can enable generating one or more specific intensity distributions within the working volume, particularly one or more specific intensity distributions from different directions. Respective intensity distributions can enable that one or more voxels within the working volume obtain a resulting intensity which meets or exceeds a threshold intensity required for curing the photocurable resin at the respective one or more voxels. This can particularly, apply when volumetric printing process comprises computed axial lithography or parallax additive manufacturing (e.g. as set forth further below).

Each of the aforementioned principles can comprise or be implemented as so-called gray-scaling. Gray-scaling can e.g. be beneficial as it enables compensating for attenuation of the intensity due to absorption and/or scattering of the light of the first wavelength and/or the or a second wavelength in the working volume. Particularly, gray-scaling can compensate for attenuation of the intensity due to absorption and/or scattering of a light sheet of the light of the first wavelength in the working volume in at least one direction, such as e.g. a vertical direction. For example, gray-scaling can be implemented by projecting a light image of the light of the second wavelength, wherein image elements in the center of the light image comparatively have higher intensities and image elements of the light image at the edges of the light image, particularly where a light sheet of the light of the first wavelength enters and exits the working volume, have a comparatively lower intensity. Particularly, the different intensities of different image elements can be based on or follow gradients and/or specific profiles, such as e.g. the profile of a parabola.

Further, the volumetric printing process can comprise that the photopolymerizable material is moved, particularly relative to at least one radiation device, before, and/or during, and/or after irradiation with light of the at least one wavelength. As an example, the resin can be provided on a moveably supported conveying element, such as a conveyor band, for instance. Such a volumetric printing process and/or apparatus for implementing such a volumetric printing process can be an independent aspect of the invention.

In an exemplary embodiment, the volumetric printing process can implement the principles of a volumetric printing method which is known as xolography. The base principles of xolography are specified in WO 2020/245456 A1, the contents of which are incorporated herein by reference.

In another exemplary embodiment, the volumetric printing processes can comprise a volumetric printing process oftentimes denoted as Computed Axial Lithography, CAL, as disclosed in documents WO 2018/208378 A2 and Kelly et al.: “Computed Axial Lithography (CAL): Toward Single Step 3D Printing of Arbitrary Geometries” which is available for download at https://doi.org/10.48550/arXiv.1705.05893, for instance; or a volumetric printing process oftentimes denoted as volumetric additive manufacturing via tomographic back-projections or tomographic reconstruction, as disclosed in document Kelly et al. Science, 2019, 363, 1075-1079: “Volumetric additive manufacturing via tomographic reconstruction” which is available for download at https://www.science.org/doi/10.1126/science.aau7114, for instance; in document Loterie et al.: “Volumetric 3D printing of elastomers by tomographic back-projections” which is available for download at http://dx.doi.org/10.13140/RG.2.2.20027.46889, or, using a rotating periscope, in document Wang et al. “Sub-second volumetric 3D printing by synthesis of holographic light fields” which is available for download at https://doi.org/10.1038/s41586-026-10114-5, for instance. The contents of the aforementioned documents are incorporated herein by reference. Particularly, the volumetric printing process can comprise irradiating the photocurable resin with light images of a specific wavelength and intensity distribution in a working volume, wherein the working volume is rotated about a rotational axis, while the light images are projected towards the working volume such that the projections enter the working volume at different angles. Due to overlay of the projections within the working volume, the photocurable resin is subject to an intensity distribution which causes curing of the photocurable resin to form a three-dimensional object. Particularly, the photocurable resin cures at voxels in which a threshold intensity is met or exceeded. Preferably, the rotational axis can be tilted and thus, arranged at an angle different from 90° relative to the propagation direction of the light of the projections which enables a high angular diversity. A high angular diversity enables producing three-dimensional objects with smooth surfaces, which is particularly preferred for manufacturing optical elements. Any one of these volumetric printing processes and/or apparatuses for implementing such volumetric printing processes can be an independent aspect of the invention.

An apparatus for implementing such a volumetric printing process can comprise a container which provides a volume for a photocurable resin, at least one radiation device configured to direct optical projections of light of at least one wavelength through the volume of the photocurable resin, a drive device assigned to the container and configured to rotate the container about a rotational axis, particularly a vertical axis or an axis tilted relative to a vertical axis, while the at least one radiation device directs the optical projections towards the volume such that the projections enter the volume at different angles, and/or a rotating periscope, particularly a periscope rotatable about the propagation axis of the light emitted by the at least one radiation device, and a controller for controlling operation of at least one of the at least one radiation device and the drive device. The rotational axis can particularly, be arranged at an angle different from 90° relative to the propagation direction of the light of the projections. Such an apparatus for implementing such a volumetric printing process can be an independent aspect of the invention.

In another exemplary embodiment, the volumetric printing process can comprise arranging the photopolymerizable material, e.g. via deposition, on a substrate and then irradiated on the substrate to form at least one three-dimensional object, such as. e.g. a structure, on the substrate, for instance. Any one of these volumetric printing processes and/or apparatuses for implementing such volumetric printing processes can be an independent aspect of the invention.

In another exemplary embodiment, the volumetric printing process can comprise projecting light images from multiple directions into a working volume; controlling a light source comprising a plurality of pixels to emit a plurality of beams toward an optical objective; diverging the plurality of beams, via the optical objective, as the plurality of beams exits the optical objective toward a volume of resin; translating, via one or more motors, the optical objective with respect to the volume of resin; by translating the optical objective relative to the volume of resin, applying the plurality of beams to a plurality of voxels inside the volume of resin; solidifying the plurality of voxels by the application of the plurality of beams to the plurality of voxels; applying the plurality of beams, via the optical objective, such that each of the plurality of voxels are exposed by at least two different beams among the plurality of beams; and exposing, via the at least two different beams, the each voxel at two different times such that the at least two different beams spatially overlap only in the each voxel, wherein a total exposure that solidifies the volume of resin in the each voxel equals to at least a sum of exposure of the at least two different beams at the each voxel (see e.g. WO2024163474A1, the contents of which are incorporated herein by reference), particularly, wherein at least two of the voxels or the plurality of voxels form an object, particularly wherein only voxels with a total exposure above a certain threshold cure and solidify, respectively; or a volumetric printing process, e.g. sometimes denoted as “cone beam lithography” or “parallax manufacturing” as suggested e.g. by Vitro3D Inc. and later Manifest Technologies Inc., respectively, in which an image is projected from a light source towards a substrate, wherein the projected light diverges towards the substrate, particularly wherein the image size can increase with increasing distance between the substrate and the light source, wherein the light path can be in a cone shape or truncated cone shape or in a shape which resembles a pyramid or truncated pyramid with a quadratic or rectangular base, and wherein by moving the light source relative to the resin, each voxel of the resin can experience irradiation from at least two different angles, wherein by changing the image for each relative position of irradiation and resin, each voxel can absorb a specific light dose leading to solidification of the resin in the shape of the voxels which have absorbed a light dose above a threshold light dose such that method of cone beam lithography or parallax manufacturing can be similar to the reverse process of cone beam reconstruction. Any one of these volumetric printing processes and/or apparatuses for implementing such volumetric printing processes can be an independent aspect of the invention.

In an exemplary embodiment, the volumetric printing process for manufacturing an object, particularly an optical element, more particularly an optical element for an AR device and/or a VR device, can implement the principles of a parallax volumetric manufacturing process.

In an exemplary embodiment, a parallax volumetric manufacturing process can comprise projecting at least two light beams, particularly at least two light beams forming an image, from a light source, particularly through an objective, towards a working volume, particularly wherein the working volume is comprised in a container, wherein the projected light beams or light diverges towards the working volume, particularly wherein the projected light diverges with an apex angle or irradiation aperture angle, particularly wherein the image size can increase with increasing distance between the working volume and the light source, wherein the light path, particularly the light path of an image, can be in a cone shape or truncated cone shape, particularly a cone shape or truncated cone shape with an apex angle or irradiation aperture angle, or in a shape which resembles a pyramid or truncated pyramid with a quadratic or rectangular base, particularly a shape which resembles a pyramid or truncated pyramid with a quadratic or rectangular base with an irradiation aperture angle, and wherein by moving the light source relative to the working volume and the photocurable resin provided therein, individual voxels of the resin can be subject to irradiation from at least three different angles and directions respectively, wherein by changing the image for each relative position of irradiation and photocurable resin, individual voxels can absorb a specific light dose leading to curing or solidification of the photocurable resin in the shape of the individual voxels which have absorbed a light dose above a threshold light dose to form an object. Therefore, the method of cone beam lithography or parallax manufacturing can be similar to the reverse process of cone beam reconstruction. The volumetric printing process and/or apparatuses for implementing such volumetric printing process can be an independent aspect of the invention.

The parallax volumetric manufacturing process can comprise irradiating, particularly via a diverging projection with an irradiation aperture angle, particularly via an objective, more particularly via an immersed objective, at least one voxel, particularly an individual voxel, of a working volume, which can be defined by the container, with light from multiple directions, particularly multiple angular directions with respect to a reference axis, particularly a reference axis which is the main propagation direction of the light or the optical axis. Notably, the photocurable resin cures at voxels in which a threshold intensity is met or exceeded. As such, parallax volumetric manufacturing process can comprise irradiating at least one voxel of the working volume with light from multiple directions which can create a resulting intensity meeting or exceeding the respective threshold intensity. As an example, the at least one voxel can be irradiated from a first direction with light of an intensity lower than the threshold intensity which is required for curing the photocurable resin at the respective voxel, and from at least one further direction with light of an intensity lower than the threshold intensity which is required for curing the photocurable resin at the respective voxel. However, the respective intensities of the light irradiated from the first direction and the light irradiated from the at least one further direction can be chosen such that they add up, e.g. via intersection at the position of the respective voxel, to a resulting intensity that meets or exceeds the respective threshold intensity. Notably, the light irradiated from the first direction and the light irradiated from the at least one further direction can irradiate the respective voxel concurrently or sequentially, particularly sequentially. As such, the resulting intensity that meets or exceeds the respective threshold intensity can be achieved by irradiation the respective voxel with light coming from the first direction and the light coming from the at least one further direction at the same time or at different times, particularly at different times. As an example, the different times typically, comprise a temporal offset of at most 10 seconds, particularly at most 9 seconds, more particularly at most 8 seconds, more particularly at most 7 seconds, more particularly at most 6 seconds, more particularly at most 5 seconds, more particularly at most 4 seconds, more particularly at most 3 seconds, more particularly at most 2 seconds, more particularly at most 1 second.

In another exemplary embodiment, the parallax manufacturing process can comprise at least one individual voxel with an individual voxel aperture angle, wherein the individual voxel with the individual voxel aperture angle is irradiated from at least three different angles or directions, respectively by at least three light beams, wherein three light beams can define an irradiation cone with an aperture angle. Particularly, the individual voxel can be the apex of the irradiation cone. Particularly, the individual voxel aperture angle is the largest aperture angle which can be formed by three different light beams. As such, the volume of the cone, which is defined by the three light beams with the individual voxel aperture angle, comprises all beams and all angles which are irradiated on the individual voxel.

In another exemplary embodiment, the parallax manufacturing process can comprise at least one individual voxel with an individual voxel aperture angle, wherein the individual voxel with the individual voxel aperture angle is irradiated from at least three different angles or directions, respectively by at least three light beams, wherein three light beams can define an irradiation cone with an aperture angle. Particularly, the individual voxel can be the apex of the irradiation cone. Particularly, the individual voxel aperture angle is the largest aperture angle which can be formed by three different light beams, wherein the three different light beams forming the cone with the largest aperture angle form three beam-beam angles between each other. Particularly, a first beam-beam angle between the first and the second light beam, a second beam-beam angle between the first and the third light beam, and a third beam-beam angle between the second and the third light beam, wherein the sum of the three beam-beam angles formed between the three light beams defines the individual voxel angle sum.

In another exemplary embodiment, the parallax manufacturing process can comprise at least one individual voxel with an individual voxel aperture angle, wherein a cone can be defined by the individual voxel aperture angle. Particularly, the individual voxel is the apex of the cone. Particularly, the cone can intersect a reference plane. Particularly, the reference plane can be at least one side of the working volume or at least one side of the container. Particularly, the intersection points form a circle or an ellipsoid within the reference plane and the circle or ellipsoid can have an area, which can be an individual voxel cone area. As such, the circle or ellipsoid area, which can be an individual voxel cone area, comprises all intersection points of the at least three light beams which are irradiated on the individual voxel.

In another exemplary embodiment, the parallax manufacturing process can comprise at least one individual voxel with an individual voxel aperture angle, wherein a cone can be defined by the individual voxel being the apex of the cone and the aperture angle being the irradiation aperture angle. Particularly, the cone can intersect a reference plane. Particularly, the reference plane can be at least one side of the working volume or at least one side of the container. Particularly, the intersection points form a circle or an ellipsoid within the reference plane and the circle or ellipsoid can have an area, which can be an individual voxel maximum cone area. As such, the circle or ellipsoid area, which can be an individual voxel maximum cone area, comprises all possible intersection points of the light beams which are irradiated on the individual voxel.

In another exemplary embodiment, the parallax manufacturing process can comprise at least one individual voxel with an individual voxel aperture angle, wherein the individual voxel with an individual voxel aperture angle is irradiated from at least three different angles or directions by at least three light beams. Particularly, the at least three light beams intersect a reference plane defining intersection points. Particularly, the reference plane can be at least one side of the working volume or at least one side of the container. Particularly, the intersection points form a polygon within the reference plane and the polygon has an area, which can be an individual voxel irradiation area. As such, the polygon area, which can be an individual voxel irradiation area, comprises all intersection points of the at least three light beams which are irradiated on the individual voxel.

According to another exemplary embodiment, at least 50%, particularly at least 60%, more particularly at least 70%, more particularly at least 80%, more particularly at least 90%, most particularly all, of the individual voxels forming at least one object manufactured according to a parallax manufacturing process can be individual voxels with an individual voxel aperture angle of at least 30°, preferably at least 35°, more preferably at least 40°, more preferably at least 45°, more preferably at least 50°, more preferably at least 55°, more preferably at least 60°. Objects formed of at least 50% of individual voxels with an individual voxel aperture angle of, e.g. at least 45°, benefit from a high angular diversity and as such exhibit reduced surface roughness, which is of particular relevance for the manufacture of optical elements, particularly for optical elements for AR devices and/or VR devices.

According to another exemplary embodiment, at least 50%, particularly at least 60%, more particularly at least 70%, more particularly at least 80%, more particularly at least 90%, most particularly all, of the individual voxels forming at least one object manufactured according to a parallax manufacturing process can be individual voxels with an individual voxel aperture angle of at least 50%, particularly at least 60%, more particularly at least 70%, more particularly at least 80%, more particularly at least 90%, most particularly all, of the irradiation aperture angle. Objects formed of at least 50% of individual voxels with an individual voxel aperture angle of, e.g. at least 60° of the irradiation aperture angle, benefit from a high angular diversity and as such exhibit reduced surface roughness, which is of particular relevance for the manufacture of optical elements, particularly for optical elements for AR devices and/or VR devices.

According to another exemplary embodiment, at least 50%, particularly at least 60%, more particularly at least 70%, more particularly at least 80%, more particularly at least 90%, most particularly all, of the individual voxels forming at least one object manufactured according to a parallax manufacturing process can be individual voxels with an individual voxel irradiation area of at least 50%, particularly at least 60%, more particularly at least 70%, more particularly at least 80%, more particularly at least 90%, most particularly all, of the individual voxel maximum cone area. Objects formed of at least 50% of individual voxels with an individual voxel irradiation area of, e.g. at least 60° of the individual voxel maximum cone area, benefit from a high angular diversity and as such exhibit reduced surface roughness, which is of particular relevance for the manufacture of optical elements, particularly for optical elements for AR devices and/or VR devices.

According to another exemplary embodiment, at least 50%, particularly at least 60%, more particularly at least 70%, more particularly at least 80%, more particularly at least 90%, most particularly all, of the individual voxels forming at least one object manufactured according to a parallax manufacturing process can be individual voxels with an individual voxel cone area of at least 50%, particularly at least 60%, more particularly at least 70%, more particularly at least 80%, more particularly at least 90%, most particularly all, of the individual voxel maximum cone area. Objects formed of at least 50% of individual voxels with an individual voxel cone area of, e.g. at least 60° of the individual voxel maximum cone area, benefit from a high angular diversity and as such exhibit reduced surface roughness, which is of particular relevance for the manufacture of optical elements, particularly for optical elements for AR devices and/or VR devices.

According to another exemplary embodiment, at least 50%, particularly at least 60%, more particularly at least 70%, more particularly at least 80%, more particularly at least 90%, most particularly all, of the individual voxels forming at least one object manufactured according to a parallax manufacturing process can be individual voxels with an individual voxel angle sum of at least 200%, particularly at least 210%, more particularly at least 220%, more particularly at least 230%, most particularly at least 250%, of the irradiation aperture angle. Objects formed of at least 50% of individual voxels with an individual voxel angle sum of, e.g. at least 200% of the individual voxel maximum cone area, benefit from a high angular diversity and as such exhibit reduced surface roughness, which is of particular relevance for the manufacture of optical elements, particularly for optical elements for AR devices and/or VR devices. As an example, the maximum angular diversity can be reached, where the three light beams form a regular triangular pyramid, which would correspond to an individual voxel angle sum of about 255% of the irradiation aperture angle.

According to another exemplary embodiment, at least 50%, particularly at least 60%, more particularly at least 70%, more particularly at least 80%, more particularly at least 90%, most particularly all, of the individual voxels forming at least one object manufactured according to a parallax manufacturing process can be individual voxels with an individual voxel angle sum of at least 60°, particularly at least 90°, more particularly at least 120°, more particularly at least 150°, most particularly at least 180°. Objects formed of at least 50% of individual voxels with an individual voxel angle sum of, e.g. at least 90°, benefit from a high angular diversity and as such exhibit reduced surface roughness, which is of particular relevance for the manufacture of optical elements, particularly for optical elements for AR devices and/or VR devices.

According to another exemplary embodiment, at least 50%, particularly at least 60%, more particularly at least 70%, more particularly at least 80%, more particularly at least 90%, most particularly all, of the individual voxels forming at least one object manufactured according to a parallax manufacturing process can be individual voxels, wherein the individual voxel with an individual voxel aperture angle is irradiated from at least three different angles by at least three light beams, wherein the three different light beams forming the cone with the largest aperture angle form three beam-beam angles between each other, particularly a first beam-beam angle between the first and the light second beam, a second beam-beam angle between the first and the third light beam, and a third beam-beam angle between the second and the third light beam. Particularly, each of the three beam-beam angles is at least 20°, particularly at least 30°, more particularly at least 40°, more particularly at least 50°, most particularly at least 60°. Objects formed of at least 50% of individual voxels wherein each of the three beam-beam angles is at least 30°, benefit from a high angular diversity and as such exhibit reduced surface roughness, which is of particular relevance for the manufacture of optical elements, particularly for optical elements for AR devices and/or VR devices.

Generally, the terms “angle” or “angles” refer to angles measured in the respective medium. As an example, the respective medium can be air.

Respective parallax manufacturing processes can be beneficial over so-called CAL-processes as they enable a higher angular diversity. Particularly, the three-dimensional objects manufacturable with parallax manufacturing processes are less prone to striation artefacts which render the three-dimensional objects specifically suitable for optical applications. In contrast, respective CAL-processes can be beneficial over respective parallax manufacturing processes as they have less constraints with respect to the geometric configurations of the three-dimensional objects manufacturable therewith because parallax manufacturing processes inherently suffer from the missing cone problem.

An apparatus for implementing such a method can comprise a light source comprising a plurality of pixels configured to emit a plurality of beams toward an optical objective; the optical objective configured to diverge the plurality of beams, e.g. in a cone-shape, as the plurality of beams exits the optical objective toward a volume of resin; and one or more motors configured to translate the optical objective with respect to the volume of resin, wherein the one or more motors can be configured to translate the optical objective relative to the volume of resin to apply that plurality of beams to a plurality of voxels inside the volume of resin, wherein the application of the plurality of beams to the plurality of voxels solidifies the plurality of voxels, wherein the optical objective is configured to apply the plurality of beams such that each of the plurality of voxels are exposed by at least two different beams among the plurality of beams. Particularly, an apparatus for implementing such a method can comprise a light source comprising a plurality of pixels configured to emit a plurality of beams toward an optical objective; the optical objective configured to diverge the plurality of beams, e.g. in a cone-shape, as the plurality of beams exits the optical objective toward a volume of resin; and one or more motors configured to translate the optical objective with respect to the volume of resin; wherein the one or more motors are configured to translate the optical objective relative to the volume of resin to apply that plurality of beams to a plurality of voxels inside the volume of resin, wherein the application of the plurality of beams to the plurality of voxels solidifies the plurality of voxels, wherein the optical objective applies the plurality of beams such that each of the plurality of voxels are exposed by at least two different beams among the plurality of beams, wherein the at least two different beams expose the each voxel at two different times such that the at least two different beams spatially overlap only in the each voxel, and wherein a total exposure that solidifies the volume of resin in the each voxel equals to at least a sum of exposure of the at least two different beams at the each voxel, as e.g. disclosed in WO2024163474A1, for instance. The apparatus can comprise a control unit configured to control the exposure of one or more voxels to form a three-dimensional object. The control unit can particularly, control the exposure time of one or more voxels such that only one voxel with a total exposure above a certain threshold cures and solidifies, respectively. The contents of the aforementioned document are incorporated herein by reference. Such an apparatus for implementing such a volumetric printing process can be an independent aspect of the invention.

The apparatus configured for a respective volumetric printing process, particularly a respective parallax volumetric manufacturing process, can comprise a container for receiving the photocurable resin, wherein one, more, or all walls of the container can be less reflective or non-reflective, particularly absorbing or transmissive for the light generated by the light source. Particularly, one or more walls of the container, such as e.g. a top or bottom wall of the container, which is/are arranged opposite to the optical objective can be less reflective or non-reflective, particularly absorbing or transmissive for the light generated by the light source. Particularly, one wall of the container which is arranged opposite to the optical objective can be absorbing for the light generated by the light source. The less reflective or non-reflective properties of the respective wall of the container can be provided by a coating or surface structuring, for example.

The parallax volumetric manufacturing process can comprise irradiating, particularly via an objective, more particularly via an immersed objective, at least one voxel of a working volume, which can be defined by the container, with light from multiple directions, particularly multiple angular directions with respect to a reference axis, particularly a reference axis which is the main propagation direction of the light or the optical axis. Notably, the photocurable resin cures at voxels in which a threshold intensity is met or exceeded. As such, parallax volumetric manufacturing process can comprise irradiating at least one voxel of the working volume with light from multiple directions which can create a resulting intensity meeting or exceeding the respective threshold intensity. As an example, the at least one voxel can be irradiated from a first direction with light of an intensity lower than the threshold intensity which is required for curing the photocurable resin at the respective voxel, and from at least one further direction with light of an intensity lower than the threshold intensity which is required for curing the photocurable resin at the respective voxel. However, the respective intensities of the light irradiated from the first direction and the light irradiated from the at least one further direction can be chosen such that they add up, e.g. via intersection at the position of the respective voxel, to a resulting intensity meeting or exceeding the respective threshold intensity. It has been surprisingly found that the three-dimensional objects, such as e.g. optical elements, which can be manufactured with parallax volumetric manufacturing process have improved properties when each of the respective voxels forming the respective three-dimensional objects is irradiated with light from multiple different directions, particularly more than two, three, four, five, six, seven, eight, nine, ten, or more different directions, wherein the intensities of the light irradiated from the respective directions are chosen such that they add up, e.g. via intersection at the position of the respective voxels, to a resulting intensity meeting or exceeding the respective threshold intensity. Particularly, the light coming from the multiple directions can be uniformly distributed around the respective voxels. As an example for a voxel being irradiated from the four different directions, the four different directions can be oriented at an angle of 90°. Hence, for a voxel being irradiated from n different directions, the n different directions can be oriented at an angle of n/360° relative to each other, for example. As another example for a voxel being irradiated from multiple directions and thus, from different irradiation angles, the irradiation angles can be evenly distributed. As another example for a voxel being irradiated from multiple directions, each direction can be assigned to a volume defined around the respective voxel, wherein the voxel can define a reference system of the respective volumes, e.g. by forming a center of the respective reference system. As such, each volume can e.g. be, comprise, or form part of a quadrant surrounding the respective voxel, wherein the voxel can define the reference system of the respective quadrants, e.g. by forming a center of the respective reference system. In such a manner, a high angular diversity can be achieved which has been surprisingly found beneficial for the properties of the as-manufactured three-dimensional objects.

The volumetric printing process can generally enable manufacturing at least one optical element in continuous or at least quasi-continuous manner which enables manufacturing optical elements having substantially isotropic properties, particularly substantially isotropic optical properties, which is a significant advantage for manufacturing optical elements. As opposed to conventional additive manufacturing techniques which are based on a successive layerwise selective solidification of a build material and thus, a successive layerwise build-up of a three-dimensional object, volumetric printing processes enable a continuous curing of a volume of a build material which not only enables faster build-times but avoids also artefacts, such as e.g. staircase structures, resulting from the successive layerwise build-up of conventional additive manufacturing techniques.

According to an example, a method for producing at least one optical element can comprise processing an optically reactive material.

Processing the optically reactive material can comprise the following: providing a starting material which is optically reactive and fills a working volume; optically processing the starting material in the working volume by way of irradiation of light of a first wavelength and light of a second wavelength that is different from the first wavelength, wherein at least one material property of the starting material is changed by way of the optical processing. Particularly, changing the at least one material property of the starting material comprises curing the starting material as a result of the optical processing. More particularly, changing the at least one material property of the starting material comprises continuously curing the starting material as a result of the optical processing to continuously form a three-dimensional object in the working volume. As an example, the optical processing can comprise the following: irradiating a first layer partial volume of the working volume filled with the starting material with the light of the first wavelength; irradiating the first layer partial volume of the working volume with the light of the second wavelength, wherein the light of the second wavelength is in this case projected into the working volume; irradiating a second layer partial volume of the working volume filled with the starting material, which is different from the first layer partial volume, with the light of the first wavelength; irradiating the second layer partial volume of the working volume with the light of the second wavelength, wherein the light of the second wavelength is in this case projected into the working volume, particularly wherein the first layer partial volume and the second layer partial volume partially overlap; and continuously repeating the preceding steps for layer-wise optical processing of the starting material in the working volume until a volume of the starting material to be processed, which is gathered entirely or in part by the working volume, is optically processed, and in the process a green body is formed from the starting material; and further processing the green body, such that an optical element is formed at least in part, in particular completely, from the green body. Particularly, the transition from a first partial layer volume to a second and each further partial layer volume can be performed continuously. As such, an irradiation zone defined by the currently irradiated partial layer volume can move continuously through the working volume during the optical processing such that the three-dimensional object is formed continuously in the working volume. The irradiation zone can be or comprise a formation zone.

The starting material can be or comprise a photocurable resin. Exemplary photocurable resins are provided further below.

The inventors were able to find that it is surprisingly possible to use volumetric 3D printing processes, specifically in particular volumetric 3D printing methods which include continuously processing partial volumes of a photocurable resin with at least two different wavelengths, for producing at least one optical element. In particular, optical elements having excellent properties, such as e.g. high isotropy, smooth surface due to avoiding surface artefacts, such as e.g. staircase effects, and optical elements of high quality can be manufactured in an efficient manner using volumetric 3D printing methods.

Further, the inventors unexpectedly found that it is surprisingly possible to use volumetric 3D printing processes, in particular parallax manufacturing processes due to their high angular diversity, for producing at least one optical element. In particular, optical elements having excellent properties, such as e.g. high isotropy, smooth surface due to avoiding surface artefacts, such as e.g. striation artefacts, and optical elements of high quality can be manufactured in an efficient manner using respective volumetric 3D printing processes.

As will be more apparent from further below, another aspect of the invention relates to a device for processing an optically reactive material, which can comprise the following: a working volume, which is configured for receiving a starting material which is optically reactive and fills the working volume in part or completely; a lighting device, which is configured to provide light of a first wavelength and light of a second wavelength for irradiation into the working volume comprising the starting material. The lighting device can be configured to optically process the starting material in the working volume as follows: irradiating a first layer partial volume of the working volume filled with the starting material with the light of the first wavelength; irradiating the first layer partial volume of the working volume with the light of the second wavelength, wherein the light of the second wavelength is in this case projected, by a projection device, into the working volume in a manner that it hits the first layer partial volume entirely or in part; irradiating a second layer partial volume of the working volume filled with the starting material or comprising the starting material, which is different from the first layer partial volume, with the light of the first wavelength; irradiating the second layer partial volume of the working volume with the light of the second wavelength, wherein the light of the second wavelength is in this case projected, by a projection device, into the working volume in a manner that hits the second layer partial volume entirely or in part, particularly only the second layer partial volume entirely or in part, particularly wherein the first layer partial volume and the second layer partial volume partially overlap; and repeating the preceding steps for layer-wise optical processing of the starting material in the working volume until a volume of the starting material to be processed, which is gathered entirely or in part by the working volume, is optically processed, and in the process a green body is formed from the starting material. An optical element can be formed (at least in part, in particular completely) from the green body by further processing, such as e.g. post-processing. The further processing, i.e, particularly the post-processing, can be implemented via at least one device configured to perform at least one further processing process, such as e.g. at least one post-processing process. Non-limiting examples of respective further processing processes and post-processing processes are provided in the following.

The lighting device, which is also referred to herein as the or an irradiation device, can be configured to create a light section (light sheet) in the working volume or can comprise a light section creation device for creating at least one light section in the working volume.

As will be apparent from further below, the lighting device can comprise e.g. one of the following elements: lenses to create a static light sheet, a Powell lens, a cylinder lens, in particular a planoconvex cylinder lens, or a polygon mirror or a galvo scanner. Alternatively or additionally, the lighting device can e.g. comprise: a laser or an LED or a thermal light source. Alternatively or additionally, the lighting device can e.g. comprise: a mirror or a light deflection device, which are configured to irradiate the light, which emerges from the working volume, back into the working volume in the opposite direction, by reflection.

The lighting device can be configured to allow earlier processing, in the temporal course, of layers that are located further from a source of the light of the second wavelength.

The layer partial volumes of the working volume can be irradiated in succession with the first and the second wavelength, in order to thus trigger an optically initiated reaction in the starting material. The layer partial volumes, which are optically processed in succession, can contain partial volumes of the starting material which is introduced into the working volume before the start of the manufacturing process (optical processing), and are filled thereby. In contrast to known methods, in the case of optical processing no layer-wise application of the starting material takes place, and respectively subsequent layer-wise optical processing (of the just-applied layer) after the layer application.

Depending on what layer partial volume is irradiated, within the working volume previously filled with the starting material, with the first wavelength, the projection of the light of the second wavelength or the irradiation with light of the second wavelength can take place via the projection device in precisely this layer partial volume that is at present and currently irradiated with the first wavelength. The projection device can cause imaging of the light of the second wavelength into the currently desired layer partial volume. In this case, the projection device can image the light of the second wavelength of an at least two-dimensionally shaped image correspondingly in the projection plane or the projection volume, which is located in the layer partial volume irradiated with the light of the first wavelength. In this way, for example a three-dimensional body can be produced in the starting material, layer-by-layer.

The further processing of the green body can in particular comprise at least one of the following steps: removing the green body from the starting material; treating (in particular washing) the green body with a solvent and/or a (treatment) monomer; and drying the (washed) green body. The green body can be formed isotropically. Alternatively, the further processing steps can take place in the starting material (without removing the blank).

The solvent and/or the (treatment) monomer can comprise a photoinitiator and/or a thermal initiator which preferably reacts only at one wavelength (or one wavelength range). Preferably, the photoinitiator comprised in the solvent and/or (treatment) monomer can react to light of a wavelength which is between the first and the second wavelength. In this way, the post-curing can take place more efficiently. In this case, the photoinitiator and/or thermal initiator can be configured to be received in the surface of the green body. In particular, a photoinitiator and/or thermal initiator can be dissolved in the solvent and/or the (treatment) monomer. The drying can take place for example by means of supplying a gas stream (preferably an airstream or a nitrogen stream) and/or by supply of heat (preferably of a temperature of at least 20° C.). Photoinitiators are described for example in Fouassier/Lalevée, Photoinitiators, Wiley-VCH (2021).

In particular for high-viscosity starting materials, the washing can result from corresponding selection of the solvent or (treatment) monomer, time, temperature, and movement of smoother surfaces of the green body.

Additionally or alternatively, the further processing of the green body can comprise at least one of the following steps: photochemical post-curing of the green body, tempering the green body (this typically corresponds to thermal post-curing of the green body), machining the green body, particularly grinding the green body, polishing the green body, and coating the green body (for example with an antireflection coating and/or a hard coating).

Coating of the green body can comprise one or more chemical and/or physical coating methods, and can in particular serve to improve the surface properties of the green body and thus of the optical element. In particular, the roughness, scratch-resistance and/or reflective properties can be improved by applying at least one coating. It is thus the case, for all embodiments, that an applied coating can have a lower refractive index than the (actual) optical element (e.g. due to an antireflection coating) and/or the surface hardness of the optical element can increase (e.g. by an anti-scratch layer).

The term “refractive index” corresponds to the refractive index at the sodium doublet D (589.29 nm), unless otherwise noted.

Corresponding coating methods can include e.g. a spray method, a dip method, a spin-coating method, a sol-gel method, or a gas-phase deposition method. After any coating, further curing-which can again take place e.g. photochemically or thermally, can be carried out.

A coating material to be applied by means of a corresponding coating method can be e.g. a solid, a paste, a liquid or a varnish, or a gas. Therefore, a coating material can be applied to the green body e.g. as powder, as paste, as liquid or as varnish, or as gas or from a gas phase.

A coating can also take place with the non-cured starting material itself or another organic polymer or an inorganic/organic hybrid material, which typically requires further curing, which can again take place e.g. photochemically or thermally.

The surface of the green body or of the optical element can be prepared chemically and/or physically before applying the coating, i.e. in particular be activated, in order to allow for better attachment of the coating. Corresponding processing or activation can take place using a plasma, in particular an oxygen plasma. Alternatively or additionally, adhesion promoters are conceivable, which allow for better attachment of the coating to the green body or the optical element.

The photochemical post-curing can take place by means of isotropic irradiation of the green body (uniform irradiation from all sides, with light). The tempering or thermal post-curing can take place by means of supply of heat at temperatures of at least 50° C., in particular for a duration of at least 15 minutes, or corresponding aging of the green body in temperatures of at least 50° C., in particular for a duration of at least 15 minutes.

Via a control device which is connected to one or more light sources or irradiation devices for providing the light of the first and the light of the second wavelength, and optionally the or a projection device, which can in general form a component of the irradiation device, it is possible to determine whether the first or the second layer partial volume (of the starting material in the working volume) is irradiated, and the projection device can be actuated, depending thereon, to project the light of the second wavelength into the first and/or the second layer partial volume. In this case, data are provided in the control device, which define the current or present position of the layer partial volume which is irradiated with light of the first wavelength. Proceeding herefrom, the projection device is controlled in such a way that the projection created via the projection device takes place in a projection plane or in a projection volume in said currently irradiated layer partial volume. In this way, the layer partial volumes of the starting material are processed layer-by-layer, in succession. In this case, the external shape of the projection of the projection device may be different for different layer partial volumes, in particular depending on a three-dimensional body which is intended to be produced in the starting material via the optical processing.

It can be provided in one embodiment to detect a current or present position of the layer partial volume, which is irradiated with the light of the first wavelength, in the working volume via a measuring device, which then provides measuring signals, indicating the position, to the control device.

The light of the first wavelength and the light of the second wavelength can be irradiated simultaneously and together into the first or the second layer partial volume, at least for a temporal overlap period. In this embodiment, the region gathered by the layer partial volume and the projection of the projection device is irradiated, at least for the temporal overlap region, both with light of the first wavelength and with light of the second wavelength.

The first and the second layer partial volume can form adjacent layer partial volumes of the starting material in the working volume.

It can be provided that the first and the second layer partial volume are formed corresponding to one of the following configurations of partial volumes: overlapping at the edge, abutting at the edge, and spaced apart from one another at the edge.

The light of the first wavelength can be irradiated along a first irradiation direction, and the light of the second wavelength can be irradiated along a second irradiation direction which extends transversely to the first irradiation direction, onto the starting material in the working volume. In one embodiment, the first and the second irradiation direction can for example assume an angle of approximately 90°. Other angles can be provided in the range of approximately 30° to 90° between the optical axes of the irradiation directions. Particularly angles can be provided in the range of approximately 30° to 80°, preferably 40° to 60°, more preferably 45°, between the optical axes of the irradiation directions.

The light of the first wavelength and/or the light of the second wavelength can be irradiated as pulsed light. The light pulses of the light of the first and second wavelength can be irradiated into the currently processed layer partial volume simultaneously or at a predetermined temporal spacing one after the other. The light pulses for the light of the two wavelengths can be provided having the same or different temporal pulse widths. Alternatively, the light of the first wavelength and/or the light of the second wavelength can be irradiated as continuous light.

The starting material can be processed by means of the optical processing in a manner corresponding to at least one processing method from the following group: curing, hardening, gelatinizing and liquifying. In these or other embodiments, the starting material can be solid, liquid or pasty.

In one embodiment it can be provided that the starting material is caused to glow on account of the optical processing with the light of the first and second wavelength, in particular on account of fluorescence or phosphorescence.

For irradiating the first layer partial volume and for irradiating the second layer volume with the light of the first wavelength, a layer-form irradiation region of a first light source, with which the light of the first wavelength is provided, can be displaced relative to the working volume. In this embodiment, the layer-form irradiation region for the light of the first wavelength is displaced relative to the starting material during the optical processing thereof, such that the irradiation region extends or sweeps quasi over the working volume. The relative movement between the working volume and the irradiation region can be achieved in various ways. A displacement of the working volume and/or of the first light source can be provided. Alternatively or additionally, the working volume and first light source can be fixed relative to one another during the entire processing of the starting material. Via a light deflection device, the irradiation region for the light of the first wavelength from the first light source is moved over the working volume comprising the starting material.

It can be provided that the optical processing of the starting material is observed via one or more light detectors, for example by means of a camera and/or a photodetector. In this case, the procedures during processing (optical processing) can be studied, in that for example transmitted light is measured, whether this be light of the excitation of the light section and/or light from the projector. Particularly, spatial changes of the transmitted light of the light section or the light of the first wavelength can be measured and used to adapt and/or iterate the input geometry of the object to be manufactured, the projected images of the light of the second wavelength, or the projected light section of the light of the first wavelength. The light section generator and/or the projector can emit further light wavelengths which are different from the excitation wavelengths and serve only for observing the change in the material property of the starting material, for example the polymerization that is taking place.

A polychromic multi-photon polymerization can be triggered in the starting material, by means of the optical processing, which causes the change in the at least one material property of the starting material. In one embodiment by way of example, the starting material can comprise a transparent organic polymer and/or an inorganic/organic polymer composite, which preferably cures by means of the optical processing. In one embodiment by way of example, the starting material can comprise one or more of the following components: oligomer (for example acrylate, methacrylate, epoxy, vinyl, allyl, organopolysiloxane, terminally functionalised polysiloxanes), functionalised and non-functionalised nanoparticle, particularly nanoparticles of high refractive index, monomer (for example acrylate, methacrylate, epoxy, vinyl, allyl), cross-linker (for example multifunctional monomers, multifunctional thiols), photoinitiator, particularly dual-color photoinitiator, thermal initiator, co-initiator, inhibitor, sensitizer, defoamer, additive for post-processing (for example additional photoinitiator and/or thermal initiator), solvent, additive, in particular additive for rheology control (rheology modifier), in particular of the starting material, additive for reducing the surface tension, in particular of the starting material, additive for influencing the optical properties, for example for adjusting or increasing the transparency or adjusting the refractive index, in particular of the starting material or of the optical element.

The dual-color photoinitiator can react to light of two different wavelengths and in particular lead to local polymerization, which preferably results in selective curing. In one embodiment, a transparent vessel with monomer and dual-color photoinitiator can be irradiated from one or more sides by a laser line, such that a light section results. A video can be projected onto the light section. A cured object can result in a free-floating manner by movement of the vessel.

The method can (preferably during the projection of the video) include performing a pixel shift, such that preferably automatic smoothing of the edges is achieved. Furthermore, dismantling of the object by software, into layers having layer thicknesses of <=1 μm at a uniform printing speed can be provided, as a result of which preferably a high resolution of the optical element is achieved.

The starting material can have a viscosity of 10² mPa·s to 10⁷ mPa·s, preferably of 3·10³ to 10⁶ mPa·s, particularly preferably of 10³ to 10⁵ mPa·s, most preferably of 10⁴ to 9·10⁴ mPa·s.

The starting material can comprise a monomer mixture and/or an oligomer mixture, preferably of a corresponding viscosity. The monomer mixture and/or oligomer mixture can preferably be transparent. The monomer mixture and/or oligomer mixture can stabilize the green body and/or a cured object, as a result of which in particular the need for support structures is omitted and there is complete structural freedom. The cured object can result in a free-floating manner in the monomer mixture and/or oligomer mixture.

In particular, the cured object, i.e. the green body, can result in a free-floating manner in the monomer mixture and/or oligomer mixture, i.e. in general in the starting material, if the monomer mixture or oligomer mixture, in general the starting material, has a sufficiently high viscosity, which supports the cured object. Alternatively or additionally, the cured object can result in a free-floating manner in the monomer mixture and/or oligomer mixture, in general in the starting material, if the monomer mixture or oligomer mixture, in general the starting material, has non-Newtonian flow properties, i.e. shear-thinning or shear-liquifying flow properties, and/or has a yield strength that is greater than the static shear loading by the object. The yield strength of the starting material can be found e.g. by rotational rheometry (plate-to-plate rheometer) under quasi static loading via a “creep test” or travelling a slow shearing stress ramp.

A corresponding yield strength of the starting material, which is greater than the static shear loading by the object, is typically greater than or equal to 0.1 Pa, in particular 0.2 Pa, more particularly 0.3 Pa, more particularly 0.4 Pa, more particularly 0.5 Pa, more particularly 0.6 Pa, more particularly 0.75 Pa, more particularly 1 Pa. A corresponding yield strength of the starting material can thus be in particular at least 0.1 Pa per cm³ of the working volume. For a working volume of 1 cm³, the yield strength of the starting material can thus be at least 0.1 Pa. For a working volume of 2 cm³, the yield strength of the starting material can thus be at least 0.2 Pa.

The static shear loading by the object can depend in particular on the geometry and size of the object, and can accordingly, depending on the geometry and size of the object, be less than or greater than 0.5 Pa. In order to achieve corresponding rheological properties of the monomer mixture or the oligomer mixture, in general of the starting material, it may be expedient for the monomer mixture or the oligomer mixture, in general the starting material, to be stirred before the optical processing, i.e. before the printing. The starting material can thus, in particular after being filled into a container defining the working volume, be stirred for a given time, in particular of at least one hour, in particular at least six hours, more particularly at least twelve hours, more particularly at least eighteen hours, more particularly at least twenty hours.

Additionally or alternatively, the starting material can rest a certain resting time before it is optically processed. As an example, the starting material can rest for at least 15 minutes, particularly at least 30 minutes, more particularly at least 45 minutes, more particularly at least 60 minutes, more particularly at least 2 hours, more particularly at least 4 hours, more particularly at least 8 hours, more particularly at least 12 hours, more particularly at least 16 hours, more particularly at least 20 hours, more particularly at least 24 hours, more particularly at least 2 days, more particularly at least 3 days, more particularly at least 4 days, more particularly at least 5 days, more particularly at least 6 days, more particularly at least 7 days.

Alternatively or additionally, a corresponding yield strength of the starting material can be set by mixing in oligomers and polymers having non-Newtonian flow properties and/or mixing in additives (rheology modifiers). Examples for oligomers having non-Newtonian flow properties are, in a non-exclusive listing: 1) linear polymers having average and/or high molar masses, e.g. PMMA, PS, PC, PIM, 2) celluloses and cellulose esters, 3) polyacrylic acids and polyacrylic acid/polyacrylic acid ester copolymers, 4) polyacrylamides, 5) polyethylene oxide, and 6) polyurethanes. Examples for rheology modifiers are, in a non-exclusive listing: 1) inorganic (nano) particles, e.g. pyrogenic silicic acid, natural and synthetic clay minerals, sheet silicates, glass, 2) organically modified inorganic (nano) particles, 3) organic molecules, oligomers and polymers (urea derivatives, polysaccharides, polyacrylic acids, polyacrylates, polyamides, polyethers, polyurethanes, polyurea derivatives), and 4) urea-modified polyacrylates, polyethers, polyamides and polyurethanes. Examples for commercial organic rheology modifiers which can be used are, in a non-exclusive listing: RHEOBYK 410, RHEOBYK 420, RHEOBYK 430, RHEOBYK 440, BYK-LP R21675, RHEOBYK 7410CA, RHEOBYK 7420CA, RHEOBYK 7420ET (all available from BYK-Chemie GmbH, 46486 Wesel (Germany)), JL-106 (available from Bomar Chem, 51 Greenwoods Rd, Torrington, CT 06790).

For any rheology modifier, it is preferably the case that this is selected and/or used, e.g. in view of its chemical and/or physical properties, concentration, etc., in such a way that it does not or barely leads to turbidity of the starting material and/or of the cured material after optical processing.

Typically, the starting material, in particular in a wavelength range between 370 and 1500 nm, more particularly between 370 and 800 nm, more particularly between 400 and 800 nm, more particularly between 450 and 800 nm, more particularly at 600 nm, has a transmission of at least 10%, in particular at least 20%, more particularly at least 30%, more particularly at least 40%, more particularly at least 50%, more particularly at least 60%, more particularly at least 70%, more particularly at least 80%, more particularly at least 90%, more particularly at least 95%, more particularly at least 99%, in the region of the irradiated light of the first wavelength and/or in the region of the irradiated light of the second wavelength. In this case, the optical transmission relates to an optical path length corresponding to the Beer-Lambert law of 10 mm.

Further, the optical element can have, in particular in a wavelength range between 370 and 1500 nm, more particularly between 370 and 800 nm more particularly between 400 and 800 nm, more particularly between 450 and 800 nm, more particularly at 600 nm, a transmission of at least 10%, in particular at least 20%, more particularly at least 30%, more particularly at least 40%, more particularly at least 50%, more particularly at least 60%, more particularly at least 70%, more particularly at least 80%, more particularly at least 90%, more particularly at least 95%, more particularly at least 99%, in the region of the irradiated light of the first wavelength and/or in the region of the irradiated light of the second wavelength. In this case, the optical transmission relates to an optical path length corresponding to the Beer-Lambert law of 10 mm.

The terms “transparency” and “transmission” can be understood as equivalents herein.

The starting material can exhibit non-Newtonian rheological behavior. Such rheological behavior can facilitate the production of an object in the case of illumination with at least two different wavelengths, wherein the object remains in a fixed position within the working volume or is not moved or is moved only minimally in the working volume during the formation. Such a minimal movement can relate to the displacement of the object during the formation in the working volume, which is acceptable for a precise production of the object. Such rheological behavior can also facilitate the separation of the partially produced object from the working volume when mechanical loads are applied. The viscosity or the apparent viscosity of the non-Newtonian starting material can drop to a lower value (e.g. the constant shear viscosity) than the static value (e.g. zero-shear viscosity or yield stress) in the case of action of mechanical load or shearing, such that the starting material can more easily flow (away) and separate from the object. Examples for such non-Newtonian rheological behavior are inter alia pseudoplastic behavior, Bingham behavior, shear-thickening behavior, and shear-thinning behavior.

A starting material can be provided with non-Newtonian rheological behavior e.g. in that additionally one or more reactive components (e.g. urethane acrylate oligomers, urethane methacrylate oligomers, acrylated or methacrylated polyurethanes, acrylated or methacrylated polyurethane ureas, acrylated or methacrylated polyesters, acrylated or methacrylated polyamides, acrylate- or methacrylate-functional block co-polymers, alkenyl- or alkynyl-functional urethane oligomers, alkenyl- or alkynyl-functional polyurethanes, alkenyl- or alkynyl-functional polyurethane ureas, alkenyl- or alkinyl-functional polyesters, alkenyl- or alkinyl-functional polyamides, alkenyl- or alkinyl-functional block co-polymers, thiol-functional urethane oligomers, thiol-functional polyurethanes, thiol-functional polyurethane ureas, thiol-functional polyesters, thiol-functional polyamides, thiol-functional block co-polymers) in the photocurable starting material components and/or by further addition of one or more non-reactive additives (e.g. but not limited to one or more thixotropes and/or rheology modifiers) to the starting material. The selection of one or more reactive components and their amounts for the addition to a photocurable starting material component in order to provide the starting material with non-Newtonian rheological behavior can in principle be selected freely, in order to obtain certain rheological properties of the starting material.

The starting material can e.g. have a viscosity or a constant shear viscosity which is for example less than 30,000 mPas, less than 20,000 mPas, less than 10,000 mPas, less than 5000 mPas, or less than 1000 mPas. The constant shear viscosity relates to the plateau value of the viscosity which is achieved in the case of unidirectional constant shearing, e.g. the value of the viscosity after the breaking of the thixotropic network. Preferred constant shear viscosities are less than 30,000 mPas, more preferably less than 10,000 mPas, and most preferably less than 1000 mPas. The viscosity in the case of constant shearing can be measured at ambient temperature (e.g. room temperature) printing temperature, or a different temperature (e.g. increased or reduced). The measurement at printing temperature can be advantageous when determining the suitability of a starting material for printing.

The constant shear viscosity can be measured e.g. under continuous shearing at constant speed, e.g. at shearing speeds of approximately 0.00001 s⁻¹ to approximately 1000 s⁻¹).

As mentioned, the starting material can contain at least one additive. Examples of additives are, as mentioned, a filler, a thixotrope or a rheology modifier, a defoamer, a stabilizer, an oxygen scavenger, a non-reactive solvent or diluent, and a dye. In the case of each additive, it may be a single additive or a mixture of a plurality of additives. A thixotrope can thus contain e.g. a single thixotrope or a mixture of two or more thixotropes.

The additives can preferably be selected such that they do not react in an undesired manner with other components or additives which are or may be contained in the starting material.

As mentioned, an additive may be a filler or comprise at least one such. A filler can be contained in an amount of more than 0, particularly more than 40%, more particularly more than 50%, more particularly more than 60%, more particularly more than 70%, to less than 90 wt. %, wherein the amount is typically determined by the purpose of the filler and the desired end use properties for the object to be produced. Advantageously, the fillers can be selected such that the optical properties, in particular the transparency or transmission, of the starting material is retained, e.g. in that the particle size of the filler is selected such that it is substantially smaller than the excitation wavelengths, or in that the refractive indices of the filler and of the starting material acting as a matrix are matched to one another, in order to prevent or at least to reduce undesired scattering effects. Fillers can in particular be used in order to modify one or more properties of the starting material or the object, e.g. with respect to rigidity, strength, viscosity, impact strength, creep strength, fatigue strength, mechanical return, mechanical loss tangent, glass transition temperature, thermal decomposition temperature, thermal conductivity, thermal resistance, moisture absorption, electrical conductivity, static dissipation, dielectric constant and loss tangent, density, refractive index, optical dispersion, opacity to ionizing radiation, and resistance to ionizing radiation. Fillers can, as indicated, also be used in order to change the properties of the starting material or object, e.g. rheological properties such as viscosity and thixotropy, and optical properties such as the refractive index, particularly a refractive index above 1.6, more particularly a refractive index above 1.65, more particularly a refractive index above 1.7, more particularly a refractive index above 1.75, more particularly a refractive index above 1.8, more particularly a refractive index above 2.0. Examples for fillers are inter alia silicon dioxide, aluminum oxide, zirconium dioxide, silicate glasses such as soda lime glass, boron silicate glass, sodium silicate glass, lead glass, aluminosilicate glass, barium glass, thorium glass, glass ceramics, chalcogenide glasses, glass microspheres and microbubbles; nanoclays such as laponite, montmorillonite, bentonite, kaolinite, hectorite and halloysite; calcium phosphate minerals such as hydroxylapatite, mineral fillers such as chalk, mineral dust, cinder dust, fly ash, hydraulic cement, loess, limestone, kaolin, talc and wollastonite. Examples for particle size ranges are less than 10 micrometers, less than 1 micrometer, 10 nm to 500 nm, 10 nm to 90 nm, 40 nm to 70 nm. Smaller particle sizes, in particular sizes below approximately 100 nm, below 50 nm, below 20 nm, below 10 nm, may be advantageous in order to achieve a high optical transparency or transmission of the starting material and facilitate the printing. Control of the particle size distribution, e.g. monodisperse, bimodal or trimodal size distributions, may be advantageous, in order to control the rheological properties, to increase the weight fraction of the filler, or to influence the properties of the starting material and/or of the object in a desired manner.

In one embodiment, an additive may be a substance which adjusts the refractive index of the liquid or pasty components to the filler. An example for such a substance is polyethylene glycol (PEG) or derivatives thereof, in particular polyethylene glycol diacrylate (PEGDA) or derivatives thereof. Further examples for substances for adjusting the refractive index include halogenated, in particular iodinated, substances. When using a substance of this kind, fillers having a non-adjusted refractive index or fillers having particle sizes of over 50 nm can be used, in particular over 100 nm, more particularly over 500 nm, more particularly over 1 μm, more particularly over 10 μm.

Further examples of additives are thixotropes and rheology modifiers. Suitable thixotropes or rheology modifiers are for example urea derivatives; modified urea compounds such as Rheobyk 410 and Rheobyk-D 410 (available from BYK-Chemie GmbH), pyrogenic metal oxides (also referred to as pyrogenic metal oxides), including but not limited to pyrogenic silicic acid, pyrogenic clay; zirconium dioxide, precipitated metal oxides, including but not limited to precipitated silicic acid, precipitated clay; unmodified and organically modified sheet silicate clays; dimer and trimer fatty acids; polyether phosphates; oxidized polyolefins; hybrid oxidized polyolefins with polyamide; alkali-soluble/swellable emulsions; cellulose ether; hydrophobically modified alkali-soluble emulsions; hydrophobically modified urethane based on ethylene oxide; saccharose benzoate; ester-terminated polyamides; tertiary amide-terminated polyamides; polyalkyleneoxy-terminated polyamides; polyether amides; acryl amidomethyl cellulose ester polymers; polyethylene imine; polyurea; organoclay; hydrogenated castor oil; organic base salts of a clay mineral (e.g. montmorillonite), and other silicate-like materials; aluminum, calcium and zinc salts of fatty acids, such as lauric and stearic acid.

Thermally reversible gelling agents, such as ester-terminated polyamides, tertiary amide-terminated polyamides, polyalkyleneoxy-terminated polyamides, and polyether amides, and combinations thereof, are conceivable for use as thioxtropes. Examples for these are Crystasense LP1, Crystasense LP2, Crystasense LP3, Crystasense MP, Crystasense HP4, Crystasense HP5, Rheoptima X17, Rheoptima X24, Rheoptima X38, Rheoptima X58, Rheoptima X73 and Rheoptima X84 (available from Croda). Crystasense HP-5 is a preferred example of a thixotrope.

Further examples of additives are metal oxides, in particular metal oxides that have been surface-treated, in order to provide particular dispersibility properties which are compatible with the starting material.

A thixotrope can be contained in the starting material in an amount of for example approximately 0.05 wt. % to approximately 15 wt. %, in particular from approximately 0.5 wt. % to approximately 15 wt. %, more particularly from approximately 0.5 wt. % to approximately 10 wt. %, more particularly from approximately 1 to approximately 10 wt. %. In principle, a thixotrope is preferably contained in an amount that is effective for limiting the movement of the three-dimensional object or of one or more regions thereof in the starting material during the production of the object. Preferably, the thixotrope is contained in the starting material, which is effective for limiting the movement of the object which floats in the working volume (without contact with the container surface) during the formation. In this case, the orientation and/or position of the object in the working volume during the production remains (substantially) unchanged.

An example for a defoamer, mentioned further above, which can be used for assisting the elimination of bubbles which occur during the processing and handling, is BYK 1798 (a silicon-based defoamer) (available from BYK-Chemie GmbH).

The starting material can contain water. The starting material can thus be an aqueous solution. The fraction of water can be between 5 and 99.9 wt. %, in particular between 30 and 99.9 wt. %, more particularly between 40 and 99.9 wt. %, more particularly between 50 and 99.9 wt. %, more particularly between 60 and 99.9 wt. %, more particularly between 70 and 99.9 wt. %, more particularly between 80 and 99.9 wt. %, more particularly between 90 and 99.9 wt. %. In such embodiments, corresponding additives, such as rheology modifiers, e.g. in the form of polyacrylic acids, gelatines, etc., can be soluble in water or in the water/monomer or water/oligomer mixture, or miscible with water or the water/monomer or water/oligomer mixture. A corresponding solubility of miscibility of the additives in or with water should be ensured in particular in a temperature range between 2° and 40° C., in particular between 25 and 37° C., alternatively between 2° and 30° C., alternatively again between 35 and 40° C.

Corresponding aqueous starting materials, in particular those which contain one or more additives that are soluble in water and/or miscible with water, are in particular selected, in their composition, in such a way that they are transparent. This is in particular to be understood to mean that the starting material, also with additives, in particular in a wavelength range between 370 and 1500 nm, in particular between 370 and 800 nm, more particularly between 400 and 800 nm, more particularly between 450 and 800 nm, has a transmission of at least 30%, in particular at least 50%, more particularly at least 80%, more particularly at least 90%, in the region of the irradiated light of the first wavelength and/or in the region of the irradiated light of the second wavelength. In this case, the transmission relates to an optical path length corresponding to the Beer-Lambert law of 10 mm. A corresponding transmission should be ensured in particular in a temperature range between 2° and 40° C., in particular between 25 and 37° C., alternatively between 2° and 30° C., alternatively again between 35 and 40° C.

Corresponding aqueous starting materials, in particular those which contain one or more additives that are soluble in water and/or miscible with water, are in particular selected, in their composition, in such a way that they have a pH in the range between 5 and 10, in particular between 6 and 9, more particularly between 7 and 8, more particularly of 7.4. In this way, an undesired precipitation of additives and/or an undesired emulsion formation can be prevented or at least reduced. The pH can be set or stabilised by adding a buffer, e.g. via a phosphate-buffered salt solution, PBS for short. A corresponding pH should be ensured in particular in a temperature range between 2° and 40° C., in particular between 25 and 37° C., alternatively between 2° and 30° C., alternatively again between 35 and 40° C.

In general it may be advantageous for the printing process if the pH of the starting material is above 8, in particular above 8.5, more particularly above 9. A corresponding pH provides a large printing or process window. Furthermore, a corresponding pH typically has a positive effect on the rheological properties of the starting material and on the optical properties, in particular the transparency, of the starting material.

As a further conceivable exemplary additive, the starting material can contain one or more of the following gelling agents, which can also serve as rheology modifiers. A gelling agent can be e.g. a polymer, in particular a polymer comprising carboxylic acids, e.g. polyacrylic acid, or cross-linked polyacrylic acids; or a polyvinyl alcohol or a derivative thereof; or a polysaccharide or a derivative thereof; or a peptide or protein or a derivative thereof, in particular gamma-carrageen; or gelatine or a derivative thereof. The addition of a gelling agent or in general a rheology modifier is preferred when the starting material contains a low-viscosity monomer or oligomer. The addition of a rheology modifier has been found to be particularly advantageous if the starting material contains a polyethylene glycol diacrylate derivative (PEGDA), in particular having a fraction of at least 10 wt. %, in particular at least 20 wt. %, more particularly at least 30 wt. %, more particularly at least 40 wt. %, more particularly at least 50 wt. %, more particularly at least 60 wt. %, more particularly at least 70 wt. %, more particularly at least 80 wt. %, more particularly at least 90 wt. %.

In one embodiment, the light of the first wavelength can be irradiated first in the first layer partial volume and then in the second layer partial volume with a distribution that is substantially homogeneous with respect to at least one of the following light parameters: light intensity and light color. In this way, substantially homogeneous illumination of the respective layer partial volume can be achieved. Alternatively it can be provided that the light of the first wavelength is irradiated first in the first layer partial volume and then in the second layer partial volume with a distribution that is substantially homogeneous with respect to at least one of the following light parameters, wherein the inhomogeneous distribution in the first layer partial volume can be different from the inhomogeneous distribution in the second layer partial volume. For example, for the light of the first wavelength a gradient for the light intensity can be formed over the width and/or the height of the layer partial volume.

The light of the second wavelength can be projected first onto the first layer partial volume and then onto the second layer partial volume, in each case with a distribution that is substantially non-homogeneous with respect to at least one of the following light parameters: light intensity and light color. While the light of the first wavelength can illuminate the respective layer partial volume as spatially homogeneously or uniformly as possible, the light of the second wavelength does not catch the starting material homogeneously in that layer partial volume, but rather in a manner corresponding to the non-homogeneous light distribution of the light projection directed thereto (of the light of the second wavelength), in order to thus correspondingly bring about the optical processing of the non-homogeneous light distribution (light parameter). This allows for the formation or production of a spatial outer contour. Optionally, different non-homogeneous light distributions (different projections) can be irradiated per layer partial volume.

When irradiating the first layer partial volume and/or when irradiating the second layer partial volume with the light of the first wavelength, a layer partial volume having a layer thickness of at most approximately 1 mm can be irradiated or caught. Alternatively, a layer partial volume having a layer thickness of at most approximately 500 μm can be irradiated. In a further alternative embodiment, a layer partial volume having a layer thickness of at most approximately 250 μm can be irradiated. A minimum layer thickness for irradiated layer partial volumes can be approximately 10 μm, particularly 1 μm, particularly less than 1 μm.

A plurality of optical elements can also be formed (at least in part) from the starting material (by means of the optical processing).

The formation of the at least one optical element can comprise formation of at least one of an optical lens, a lens of imaging quality, an intraocular lens, a lens array, a diffusor, a prism, an optical grating, a diffractive optical element, and an optical waveguide. The intraocular lens can in particular be an accommodating intraocular lens. In particular, formation of a (functional) contact lens can be provided. In other words, according to the method in particular an optical lens, a lens of imaging quality, an intraocular lens, in particular an accommodating intraocular lens, a lens array, a diffusor, a prism, an optical grating, a diffractive optical element, or an optical waveguide, can be produced.

In one embodiment, the optical element can be formed having a transmission of at least 10%, in particular at least 20%, more particularly at least 30%, more particularly at least 40%, more particularly at least 50%, more particularly at least 60%, more particularly at least 70%, more particularly at least 80%, more particularly at least 90%, in a range of 300 nm to 2500 nm, preferably of 380 nm to 2000 nm, more preferably of 400 nm to 1800 nm, most preferably of 450 nm to 1600 nm. In a further embodiment, the optical element can be formed having a surface roughness (rms) of at most 100 nm, preferably at most 50 nm, more preferably at most 30 nm, most preferably at most 10 nm. The transmission relates in particular to a thickness or wall thickness of the optical element or an optical path length corresponding to the Beer-Lambert law of the optical element of 1 mm or 10 mm. The smallest individual structures of the optical element can be of a size of 0.1 μm to 10 μm.

An optical element can have a transmission of at least 10%, in particular at least 20%, more particularly at least 30%, more particularly at least 40%, more particularly at least 50%, more particularly at least 60%, more particularly at least 70%, more particularly at least 80%, more particularly at least 90%, in a wavelength range of 300 nm to 2500 nm, preferably of 380 nm to 2000 nm, more preferably of 400 nm to 1800 nm, most preferably of 450 nm to 1600 nm. The transmission typically relates to a thickness or wall thickness of the optical element or an optical path length corresponding to the Beer-Lambert law of the optical element of 1 mm.

In at least some exemplary embodiments, the optical element can be configured to shape light. In particular, the optical element can be configured to refract, diffract, reflect, scatter, interfere and/or polarize light. The optical element can be configured as at least one of a spherical lens, an aspherical lens, a freeform lens, a Fresnel lens, a lens array, a diffusor, a prism, an optical grating, a diffractive optical element, and an optical waveguide.

The further processing of the green body can be free of photochemical post-curing and/or tempering and/or further process steps such as grinding, polishing and/or coating, in particular for forming the optical element having lower surface roughness.

At least one functional element can be provided in the starting material, in particular before and/or during the optical processing. Furthermore, the optical element can be formed at least in part adjacently to the at least one functional element. In particular, the optical element can be formed around the at least one functional element, preferably such that the formed optical element surrounds the at least one functional element at least in part (in particular completely).

The at least one functional element can be arranged at least in part, in particular completely, in the starting material and/or at least in part adjacently to the starting material. It can be provided to arrange the at least one functional element in the starting material by means of an arranging device.

The at least one functional element comprises at least one of the following elements: an actuator element, a sensor element, an energy source element (for providing electrical energy, for example a solar cell), a display, a lens holder (lens mount), and a prefabricated further optical element. Alternatively or additionally, the at least one functional element can comprise at least one optical component, in particular at least one of one or more apertures and optical filters.

The at least one prefabricated further optical element can be a lens, a lens array, an optical grating, a diffractive optical element, or an optical waveguide. The optical element can in particular be formed bound to a glass fiber and/or a light source.

The at least one prefabricated further optical element, particularly an optical waveguide, can have a coating, particularly a low refractive index coating and/or an anti-reflectance coating. Particularly the at least one functional element can have a refractive index that deviates (absolutely) from a low refractive index coating by at least 0.05, preferably at least 0.1, particularly preferably at least 0.2, particularly preferably at least 0.3, particularly preferably at least 0.4, particularly preferably at least 0.5, particularly preferably at least 0.6, particularly preferably at least 0.7, particularly preferably at least 0.8, particularly preferably at least 0.9. As an example, the at least one low refractive index coating and/or an anti-reflectance coating can comprise a coating based on Ti, Zn, Zr, Si, C, or F. Exemplary coatings can thus, comprise coatings comprising or consisting of TiO₂, ZnO, ZnS, ZrO₂, SiO₂, particularly MgF₂, BeF₂, AIF₃, NaAIF₄, for example. Respective coatings can be provided as gels, particularly as aerogels, more particularly porous silica aerogels.

Further, the optical element can comprise a lens, a lens array, an optical grating, a diffractive optical element, or an optical waveguide, particularly at least one interface between the surrounding optical element and a lens, a lens array, an optical grating, a diffractive optical element, or an optical waveguide can be an air gap.

Further, an optical element assembly can be manufactured, wherein the optical element assembly can comprise at least one first optical element, such as e.g. a lens or a lens array, and at least one second optical element, such as e.g. an optical waveguide, coupled with the at least one first optical element such that light can be guided from the at least one first optical element into the at least one second optical element or vice versa. As more concrete example, the optical element assembly can comprise at least two first optical elements, such as e.g. two lenses, and at least one second optical element, such as e.g. an optical waveguide, that connects the at least two first optical elements such that light can be guide from one first optical element to another first optical element via a second optical element which optically couples the at least two first optical elements. Further examples of optical element assemblies will be provided below.

The at least one functional element can comprise an optoelectronic component, in particular at least one of a light source (for example an LED chip or a laser diode) and an optical sensor (for example CMOS or CCD chip).

The at least one functional element can comprise at least one electronic component, in particular at least one of an electronic circuit, a resistive sensor, an electronic chip, a battery, an electrical lead, and an electrical terminal.

The at least one functional element can comprise at least one component which is provided with terminals at the surface, such that it is preferably possible to control a further electronic functional element and/or a prefabricated further optical element in the interior of the component. The at least one functional element can comprise at least one micropump or a mechanical actuator.

The at least one functional element can have a refractive index that is the same as or similar to the starting material, in particular such that no refraction of the light of the first and/or second wavelength occurs at the interface between the functional element and the starting material. The at least one functional element can have a (functional element) refractive index (and/or be formed having a (functional element) refractive index) that deviates (relatively) from a starting material refractive index by at most 3%, preferably at most 1%, particularly preferably at most 0.3%, particularly preferably at most 0.1%.

The optical element and/or the at least one functional element can have a refractive index that is higher than the refractive index of the starting material. Particularly, the refractive index of the optical element and/or the refractive index of the at least one functional element can differ (absolutely) from the refractive index of the starting material by at least 0.05, preferably at least 0.1, particularly preferably at least 0.2, particularly preferably at least 0.3, particularly preferably at least 0.4, particularly preferably at least 0.5, particularly preferably at least 0.6.

In at least some exemplary embodiments, the at least one functional element may be reflective or non-reflective.

The method can further comprise finalizing the (at least partially) formed optical element. The method can include laser machining and/or mechanical machining, particularly turning, such as e.g. diamond turning, lapping or polishing, of the optical element. The laser machining and/or the mechanical machining of the optical element are conceivable examples for a finalization of the (at least partially) formed optical element.

Finalizing the (at least partially) formed optical element can e.g. comprise reducing surface roughness, reducing deviations of the geometry or shape, reducing deviations of a curvature of one or more curved portions (if any), or minimizing a wave front error. As an example, finalizing the formed optical element can comprise reducing the thickness of the optical element by a certain amount, such as e.g. approximately 100 μm, and thereby reducing deviations of the geometry or shape, reducing deviations of the curvature, or minimizing the wave front error.

During optical processing, the starting material can be irradiated around the at least one functional element with light of the first wavelength and light of the second wavelength, from at least two sides, in particular two different sides, more particularly from four different sides. The irradiation from at least two sides in particular two sides, more particularly four sides, can take place simultaneously or in succession. For example, the optical processing of the functional element can take place in a first direction and (simultaneously or successively) in a second direction that is different from the first direction. In particular, the functional element can be rotated relative to the light source/light sources between optical processing in the first direction and optical processing in the second direction.

The irradiation can take place by means of light sources (of the first wavelength and/or second wavelength) that are arranged opposite one another, in particular such that the starting material is arranged between the opposing light sources.

The irradiation with light of the first wavelength and/or light of the second wavelength can take place using a plurality of light sources, such that the light is preferably irradiated into layer partial volumes which are superimposed at least in part. The at least one functional element can be arranged in the starting volume in such a way that does not impede the beam path of the light of the first and second wavelength, or impedes it as little as possible. In particular, a plurality of light sources can be used for providing the light of the first and/or second wavelength, in order to reach all the partial volumes around the functional element.

Alternatively, the light of one light source can be irradiated into the starting volume via the arrangement of light reflection elements, in particular mirrors, such that all the partial volumes around the functional element can be irradiated. Optionally, non-adjacent layer partial volumes can be irradiated in succession, wherein in particular first one part of the starting volume is processed in one direction, and subsequently a further part of the starting volume is processed in a direction different therefrom, preferably the opposite direction. In cases in which not all the partial volumes around the functional element can be irradiated, the described options can be used for minimizing the partial volumes that cannot be reached.

In particular, the light of the first wavelength can be radiated into the starting material by means of a mirror ring, wherein the starting material is arranged inside the mirror ring and/or along the axis of rotation of the mirror ring. In this way, a circular light section for the light of the first wavelength can be formed. The light of the second wavelength can be radiated into the starting material orthogonally to the light section.

In one embodiment, both a light section of the first wavelength and also the projector image of the second wavelength can be created by means of a (single or integrated) projection device and then irradiated onto/into the receiving vessel. In this case, an arrangement of light reflection elements, in particular mirrors, can be provided, in order to bring about a separation of the light section from a beam axis of the projection device and the irradiation of the light section transversely to the projection image the receiving vessel.

In one embodiment, the receiving vessel can be moved, in order to move the light section through the working volume. The projector image can be imaged sharply within the light section by means of variable focus optics. In one embodiment, the movement direction can be changed during the method, such that parts of the working volume are caused to cure in different directions. In a further embodiment, the receiving vessel remains immobile, and the light section is moved, for example in that a display element of the projection device, for example an LC- or a DM-display, is divided into a central region, which generates the projector image, and into two regions mounted laterally thereof, which create the light section. For this purpose, pixels of the display element can be actuated by means of actuating the optical transmission and/or reflection of the display element in such a way as to achieve a lateral shift of the light section. In this case, a central region of the display element can be irradiated with the first wavelength, and outer regions of the display element can be irradiated with the second wavelength.

The method can comprise irradiating light (at least) of a third wavelength onto the material to be processed, wherein the third wavelength is different from the first and the second wavelength, particularly wherein the third wavelength is between the first and second wavelength. In this case, the light of the third wavelength can for example be irradiated onto a layer partial volume currently being processed, at the same time as or temporally offset from the irradiation of the light of the second/first wavelength. For this purpose, the projection device or a further projection device can be used, in order to selectively limit the light irradiation onto the current layer partial volume. As a result, chemical/physical processes for material treatment initiated or occurring in the working volume of the material to be processed can be (additionally) influenced, for example when using polychromic multiphoton polymerization.

Further exemplary embodiments of the method, given by way of example, will be explained in the following:

In one exemplary embodiment, the starting material can, in particular after being filled into a container defining the working volume, be stirred for a given time, in particular of at least one hour, in particular at least six hours, more particularly at least twelve hours, more particularly at least eighteen hours, more particularly at least twenty hours. Corresponding stirring of the starting material can, as mentioned above, lead to desired rheological properties of the starting material, i.e. in particular a desired yield strength, being set.

Additionally or alternatively, the starting material can rest a certain resting time after being filled into a container defining the working volume. As an example, the starting material can rest for at least 15 minutes, particularly at least 30 minutes, more particularly at least 45 minutes, more particularly at least 60 minutes, more particularly at least 2 hours, more particularly at least 4 hours, more particularly at least 8 hours, more particularly at least 12 hours, more particularly at least 16 hours, more particularly at least 20 hours, more particularly at least 24 hours, more particularly at least 2 days, more particularly at least 3 days, more particularly at least 4 days, more particularly at least 5 days, more particularly at least 6 days, more particularly at least 7 days.

In a further exemplary embodiment, the starting material can undergo at least one process for removing impurities, in particular particulate impurities, before the irradiation, in particular before being filled into a container defining the working volume, wherein the process in particular comprises filtering the starting material by means of a filter device. Thus, any impurities which have a negative effect on the optical properties of the optical element to be produced can be removed, which has a correspondingly positive effect on the quality of the optical element to be produced.

In a further exemplary embodiment, the further processing of the green body, such that an optical element is formed at least in part, in particular completely, from the green body, in particular the post-curing of the green body, can be carried out under vacuum or a protective gas atmosphere, in particular an argon, carbon dioxide or nitrogen atmosphere. It was surprisingly found that further processing of the green body, in particular the post-curing of the green body, more particularly the photochemical and/or thermally post-curing of the green body, under vacuum or a corresponding protective gas atmosphere leads to better component surfaces. Specifically, in this way e.g. undesired sticky component surfaces can be avoided or at least reduced.

In a further exemplary embodiment, the further processing of the green body can comprise photochemical post-curing of the green body by means of at least one additional photoinitiator, wherein the additional photoinitiator is configured to perform a photochemical reaction, in a wavelength different from the first and the second wavelength, particularly between the first and second wavelength, that brings about photochemical post-curing of the green body. Therefore, photochemical post-curing of the green body can advantageously be carried out using an additional photoinitiator, which has no or the least possible absorption at the first and second wavelength, such that it is ensured that the additional photoinitiator does not or barely reacts in the case of irradiation of the starting material with the light of the first and second wavelength. An example for a corresponding additional photoinitiator is an alpha diketone, in particular camphorquinone, or a corresponding additional photoinitiator can contain at least one alpha diketone, in particular camphorquinone. Corresponding additional photoinitiators have proven to be particularly expedient if the first wavelength is less than 400 nm, in particular 375 nm, and the second wavelength is 500 nm or over 500 nm.

In general, an additional photoinitiator can be used, which has an absorption maximum between the first and the second wavelength. An example for a corresponding additional photoinitiator is an alpha diketone, in particular camphorquinone, the absorption maximum of which is approximately 470 nm. In one embodiment of the method, in which the first wavelength is below 420 nm and the second wavelength is above 500 nm, the absorption maximum of camphorquinone is thus therebetween.

In general, an additional photoinitiator can be used, which has an absorption in the wavelength range between 400 and 600 nm. As mentioned, the absorption maximum of the additional photoinitiator can be between the first and the second wavelength.

In general, an additional photoinitiator can be used, which changes its optical properties, i.e. in particular bleaches, in the case of irradiation with light of a wavelength that is between the first and second wavelength.

In general, an additional photoinitiator can be used, which has an extinction coefficient of less than 10,000 l/mol/cm, in particular less than 5000 l/mol/cm, more particularly 1000 l/mol/cm, more particularly less than 500 I/mol/cm, more particularly less than 300 I/mol/cm, more particularly less than 100 l/mol/cm, more particularly less than 50 l/mol/cm, more particularly less than 10 I/mol/cm, more particularly less than 1 I/mol/cm, at the first and/or second wavelength.

An additional photoinitiator can be: an alpha diketone, such as diacetyl, 3,4-hexanedione, for example.

Alternatively or additionally, an additional photoinitiator can be: an aromatic alpha diketone, such as benzil or a benzil derivative, or acenaphthoquinone.

Alternatively or additionally, an additional photoinitiator can be: a cyclic alpha diketone, such as camphorquinone or 1,2-cyclohexanedione.

Alternatively or additionally, an additional photoinitiator can be: an aliphatic alpha diketone, such as camphorquinone, diacetyl or 3,4-hexanedione.

In general, an additional photoinitiator can be contained e.g. in a specific concentration of 0.0001 to 10 wt. %, in particular between 0.01 and 2 wt. %, more particularly between 0.1 and 2 wt. %, more particularly between 0.1 and 1 wt. %.

The use of an additional photoinitiator which can be irradiated with visible light, in particular light in a wavelength range between 400 and 600 nm, preferably between 420 and 500 nm, is advantageous. Since the additional photoinitiator, as mentioned, can in particular be excited between the first and the second wavelength and barely exhibits any absorption at the first and the second wavelength, it does not or barely impairs the absorption of the starting material at the first and second wavelength, and a large penetration depth for the first and second wavelength during the formation of the object or green body results, such that an installation volume that is as large as possible results, and undesired secondary reactions with the first or second wavelength are prevented or at least reduced. In addition, a homogeneous post-curing of the object can be achieved even in the working volume. In this way, e.g. cracks in the surface of the object can be prevented or at least reduced; this is not the case if the additional photoinitiator is irradiated with light of a wavelength below the first wavelength.

In a further exemplary embodiment, the post-processing, in particular post-curing, of the object, in particular in the case of use of a corresponding additional photoinitiator, can include irradiating the object with light of a wavelength that is between the first and second wavelength. In this way, as mentioned, e.g. cracks in the surface of the object can be prevented or at least reduced; this is not the case if the additional photoinitiator is irradiated with light of a wavelength below the first wavelength. This can optionally constitute an independent aspect of the invention.

In a further exemplary embodiment, the green body can be irradiated with light of a wavelength that is between the first and second wavelength, wherein the absorption reduces at at least a wavelength that is between the first and second wavelength. In this way, the penetration depth for the light used for post-processing can be increased during the irradiation, as a result of which in particular the inner part of the green body can be efficiently post-processed, such that a homogeneously cured optical element results. This can optionally constitute an independent aspect of the invention.

In a further embodiment, the green body can be irradiated with light of a wavelength that is between the first and second wavelength, wherein the absorption reduces in the wavelength range between the first and second wavelength. In this way, the penetration depth for the light used for post-processing can be increased during the irradiation, as a result of which in particular the inner part of the green body can be efficiently post-processed, such that a homogeneously cured optical element results. This can optionally constitute an independent aspect of the invention.

In a further exemplary embodiment, the green body can be irradiated with light of a wavelength that is between the first and second wavelength, wherein the absorption reduces at the irradiation wavelength, which is between the first and second wavelength. In this way, the penetration depth for the light used for post-processing can be increased during the irradiation, as a result of which in particular the inner part of the green body can be efficiently post-processed, such that a homogeneously cured optical element results. This can optionally constitute an independent aspect of the invention.

In a further exemplary embodiment, the further processing of the green body can include treating the green body with a solvent and/or a monomer, in particular for washing the green body, wherein a solvent and/or a monomer having a molar mass of greater than or equal to 200 g/mol is used. Using a solvent or monomer having a correspondingly high molar mass makes it possible to prevent the solvent or monomer penetrating into the green body, as a result of which its properties may be impaired. A specific example for a corresponding solvent or monomer is tripropylene glycol monomethyl ether having a corresponding molar mass.

In a further exemplary embodiment, the further processing of the green body can include treating the green body with a solvent and/or a monomer, in particular for washing the green body, wherein a highly volatile solvent and/or a highly volatile monomer is used. The use of a highly volatile solvent or monomer makes it possible for drying processes of the green body to be accelerated and the method to thus be made even more efficient. A specific example for a corresponding low-molecular solvent or monomer is an alcohol, such as ethanol or isopropanol.

In a further exemplary embodiment, a starting material can be used that is free of inorganic and/or organic particles. In particular, a starting material can be used that is free of inorganic and/or organic particles of a diameter of greater than 50 μm can be used. This can also have a positive effect on the quality of the optical element to be produced according to the method, in particular because no impairments by inorganic and/or organic particles or nanoparticles are possible. The starting material can nonetheless contain inorganic and/or organic nanoparticles, i.e. in particular particles of a diameter of less than 50 nm, for example in order to set a desired refractive index. Corresponding nanoparticles can be present e.g. in a concentration of between 0.1 and 90 wt. %, in particular between 0.1 and 5 wt. %, more particularly between 0.3 and 2 wt. %, more particularly between 0.5 and 1.5 wt. %. Alternatively corresponding nanoparticles can be present e.g. in a concentration of between 0.1 and 90 wt. %, in particular between 20 and 80 wt. %, more particularly between 30 and 70 wt. %, more particularly between 40 and 60 wt. %. Corresponding nanoparticles can be e.g. SiO₂, ZrO₂ and TiO₂ nanoparticles.

In a further exemplary embodiment, a starting material can be used that contains exclusively organic components. This can also have a positive effect on the quality of the optical element to be produced according to the method, in particular because no impairments by inorganic components are possible.

In a further exemplary embodiment, a starting material can be used that is free of organic polymers. This can also have a positive effect on the quality of the optical element to be produced according to the method, in particular because no impairments by organic polymers are possible, which may possibly lead to undesired polymerization-related phase separations.

In a further exemplary embodiment, the optical element to be produced can have a main extension plane having a planar geometric shape. This applies e.g. for optical lenses. In such embodiments, the construction or printing direction of the optical element is expediently selected so as to be at an angle, in particular a right angle, to the main extension plane. In this way a sinking of the green body in the starting material, which may have a negative effect on the quality of the optical element to be produced, can be prevented or at least slowed.

It is in principle conceivable for all embodiments for the construction or printing direction to be selected from top to bottom, or vice versa. The construction or printing direction can thus be oriented along a vertical axis.

In a further embodiment, the first wavelength may be less than or equal to 400 nm, in particular less than or equal to 375 nm. Alternatively or additionally, the first or second wavelength can be 405 nm.

In a further exemplary embodiment, the starting material and/or the photoinitiator and/or a co-initiator can be free of amine bonds or can comprise less than 10 wt. %, in particular less than 5 wt. %, more particularly less than 4 wt. %, more particularly less than 3 wt. %, more particularly less than 2 wt. %, more particularly less than 1 wt. %, more particularly less than 0.5 wt. %, more particularly less than 0.25 wt. %, more particularly less than 0.1 wt. % of one or more amine bonds. This can also have a positive effect on the quality of the optical element to be produced according to the method, in particular because undesired interactions of corresponding amine bonds with the starting material can be prevented, which may have a negative effect on the component quality of the optical element to be produced. In particular, in this way undesired coloring or discoloration, in particular undesired yellowing, of the optical element to be produced can be prevented or at least reduced.

In a further exemplary embodiment, at least one first irradiation device can be used, which is configured such that it irradiates light of the first wavelength into the working volume in order to create at least one first light projection in the working volume, wherein the at least one first light projection comprises a plurality of light beams which pass through the working volume in at least one light plane. Furthermore, at least one light modulation device can be used, which is associated with the at least one first irradiation device, wherein the at least one light modulation device is configured such that it modulates the spatial extension direction of two or more light beams of the plurality of beams in the at least one light plane in such a way that the two or more light beams extend in a non-parallel arrangement relative to one another.

The at least one light modulation device is configured such that it modulates the spatial extension direction of two or more light beams of the plurality of beams in the at least one light plane in such a way that the two or more light beams extend in a non-parallel arrangement relative to one another. The at least one light modulation device can be configured such that it actively and/or passively changes the spatial extension direction and/or orientation of two or more light beams of the plurality of light beams in the at least one light plane in such a way that at least two of the plurality of light beams extend in a non-parallel arrangement relative to one another. The non-parallel arrangement of the at least two light beams in the at least one light plane typically leads to the at least two light beams intersecting at at least one intersection point within the at least one light plane. In particular, a plurality of intersection points, at which at least two light beams intersect, are created at different positions in the at least one light plane. In contrast to the light planes of conventional volumetric 3D printing devices which have a (substantially) parallel arrangement of (collimated) light beams without intersecting light beams, the at least one light modulation device of the device described here allows for purposeful changing of the spatial extension direction and/or orientation of at least two light beams within the at least one light plane, such that the at least two light beams extend in a non-parallel arrangement, the at least one light modulation device of the device described here allows for purposeful changing of the spatial extension direction and/or orientation of at least two light beams within the at least one light plane, such that the at least two light beams extend in a non-parallel arrangement relative to one another within the at least one light plane, which leads to one or more intersection points being created within the at least one light plane, at which points two or more light beams intersect.

In particular, the at least one light modulation device can be configured to influence the optical coherence of light beams within the at least one light plane, in particular to reduce it at least in part, in that the spatial extension direction and/or the orientation of at least two light beams is purposely changed in such a way that at least two light beams extend in a non-parallel arrangement relative to one another, which results in two or more light beams intersecting at one or more intersection points within the at least one light plane. A change in the spatial extension direction and/or orientation of at least two light beams, such that at least two light beams extend not in parallel with one another in the at least one light plane, also leads to the at least one light plane comprising light beams having angled spatial extension directions, while they cross, pass through or propagate in the working volume. In particular, at least two light beams can cross, pass through or propagate in the working volume at an angle relative to one another that is different from 0°. An intersection point of at least two light beams at one or more intersection points within the at least one light plane can also consist in at least two light beams being able to be superimposed at the one or more intersection points.

The at least one light modulation device can thus be configured to deflect two or more light beams within the at least one light plane, e.g. by diffraction and/or refraction and/or scattering, such that the at least one light plane comprises non-parallel and/or non-coherent light beams. The steering of light beams can include changing the spatial extension direction of one or more light beams, in particular with respect to an original spatial extension direction, such that the at least one light plane comprises non-parallel and/or non-coherent light beams. This is precisely the opposite operating principle from that of conventional light sheet generators, which are configured for creating light sheets from non-intersecting collimated light beams, i.e. light beams having a parallel spatial extension direction without intersections. As a result, in contrast with conventional light sheets or light sections, which substantially have a rectangular basic shape which is defined vertically by a parallel arrangement of topmost and bottom most light beams, the at least one light section, which is modified by the at least one light modulation device, can have a non-rectangular basic shape, e.g. a trapeze shape, within the working volume, which shape is defined vertically by non-parallel light beams.

In particular, the at least one light modulation device can be configured such that it generates modified light beams having different properties from a Gaussian beam. Thus, the at least one light modulation device can be configured such that it generates modified light beams which for example have a non-Gaussian beam profile. For example, the at least one light modulation device can be configured such that it generates modified light beams, specifically for example Airy beams or Bessel beams, or light beams having a characteristic that for example resembles Airy beams or Bessel beams.

Experiments have surprisingly shown that the purposeful creation of respective intersection points, at which two or more light beams intersect in at least one light plane, respective undesired artefacts, and thus undesired properties, such as (quasi) regular or irregular streaking artefacts or sliding artefacts, can be significantly reduced, which can lead to an improved optical appearance of the produced green body compared to a green body appearing as though it were constructed by layers, as is the case for example in conventional additive manufacturing according to principles of stereolithography and/or principles of digital light processing and/or volumetric printing methods, e.g. computed axial lithography (CAL) with an untilted rotation axis, i.e. a rotational axis arranged at an angle of 90° relative to the propagation direction of the light of the projections. The at least one light modulation device thus has a positive effect on the properties of the three-dimensional objects manufactured using the device.

The at least one light modulation device can comprise one or more optical elements, wherein each optical element is configured such that it changes the original spatial extension direction of the incident light beam, in order to create a light beam that has a different spatial extension direction relative to the original spatial extension direction. The optical elements can be configured as or comprise e.g. optical lenses, in particular microlenses, and/or optical diffusor elements, in particular elliptical diffusor elements.

The at least one light modulation device can be mounted so as to be movable, in particular relative to the working volume, in at least one translational and/or rotational degree of freedom of movement. In particular, the at least one light modulation device can be mounted so as to be movable in at least one spatial direction, in a uniform or oscillating movement. For this purpose, a corresponding drive coupled to the light modulation device, can be present, in particular in addition to an associated controller.

In principle, the at least one light modulation device can comprise one or more reflective and/or diffractive optical elements. It is conceivable that at least one optical element of the at least one light modulation device comprises e.g. a combination of at least two of: one or more respectively optically permeable surfaces, one or more respectively optically reflective surfaces, and/or one or more respectively optically diffractive surfaces, a combination of at least two of optically permeable surfaces, optically reflective surfaces and/or optically diffractive surfaces. Corresponding optically permeable surfaces and/or optically reflective surfaces and/or optically diffractive surfaces can for example be formed of or comprise one or more optically permeable coatings and/or reflective coatings and/or optically diffractive coatings.

In a further exemplary embodiment, at least one measure for changing the optical properties of the green body can be carried out. In this way, it is possible to ensure that the green body has the desired optical properties, i.e. in particular a desired transmission. The at least one measure can preferably include changing the optical properties of the green body, which leads to a reduction in the absorption properties of the green body or the optical element for at least a wavelength in a wavelength range between 300 nm and 2000 nm, in particular between 350 nm and 900 nm, and/or to an increase in the light permeability properties of the green body or the optical element for at least a wavelength in the wavelength range between 300 nm and 2000 nm, in particular in the wavelength range between 350 nm and 900 nm, in particular in the wavelength range between 400 nm and 800 nm.

The at least one measure for carrying out at least one measure for modifying the optical properties of the green body can include modifying the optical properties of the green body, which results in an average transmission or an integral of the transmission between 300 nm and 2000 nm, in particular between 350 nm and 900 nm, in particular between 400 nm and 800 nm, being reduced by at least 1%, in particular at least 2%, in particular at least 3%, in particular at least 4%, in particular at least 5%, in particular at least 7.5%, in particular at least 10%, in particular at least 15%, in particular at least 20%, in particular at least 25%, in particular at least 30%, in particular at least 35%, in particular at least 40%, in particular at least 45%, in particular at least 50%, in particular compared with a state of the green body before it has undergone the at least one measure. Alternatively or additionally, the at least one measure for carrying out at least one measure for changing the optical properties of the green body can include changing the optical properties of the green body, which results in an average absorption or an integral of the absorption between 300 nm and 2000 nm, in particular between 350 nm and 900 nm, in particular between 400 nm and 800 nm, being reduced by at least 1%, in particular at least 2%, in particular at least 3%, in particular at least 4%, in particular at least 5%, in particular at least 7.5%, in particular at least 10%, in particular at least 15%, in particular at least 20%, in particular at least 25%, in particular at least 30%, in particular at least 35%, in particular at least 40%, in particular at least 45%, in particular at least 50%, in particular compared with a state of the green body before it has undergone the at least one measure.

Therefore, an optical element can in general be understood as any element that has an average or integrated absorption per mm thickness of the element for each wavelength in the wavelength range between 300 nm and 2000 nm, in particular between 400 nm and 900 nm, more particularly between 500 nm and 850 nm, more particularly between 600 nm and 800 nm, more particularly between 650 nm and 750 nm, of less than 0.5, in particular of less than 0.3, in particular of less than 0.2, in particular of less than 0.1.

The at least one measure can include changing the optical property of the green body, which leads to an average or integrated absorption per mm thickness of the green body of less than 0.5, in particular of less than 0.3, more particularly of less than 0.2, more particularly of less than 0.1, in a wavelength range between 300 nm and 2000 nm, in particular 350 nm and 900 nm, more particularly between 400 nm and 800 nm. In particular, the average or integrated absorption per mm thickness of the green body can be less than 0.5, in particular less than 0.3, in particular less than 0.2, in particular less than 0.1, for each wavelength in the wavelength range between 300 nm and 2000 nm, in particular 350 nm and 900 nm, in particular between 400 nm and 800 nm.

In particular, the average or integrated absorption per mm thickness of the optical element can be less than 0.5, in particular less than 0.3, in particular less than 0.2, in particular less than 0.1, for each wavelength in the wavelength range between 300 nm and 2000 nm, in particular 350 nm and 900 nm, in particular between 400 nm and 800 nm.

The at least one measure can include e.g. thermal treatment of the green body and/or optical treatment of the green body, in particular by irradiating the green body using electromagnetic radiation, and/or chemical treatment of the green body.

The thermal treatment can include aging of the green body at a temperature between 5° and 150° C., in particular between 75 and 125° C., in particular for a duration of between 1 and 24 h min, more particularly between 1 and 20 h, more particularly between 1 and 16 h, more particularly between 1 and 12 h, more particularly between 1 and 8 h, more particularly between 1 and 4 h, more particularly between 1 and 30 min.

The optical treatment can include irradiating the green body with electromagnetic radiation of a wavelength of between 350 nm and 1000 nm, in particular between 400 nm and 800 nm, more particularly between 350 nm and 500 nm or between 420 nm and 800 nm, in particular for a duration between 0.5 and 180 min, between 5 and 60 min.

The optical treatment of the green body can take place in the working volume or after removal of the green body from the working volume.

The three-dimensional object can undergo controlled tempering (heating and/or cooling). Controlled tempering can include heating the three-dimensional object to a temperature in the range between 50° C. and 150° C. for a time in the range between 1 min and 60 min, in particular between 5 min and 30 min, for example. Controlled tempering can include implementing one or more specific temperature ramps from a lower temperature to a higher temperature or vice versa.

The three-dimensional object resulting from an optical treatment can undergo tempering after the optical treatment, wherein the temperature-control can in particular include heating the green body to a temperature in the range between 50° C. and 150° C. for a time in the range between 1 min and 60 min, in particular 5 min and 30 min.

The chemical treatment can include e.g. the chemical change, in particular by oxidation and/or reduction, of the chromophore molecules, in particular the remaining photoinitiator molecules, of the green body, wherein the molecules have a (visible) color in the visible wavelength spectrum of between 380 nm and 750 nanometers, using at least one chemical modification agent, e.g. an oxidation or reduction agent.

Specifically, the at least one chemical modification agent can be or comprise a chlorine-based substance, in particular chlorine, hypochlorite, chlorine dioxide, or an oxygen-based substance, in particular ozone, oxygen, peroxide, perborate, percarbonate, peracetic acid, or chlorine or a chlorine compound.

The at least one chemical modification agent can be added to the photopolymerized material after the formation of the green body, in that the three-dimensional object is placed in a solution, in particular an organic solution, for a specific time, which solution contains the at least one chemical modification agent, wherein the at least one chemical modification agent migrates out of the solution into the three-dimensional object and possibly remaining co-initiator and/or photoinitiator migrates out of the three-dimensional object into the solution.

The at least one chemical modification agent can be configured in such a way that it changes the chromophore properties of the original chromophore molecules, in particular of the remaining photoinitiator molecules, of the photopolymerizable material (starting material) and/or of the chromophore of the green body resulting from the photopolymerization process, or the at least one chemical modification agent is configured in such a way that it generates a reactive agent which is configured such that it changes the chromophore properties of the chromophore molecules, in particular the remaining photoinitiator molecules, of the green body under the influence of electromagnetic energy, in particular thermal energy and/or radiation energy.

It is the case for all the embodiments that the optical processing of the starting material can also take place using at least one combined light section. A corresponding combined light section can be created e.g. as follows: a first light section is created, which extends along an extension axis through the starting material, and a second light section is created, in which the first light section emerging from the starting material is reflected by at least one reflection element, and the reflected light section thus created extends (substantially) along the extension axis of the first light section, again through the starting material. In principle, every light section described herein can be a corresponding combined light section. It is likewise conceivable for a plurality of combined light sections to be used, which extend through the working volume from at least two, in particular at least three, more particularly at least four, different sides. The extension axes of the respective combined light sections can be oriented at any desired angle relative to one another, i.e. e.g. at an angle of approximately 90°.

A corresponding reflection element can e.g. be or comprise: at least one flat mirror, at least one mirror that is curved once or multiple times, e.g. a doubly concave mirror, at least one plan-convex cylinder lens, at least one plano-concave cylinder lens, etc. Combinations of at least two of the same or different of the above-mentioned reflection elements are conceivable.

Further exemplary embodiments of the method of the first aspect of the invention will be provided in the following:

The method typically comprises performing a volumetric printing process to manufacture at least one optical element, particularly at least one optical element for an AR device and/or VR device. The volumetric printing process comprises at least one irradiation process which comprises irradiating a photocurable resin with light of at least one wavelength to form, by photopolymerization, particularly by multi-color photopolymerization, more particularly by dual-color photopolymerization, at least one optical element, particularly at least one optical element for an AR device and/or VR device. The method thus, enables implementing a volumetric printing process for manufacturing at least one optical element, particularly at least one optical element for an AR device and/or VR device.

As mentioned above, the volumetric printing process comprises at least one irradiation process which comprises irradiating a photocurable resin with light of at least one wavelength to form, by photopolymerization, particularly by multi-color photopolymerization, more particularly by dual-color photopolymerization, at least one optical element, particularly at least one optical element for an AR device and/or VR device. The method can thus, comprise at least one irradiation process which comprises irradiating, typically on basis of a plurality of printing parameters, a photocurable resin with light of a first wavelength and light of a second wavelength, which is different from the first wavelength, to form, by multi-color photopolymerization, particularly by dual-color photopolymerization, a three-dimensional object in the shape of at least one optical element in at least one direction. The at least one direction can be or comprise a formation direction of the respective optical element to be manufactured and thus, printed, i.e. the or a direction in which the respective optical element is printed. The method generally, enables volumetric printing of one or more optical elements in the at least one (formation) direction. As such, the terms “manufacturing” and “printing” can have the same meaning herein.

In exemplary embodiments in which the at least one irradiation process comprises irradiating the photocurable resin with light of a first wavelength and light of a second wavelength, which is different from the first wavelength, the light of the first wavelength can e.g. comprise a wavelength in the range of: 350 nm-500 nm, particularly 375 nm-450 nm, more particularly 385 nm-440 nm, more particularly 395 nm-420, more particularly 400 nm-410 nm, and the light of the second wavelength can e.g. comprise a wavelength in the range of: 400 nm-1000 nm, particularly 425-750 nm, more particularly 450-675 nm, more particularly 500-650 nm. The light of the first wavelength can comprise a spectrum of wavelengths, particularly at least partly covering the respective ranges. Typically, the first wavelength will be chosen at least under consideration of the photochemical properties, particularly the photochromic properties, of the photoinitiator molecules of at least one photoinitiator of the photocurable resin. Also the light of the second wavelength can comprise a spectrum of wavelengths, particularly at least partly covering the respective ranges. Preferably, the light of the second wavelength can comprise a wavelength in a range which does not include the first wavelength. Typically, the second wavelength will be chosen at least under consideration of the photochemical properties, particularly the photochromic properties, of the photoinitiator molecules of at least one photoinitiator of the photocurable resin.

Typically, the photocurable resin is irradiated with the light of the first wavelength and the light of the second wavelength such that the light of the first wavelength and the light of the second wavelength intersect in the or a formation zone. The formation zone can be deemed the zone in which the photopolymerization of the photocurable resin takes place which results in photocuring and/or solidification, respectively of the photocurable resin and forming at least a cross-section of the at least one optical element to be printed. However, the formation zone can also comprise a volume, in which the light of the first wavelength and the light of the second wavelength do not intersect, adjacent to the volume, in which the light of the first wavelength and the light of the second wavelength intersect. Such a volume, in which the light of the first wavelength and the light of the second wavelength do not intersect, can e.g. be downstream of the volume, in which the light of the first wavelength and the light of the second wavelength intersect, with respect to the formation direction. Particularly, the formation zone can comprise a volume, which has been irradiated with the light of the first wavelength, such that molecules of the dual color photoinitiator have been transferred to the intermediate state. In the formation zone, the concentration of the dual color photoinitiator can exceed a certain minimum concentration required for curing of the photocurable resin such that, when the formation zone is irradiated with the light of second wavelength, the photocurable resin cures.

As such, the light of the first wavelength can be irradiated into the photocurable resin at a different angle and/or in a different direction relative to the light of the second wavelength. As an example, the light of the first wavelength can be irradiated into the photocurable resin at an angle of ca. 90° relative to the light of the second wavelength. Particularly, the light of the first wavelength can be irradiated at an acute angle into the photocurable resin, which can also be provided as film, or the working volume or relative to at least one wall of a container which delimits the working volume. An exemplary acute angle can range between 3° and 85°, particularly between 4° and 50°. According to a concrete example, the light of the first wavelength can be irradiated at an angle of substantially 45° relative to at least one wall of a container which delimits the working volume.

The light of the first wavelength can comprise a light sheet which can comprise a plurality of light beams extending through the photocurable resin. Respective light beams can comprise two or more (substantially) parallel light beams. Respective light beams can intersect in one or more intersection points; respective intersection points can be (substantially) arranged in a common plane which can define a light plane. Additionally or alternatively, respective light beams can comprise a light plane, for instance. A light plane can be or comprise a light plane in which the or a plurality of light beams, such as e.g. (substantially) parallel light beams, extend adjacent such that there is no intermediate space between directly adjacent light beams. Notably, at least some of the directly adjacent light beams can also partially overlap. Alternatively, a light plane can be or comprise a light plane in which the or a plurality of light beams extend adjacent such that there is an intermediate space between directly adjacent light beams. Respective light beams can be generated by a directed light emission device, such as e.g. a laser device, which can form part of an irradiation device of a volumetric printing apparatus used for implementing the method, for instance.

A respective light sheet or light beam, respectively can comprise a main extension which can be generally understood as the extension direction of the respective individual light sheet or light beam between opposing walls or wall portions of a container delimiting a working volume of the method. Particularly, the main extension direction of each respective light sheet or light beam can be understood as the main propagation direction of the light of the light sheet or light beam between opposing walls or wall portions of a container delimiting the working volume. Hence, the main extension direction of a respective light sheet or light beam can correspond to a direction along a line which halves the divergence or divergence angle, respectively of the light sheet or light beam within the working volume.

The height direction or height extension of a respective light sheet or light beam can be generally understood as the direction with maximum spatial extension which extends orthogonal to the main extension direction. Particularly, the height direction or height extension can be a direction or extension parallel to a wall or wall portion of a container delimiting the working volume through which wall or wall portion, respectively the light sheet or light beam enters the working volume.

The light of the second wavelength can comprise a projection of images corresponding to a cross-sectional geometry of an optical element to be printed or a plurality of points or lines corresponding to a cross-sectional geometry of the optical element to be printed. Respective points or lines can form a pattern, such as e.g. a hatch pattern. A respective projection can be generated by a light projection device, such as e.g. a digital light projection device, which can form part of an irradiation device of a volumetric printing apparatus used for implementing the method. As an example, the light projection device can be or comprise a digital micromirror device (DMD) or a liquid-crystal display (LCD) configured to generate the different images corresponding to a cross-sectional geometry of an optical element, which can form part of an irradiation device of a volumetric printing apparatus used for implementing the method. Additionally or alternatively, a respective point or line can be generated by a directed light emission device, such as e.g. a laser device, which can form part of an irradiation device of a volumetric printing apparatus used for implementing the method, for instance.

Respective printing parameters of the at least one irradiation process and thus, respective printing parameters used for implementing the at least one irradiation process can generally be or comprise parameters of the at least one irradiation process which influence the spatial and/or temporal irradiation of the photocurable resin with the light of the first and/or the second wavelength. Respective printing parameters can additionally or alternatively be or comprise the number of irradiation steps in which one or more volume elements, e.g. voxels, of the photocurable resin are irradiated with the light of the first wavelength and/or with the light of the second wavelength. As such, respective printing parameters can be or comprise control parameters of a volumetric printing apparatus for implementing the method which control parameters concern the spatial and/or temporal irradiation of the photocurable resin with the light of the first and the second wavelength to form, particularly by multi-color photopolymerization, more particularly by dual-color photopolymerization, an optical element in at least one direction. Particularly, respective printing parameters can be or comprise control parameters of an irradiation device of a respective volumetric printing apparatus which irradiation device is configured to irradiate a photocurable resin with light of a respective first and second wavelength to form, by multi-color photopolymerization, particularly by dual-color photopolymerization, an optical element in at least one direction. Respective printing parameters can also be or comprise control parameters of a drive device of a respective volumetric printing apparatus which drive device is configured to move the photocurable resin or a container containing the photocurable resin in the at least one direction, for instance.

The inventors surprisingly found that implementing a volumetric printing technique, particularly a volumetric printing technique which comprises at least one irradiation process of irradiating a photocurable resin with light of at least one wavelength, particularly with light of at least a respective first wavelength and light of a respective second wavelength, for forming, by photopolymerization, particularly by multi-color photopolymerization, more particularly by dual-color photopolymerization, at least one optical element for an AR device and/or VR device has several advantages. Particularly, the inventors found that implementing a volumetric printing technique, which comprises at least one irradiation process of irradiating a photocurable resin with light of at least one wavelength, particularly with light of at least a respective first wavelength and a respective second wavelength, for forming, by photopolymerization, particularly by multi-color photopolymerization, more particularly by dual-color photopolymerization, at least one optical element, can be highly beneficial for manufacturing at least one optical element for an AR device and/or VR device. Specifically, the inventors surprisingly found that advantages over existing manufacturing techniques for manufacturing respective optical elements components have unexpectedly been observed, such as e.g. a more efficient manufacturing, higher design freedom, high resolution of the printed optical elements, improved properties of the printed optical elements, when implementing a respective volumetric printing process which has not been known for producing three-dimensional objects, such as optical elements. Importantly, the inventors surprisingly found that optical elements manufactured by a volumetric printing technique, particularly a volumetric printing technique comprising a dual-color photopolymerization, as described herein benefit from isotropic properties and/or improved surface properties, particularly smoother surfaces, which can lead to improved optical properties of the respective optical elements. Moreover, the inventors surprisingly found that optical elements manufactured by a volumetric printing technique, particularly a volumetric printing technique comprising a dual-color photopolymerization, as described herein are particularly well suited to include at least one functional element, particularly at least one further optical element, more particularly a waveguide, in the photocurable resin during photopolymerization which allows the efficient manufacture of optical elements comprising one or more functional elements suited for the use in an AR device and/or VR device. As such the inventors also surprisingly found that optical elements manufactured by a volumetric printing technique, particularly a volumetric printing technique comprising a dual-color photopolymerization, as described herein can be used to manufacture optical elements comprising one or more optical elements and/or functional elements, such as e.g. waveguides or gratings, in an efficient manner and improved quality compared to traditional manufacturing methods.

As such, the method specified herein enables an improved principle for manufacturing at least one optical element, particularly at least one optical element for an AR device and/or VR device, which is based on the implementation of a volumetric printing technique for manufacturing the at least one optical element.

The at least one optical element which can be manufactured in accordance with the method described herein can generally have a high transmission (optical transmission) in a wavelength range between 400 nm and 800 nm, particularly between 450 nm and 700 nm, more particularly between 480 nm and 650 nm. Particularly, the at least one optical element which can be manufactured in accordance with the method described herein can have a transmission (optical transmission) of at least 70%, particularly of at least 71%, more particularly of at least 72%, more particularly of at least 73%, more particularly of at least 74%, more particularly of at least 75%, more particularly of at least 76%, more particularly of at least 77%, more particularly of at least 78%, more particularly of at least 79%, more particularly of at least 80%, more particularly of at least 81%, more particularly of at least 82%, more particularly of at least 83%; more particularly of at least 84%, more particularly of at least 85%, more particularly of at least 86%, more particularly of at least 87%, more particularly of at least 88%, more particularly of at least 89%, more particularly of at least 90%, more particularly of at least 91%, more particularly of at least 92%, more particularly of at least 93%; more particularly of at least 94%, more particularly of at least 95%, more particularly of at least 96%, more particularly of at least 97%, more particularly of at least 98%, more particularly of at least 99%, in a wavelength range between 400 nm and 800 nm, particularly between 450 nm and 700 nm, more particularly between 480 nm and 650 nm, for instance. The aforementioned values can form part of lower or upper thresholds of one or more intervals.

Hence, the optical properties, particularly the resulting transmission properties, of the at least one optical element after completion of the volumetric printing process may comprise a high transparency in the visible wavelength range. Hence, the at least one optical element can show no or only little absorption in the visible wavelength range after completion of the volumetric printing process. Transparency in the visible wavelength range typically means that the transmission of the at least one optical element in the visible wavelength range is above 80% and/or that the absorbance of the at least one optical element in the visible wavelength range, particularly at at least one wavelength in the visible wavelength range, is below 0.5, particularly below 0.4, more particularly below 0.3. The absorption and/or transmission of the at least one optical element object can generally be determined/measured, particularly in the center of the optical element, with a UV-Vis-NIR spectrophotometer of the type “Cary 50” available from Agilent Technologies, Inc., for instance.

Further, the at least one optical element which can be manufactured in accordance with the method described herein can generally have a relatively high Abbe number in a wavelength range between 400 nm and 800 nm, particularly between 450 nm and 700 nm, more particularly between 480 nm and 650 nm. Particularly, the at least one optical element can have an Abbe number of at least 20, particularly of at least 30, more particularly of at least 40, more particularly of at least 50, more particularly of at least 60, more particularly of at least 70, more particularly of at least 80, more particularly of at least 90, in a wavelength range between 400 nm and 800 nm, particularly between 450 nm and 700 nm, more particularly between 480 nm and 650 nm, for instance. The aforementioned values can form part of lower or upper thresholds of one or more intervals. The Abbe number of the at least one optical element object can generally be determined/measured with any suitable refractometer, for instance. Generally, the Abbe number is an approximate measure of a material's dispersion (change in refractive index as a function of wavelength), with high values indicating low dispersion. A more detailed definition of the Abbe number can be found in Bach, Hans et al.: The Properties of Optical Glass. Schott Series on Glass and Glass Ceramics. Schott Glass. doi: 10.1007/978-3-642-57769-7.

Particularly, the at least one optical element which can be manufactured in accordance with the method described herein can have a specific combination of Abbe number and refractive index. More particularly, the at least one optical element which can be manufactured in accordance with the method described herein can have a specific combination of comparatively high Abbe number with a comparatively high refractive index.

Generally, the photocurable resin processed in the volumetric printing process can comprise properties, particularly mechanical properties, optical properties, thermal properties, water absorption properties, etc., of known injection molding materials, such as cyclic olefin polymers, cyclic olefin copolymers, polycarbonates, polymethylmethacrylates, polyesters, etc., or articles molded therefrom. Particularly, the photocurable resin processed in the volumetric printing process can comprise high mechanical properties, such as e.g. high tensile strength, combined with high optical properties, such as e.g. high transmission, low birefringence, etc. The same applies to the at least one optical element manufactured in accordance with the method. As an example, the photocurable resin can have same or similar properties as a polycarbonate grade commercially available under the tradename “Makrolon”; such a polycarbonate grade can e.g. comprise an Abbe number of 30 and a refractive index of 1.58. As another example, the photocurable resin can have same or similar properties as a cyclic olefin copolymer commercially under the tradename “Topas”, “Apel”, or “Zeonex”; such a cyclic olefin copolymer grade can e.g. comprise an Abbe number of 56 and a refractive index of 1.53.

Particularly, the photocurable resin processed in the volumetric printing process can exhibit birefringence lower than 0,1, particularly lower than 0,075, more particularly lower than 0,05, more particularly lower than 0,025, more particularly lower than 0,01, more particularly substantially zero. Likewise, the at least one optical element manufactured with the method can exhibit birefringence lower than 0,1, particularly lower than 0,075, more particularly lower than 0,05, more particularly lower than 0,025, more particularly lower than 0,01, more particularly lower than 0.001, more particularly lower than 0,0001, more particularly lower than 0,00001, more particularly substantially zero. The aforementioned values relate to the maximum difference between the two refractive indices exhibited by the photocurable resin. In absolute values, the birefringence of the photocurable resin can be <10 nm/cm, for example. The birefringence can be measured in accordance with ISO 10110-2, ISO 10110-18:2018, or ISO 11455:1995.

As another example, the photocurable resin processed in the volumetric printing process can contain sulfur or a sulfur-compound of at least 5 wt.-%, particularly of a least 10 wt.-%, more particularly of a least 15 wt.-%, more particularly of a least 20 wt.-%, more particularly of a least 25 wt.-%. A respective sulfur content of at least 5 wt.-%, particularly of a least 10 wt.-%, more particularly of a least 15 wt.-%, more particularly of a least 20 wt.-%, more particularly of a least 25 wt.-%, was surprisingly identified as having a positive effect on the properties, particularly optical properties, of the at least one optical element manufactured with the method.

Examples and thus, non-limiting exemplary embodiments of optical elements which can be manufactured in accordance with the method described herein will be provided in the following. Notably, one, more or all of the exemplary embodiments and examples can be arbitrarily combined.

As an example, the at least one optical element can be, comprise, or form part of a reflective optical element, such as e.g. a mirror, a refractive optical element, or a diffractive optical element. The at least one optical element can thus, have reflective optical properties, refractive optical properties, or diffractive optical properties.

The at least one optical element can be formed with a surface structuring, particularly a regular or irregular surface structuring. A respective surface structuring can comprise a regular, partly regular, irregular, or partly irregular arrangement of recessed portions and/or elevated surface portions with respect to reference plane. A respective surface structuring can enable or enhance specific optical properties of the at least one optical element. As an example, a respective surface structuring can enable or enhance reflective optical properties, refractive optical properties, or diffractive optical properties of the at least one optical element. The inventors have surprisingly found that the realization of respective optically effective surface structuring can be implemented with the method described herein in highly accurate and efficient manners, which is mainly due to the high resolution of the volumetric printing process which enables generating highly filigree surface structures.

The at least one optical element can exhibit comparatively low birefringence, sometimes also called double refraction. As such, the at least one optical element or the photocurable resin from which it has been manufactured can have a refractive index that does not depend on the polarization and propagation direction of light impinging thereon. In such a manner, undesired optical effects based on birefringence can be avoided. As mentioned above, the at least one optical element can exhibit birefringence lower than 0,1, particularly lower than 0,075, more particularly lower than 0,05, more particularly lower than 0,025, more particularly lower than 0,01, more particularly lower than 0.001, more particularly lower than 0,0001, more particularly lower than 0,00001, more particularly substantially zero. The aforementioned values relate to the maximum difference between the two refractive indices exhibited by the photocurable resin. In absolute values, the birefringence of the at least one optical element can be <10 nm/cm, for example. Particularly, the at least one optical element can exhibit birefringence lower than 50 nm/cm, particularly lower than 30 nm/cm, more particularly lower than 10 nm/cm, more particularly lower than 5 nm/cm, more particularly lower than 2 nm/cm, more particularly lower than 1 nm/cm, more particularly lower than 0.5 nm/cm, more particularly lower than 0.1 nm/cm, more particularly substantially zero. The birefringence can be measured in accordance with ISO 10110-2, ISO 10110-18:2018, or ISO 11455:1995. In contrast to common methods of manufacturing optical elements, such as e.g. molding, milling, or machining, the method as specified herein has been found to exhibit comparatively less heat generation introducing surprisingly low or no birefringence. This renders optical elements manufactured by a volumetric printing process particularly well suited for an AR device and/or VR device.

As a further example, the at least one optical element can be, comprise, or form part of an optical deflection element. A respective optical deflection element comprises at least one deflection surface. The at least one deflection surface can be configured to deflect incident light, such as e.g. an incident light beam. The at least one deflection surface can be formed by at least one coating, structuring, etc. which enables deflecting incident light, such as e.g. an incident light beam. The at least one deflection surface can be, comprise, or form part of a curved surface, particularly a concave or convex surface. Further, the at least one deflection surface can be, comprise, or form part of at least one inclined surface, particularly an inclined surface which is inclined relative to the propagation direction of an incident light beam. An inclination angle of the at least one inclined surface can e.g. be an acute angle or an obtuse angle relative to an axis parallel to the propagation direction of an incident light beam.

As a further example, the at least one optical element can be, comprise, or form part of, at least one light splitting element. The at least one optical element can thus, generally have, e.g. based on its surface, particularly surface properties, its shape and/or its material, light splitting properties which enable that at least one light beam is split into at least two light beams. A respective surface or respective surface properties which enable respective light splitting properties can also be achieved via one or more coatings applies to at least one surface of the at least one optical element.

As a further example, the at least one optical element can be, comprise, or form part of, at least one light combining element. The at least one optical element can thus, generally have, e.g. based on its surface, particularly surface properties, its shape and/or its material, light combining properties which enable that at least two light beams are combined into at least one light beam. A respective surface or respective surface properties which enable respective light combining properties can also be achieved via one or more coatings applies to at least one surface of the at least one optical element.

As a further example, the at least one optical element can be, comprise, or form part of a geometric body comprising two or more parallel surfaces and/or two or more non-parallel surfaces, particularly at least to non-parallel flat surfaces. A respective geometric body can thus, be or comprise a polyhedron or a prismatoid or a prism. However, the shape of the geometric body is not limited to a polyhedron or a prismatoid or a prism.

Hence, the at least one optical element can be, comprise, or form part of a prism. A prism typically comprises at least two parallel surfaces, such as e.g. a base surface and a top surface. As a concrete example, a prism can be a triangular prism. A prism having dispersive optical properties (dispersive prism) can be a more concrete example of a light splitting element. A prism having dichroic properties (dichroic prism) can be a more concrete example of a light combining element.

As a further example, the at least one optical element can be, comprise, or form part of at least one optical guiding element, particularly a light guiding element, such as e.g. a waveguide. The at least one optical element can thus, generally have, e.g. based on its shape and/or material, light guiding properties which enable that light can enter at at least one (optical) inlet, propagate at least partially therethrough, and exit at at least one (optical) outlet. The at least one optical guiding element can generally, comprise at least one (optical) inlet via which light, such as e.g. polarized or non-polarized light, can enter the at least one optical guiding element and at least one (optical) outlet via which light that has propagated at least partially through the at least one optical guiding element can exit the at least one optical guiding element. The at least one optical guiding element can thus, define, particularly between a respective (optical) inlet and a respective (optical) outlet, a propagation path along which light can propagate at least partially through the at least one optical guiding element.

As a first more concrete example, the at least one optical element can be, comprise, or form part of at least one glass of a spectacle (spectacles glass). The spectacle can comprise smart glasses or form part of smart glasses. As such, the method can be used to manufacture a glass of a spectacle or a part thereof, wherein the spectacle comprises smart glasses or forms part of smart glasses.

A respective glass of a spectacle can e.g. have the following dimensions: a maximum diameter ranging between 1-100 mm, a maximum thickness ranging between 0,1-10 mm, a maximum radius of curvature ranging between 50-1100 mm.

Typically, the dimensions of the at least one glass of a spectacle will be determined by an intended application and/or an intended use of the at least one glass of a spectacle and thus, based on the actual constructive and/or functional configuration of an AR device and/or VR device equipped with or to be equipped with the at least one glass of a spectacle. As an example, for a glass to be used in smart glasses, the maximum diameter of the optical glass can be 80 mm, for example. Similarly, the thickness of the at least one optical element and particularly, the thickness of a respective glass, respectively will typically depend from the actual configuration of the at least one optical element and from the optical properties, particularly the refractive index, of the material forming the at least one optical element. As an example, the at least one optical element, particularly a respective glass, can have a thickness ranging between 0.25 mm-25 mm.

As a second more concrete example, the at least one optical element can be, comprise, or form part of at least one optical lens. Particularly, the at least one optical element which can be manufactured in accordance with the method described herein is, comprises, or forms part of at least one of the following: an optical lens of a light beam source of a respective AR device and/or VR device, an optical lens of a light image source of a respective AR device and/or VR device, an optical lens of a light sensor, such as e.g. a camera, etc.

The shape of a respective at least one optical lens manufactured in accordance with the method described herein can be at least one of the following: convex, biconvex, plano-convex, positive meniscus, concave, biconcave, plano-concave, negative meniscus. An optical lens which has been manufactured in accordance with the method described herein can thus, generally be, comprise or form part of a converging lens, such as e.g. a convex lens, a biconvex lens, a plano-convex lens, a positive meniscus lens, or a diverging lens, such as e.g. a concave lens, a biconcave lens, a plano-concave lens, a negative meniscus lens.

A respective optical lens can e.g. have at least one of the following dimensions: a maximum diameter ranging between 1-100 mm, a maximum thickness ranging between 0,1-10 mm, a maximum radius of curvature ranging between 50-1100 mm.

Typically, the dimensions of the at least one optical lens will be determined by an intended application and/or an intended use of the at least one optical lens and thus, based on the actual constructive and/or functional configuration of an AR device and/or VR device equipped with or to be equipped with the at least one optical lens. As an example, for an optical lens to be used in an optical sensor device, such as e.g. a camera, the maximum diameter of the optical lens can be 10 mm, for example. As another example, for an optical lens to be used in a light image source, such as e.g. a light projector device, the maximum diameter of the optical lens can be 20 mm, for example. As another example, for an optical glass to be used in smart glasses, the maximum diameter of the optical glass can be 80 mm, for example. Similarly, the thickness of the at least one optical element and particularly, the thickness of a respective optical lens, respectively will typically depend from the actual configuration of the at least one optical element and from the optical properties, particularly the refractive index, of the material forming the at least one optical element. As an example, the at least one optical element, particularly a respective optical lens, can have a thickness ranging between 0.25 mm-25 mm.

The method can comprise manufacturing an optical element assembly comprising one or more optical elements and/or one or more functional elements for an AR device and/or VR device via the volumetric printing process. As an example, the method can comprise manufacturing an optical element assembly comprising two or more optical elements for an AR device and/or VR device via the volumetric printing process. The method can thus, comprise performing a volumetric printing process to manufacture an optical element assembly comprising at least two optical elements for an AR device and/or VR device, wherein the volumetric printing process comprises at least one irradiation process which comprises irradiating a photocurable resin with light of a first wavelength and light of a second wavelength, which is different from the first wavelength, to form at least two optical elements for AR device and/or VR device. The at least two optical elements can thus, be formed in the same container and working volume, respectively of a volumetric printing apparatus used for implementing the method. In other words, one single volumetric printing process can be used to manufacture a plurality of optical elements for an AR device and/or VR device. Particularly, one single volumetric printing process can be used to manufacture a plurality of optical elements forming an optical element assembly. The optical element assembly can comprise an optical arrangement, such as e.g. a stacked optical arrangement, of an AR device and/or VR device. This can be beneficial since two, more than two, or all optical elements of an optical arrangement for an AR device and/or VR device can be manufactured in one single volumetric printing process which can enable a highly efficient manufacturing possibility for manufacturing a respective optical arrangement.

Non-limiting examples of a respective optical element assembly can comprise one or more optical elements, particularly two or more optical elements, which can be connected with at least one functional element. Examples of respective optical elements can be or comprise glasses, lenses, parts of glasses, parts of lenses, etc. A respective functional element which is connected to the one, two or more optical elements can be or comprise light guiding properties. Examples of a respective functional element(s) can thus, be or comprise a waveguide or a part of a waveguide. An exemplary configuration of a respective optical element assembly can thus, comprise a first glass or lens and a second glass or lens, wherein the first glass or lens is connected with the second glass or lens via at least one functional element which comprises light guiding properties. Another exemplary configuration of a respective optical element assembly can thus, comprise a first glass or lens and a second glass or lens, wherein the first glass or lens is connected with the second glass or lens and wherein at least one functional element which comprises light guiding properties is arranged between the first glass or lens and the second glass or lens. The at least one functional element can thus, be arranged between the first glass or lens and the second glass or lens. Hence, the connection of two optical elements via the at least one functional element can comprise both a mechanical and an optical connection.

As mentioned earlier, the entire optical element assembly can be manufactured in a volumetric printing process. However, it is conceivable that only parts of an optical element assembly are manufactured in a volumetric printing process and other parts of the optical element assembly are provided after the volumetric printing process. For an exemplary optical element assembly which comprises two or more optical elements and at least one functional element, the following manufacturing scheme can apply: the two or more optical elements are manufactured in a first volumetric printing process and the at least one functional element is manufactured in a separate manufacturing process. The separate manufacturing process can comprise a second volumetric printing process or any other manufacturing process, such as e.g. a machining process, a molding process, etc. The manufacturing scheme can further comprise a connection process in which the two or more optical elements are connected with the at least one functional element. Particularly, the at least one functional element can be arranged between the two or more optical elements to connect same with each other. As mentioned above, the connection via the at least one functional element can comprise both a mechanical and an optical connection. However, a physical connection between the two or more optical elements and the at least one functional element is not necessarily required. As such, exemplary configurations of a respective optical assembly can also comprise that the at least one functional element, which can e.g. be or comprise a waveguide, can be arranged in a receiving space, such as e.g. a slit, without a physical connection with the two or more optical elements.

Other examples of a respective functional element can comprise at least part of a light beam source, at least part of a light image source, such as e.g. a projector, at least part of a display, at least part of a light sensor, particularly forming part of a camera, at least part of a structural device, such as e.g. a frame element, a housing element, etc. at least part of an AR device and/or VR device.

Generally, at least two optical elements, such as e.g. two optical lenses, which are manufactured in the same volumetric printing process can comprise same or different properties as the properties of the respective optical elements manufactured in the same volumetric printing process can be adjusted by deliberately changing one or more printing parameters of the volumetric printing process. Particularly, the at least two optical elements which are manufactured in the same volumetric printing process can comprise same or different geometric properties, such as e.g. shape, size, thickness, as the geometric properties of the respective optical elements manufactured in the same volumetric printing process can be adjusted by deliberately changing one or more printing parameters of the volumetric printing process. Manufacturing at least two optical elements with different geometric properties can be useful to compensate for vision deviations between a left and a right eye of a user of an AR device and/or VR device.

The same applies for at least two optical elements which are not manufactured in the same volumetric process, but in different manufacturing processes, particularly in different volumetric printing processes. Hence, any AR device and/or VR device can generally comprise at least two optical elements, such as e.g. two optical lenses, having same or different properties, such as e.g. geometric properties, optical properties, mechanical properties, etc.

As such, the at least two optical elements which are manufactured in the same volumetric printing process can be equal or different e.g. in at least one of the following properties: optical properties, particularly optical absorptive properties with respect to light of a specific wavelength range, transmissive properties with respect to light of a specific wavelength range, reflective properties with respect to light of a specific wavelength range, diffractive properties with respect to light of a specific wavelength range, or refractive properties with respect to light of a specific wavelength range, or geometric properties, such as e.g. shape, size, thickness.

As a more concrete example for at least two optical elements which have different optical properties, the refractive index of at least a first optical element can be different from the refractive index of at least second optical element. Hence, the refractive index of at least a first optical element can be n1, and the refractive index of at least a second optical element can be n2, wherein n1≥n2+0.01, for instance. As a further example, a first optical element can have a first refractive index n1 and a first Abbe number V1, and a second optical element can have a second refractive index n2 and a second Abbe number V2, wherein particularly n1≥n2 and V2>V1, or wherein particularly n1 and n2 differ by less than 0.03 and V1-V2>10, for instance. In such a manner, an arrangement of optical elements with outstanding optical properties can be manufactured as possible drawbacks of a first material of a first optical element which has a relatively high dispersion, can be compensated with a second material of a second optical element which has a relatively low dispersion.

As indicated further above, the at least two optical elements can be connected with each other or are isolated from each other. As such, the volumetric printing process can be used to manufacture at least two optical elements which are connected with each other (i.e. connected at at least one connection portion, which can e.g. be or comprise a connection point, a connection line, or a connection area) or are isolated from each other (i.e. not connected). Any connection of the at least two optical elements can be facilitated via at least one connection element. A respective connection element is an example of a frame structure mentioned further above. Another respective connection element is an example of a functional element mentioned further above. A respective connection element can thus, have light guiding properties. Any connection of the at least two optical elements can be or comprise a provisional connection, i.e. a connection which is to be later removed, or a non-provisional connection, i.e. a connection which is not to be removed. In either case, a respective connection can enable that the at least two optical elements can be provided in a defined spatial arrangement and/or orientation relative to each other. Notably, such a defined spatial arrangement and/or orientation of at least two optical elements relative to each other can be the actual spatial arrangement and/or orientation of the at least two optical elements as required for a specific AR device and/or VR device. As such, defined stacks of at least two optical elements can be manufactured in one single volumetric printing process with respect to a specific AR device and/or VR device, for example. Additionally or alternatively, a respective connection can enable that the at least two optical elements are moveably supported relative to each other in at least one degree of freedom of motion. Such a configuration enables adjusting the spatial arrangement and/or orientation of the at least two optical elements relative to each other. Adjusting the spatial arrangement and/or orientation of the at least two optical elements, which can be or comprise lenses, for example, relative to each other can e.g. enable that optical elements are adapted to the eye distance of a user of an AR device and/or VR device equipped with the at least two optical elements. Adjusting the spatial arrangement and/or orientation of the at least two optical elements, which can e.g. be or comprise lenses, can e.g. enable that the distance between the optical elements and the eyes is adapted for a user of an AR device and/or VR device equipped with the at least two optical elements.

If two or more optical elements are isolated from each other, they can be connected separately, e.g. after completion of the volumetric printing process. A respective connection can be facilitated by chemical or physical connection technique. Examples of a respective chemical connection technique can comprise adhesive connection techniques, i.e. the use of one or more adhesives to connect two or more optical elements with each other via one or more adhesives. Respective adhesives can particularly, be or comprise adhesives having a refractive index which is matched with the refractive index of at least one of the at least two optical elements. Examples of a respective physical connection technique can comprise mechanical connection techniques, such as e.g. pressing, positive locking, screwing, etc. As such, it is possible to connect two or more optical elements to form an arrangement of optical elements, particularly a stack of optical elements. If two or more optical elements of such an arrangement are to be connected with each other, the connection can be established via an adhesive, particularly an adhesive which comprises a refractive index matching the refractive index of at least one of the two or more optical elements.

Exemplary embodiments of the method and related examples will be specified in the following. Notably, one, more or all of the exemplary embodiments and examples can be arbitrarily combined.

According to an exemplary embodiment, the photocurable resin can be provided in a container delimiting a container volume. The container volume can comprise the or a working volume which includes the photocurable resin and in which the at least one optical element can be printed in accordance with the method. One or more walls of the container can be made of a material which enables irradiating the photocurable resin inside the container with the light of the at least one wavelength. A respective material can be, at least with respect to the light of the at least one wavelength, a transparent material, for instance. A respective transparent material can be or comprise glass or a polymer, such as e.g. polycarbonate, polymethylmethacrylate, or cyclic olefin copolymer, for instance.

According to another exemplary embodiment, the at least one irradiation process can comprise irradiating a photocurable resin with light of at least a first wavelength and a second wavelength, different from the first wavelength, to form, by multi-color photopolymerization, particularly by dual-color photopolymerization, the at least one optical element (as indicated above). Concrete examples of respective first and second wavelengths have been provided further above. The at least one irradiation process can thus, comprise multi-color photopolymerization, particularly dual-color photopolymerization, of a photocurable resin which provides several benefits for manufacturing optical elements, such as e.g. faster manufacturing, higher design complexity, and higher resolution.

The inventors have surprisingly found that using a first wavelength ranging between 400 nm and 500 nm, particularly between 400 nm and 450 nm, more particularly between 400 nm and 440 nm, more particularly between 400 nm and 430 nm, more particularly between 400 and 420, more particularly between 400 nm and 410 nm, can be beneficial for producing optical elements with good optical properties for being used in an AR device and/or VR device. As such, the first wavelength is preferably ranging between 400 nm and 500 nm, particularly between 400 nm and 450 nm, more particularly between 400 nm and 440 nm, more particularly between 400 nm and 430 nm, more particularly between 400 and 420, more particularly between 400 nm and 410 nm. This is particularly, based on the unexpected insight of the inventors that photocurable materials, particularly photocurable materials with a refractive index of at least 1.55, more particularly at least 1.56, more particularly at least 1.58, more particularly at least 1.6, more particularly at least 1.62, more particularly at least 1.65, most particularly at least 1.7, to be used for manufacturing the at least one optical which facilitate manufacturing optical elements with good optical properties for being used in an AR device and/or VR device can require a first wavelength in one of the aforementioned ranges.

Likewise, the inventors have surprising found that using a second wavelength ranging between 400 nm and 800 nm, particularly between 450-700 nm, more particularly between 480-650 nm, can be beneficial for producing optical elements with good optical properties for being used in an AR device and/or VR device. As such, the second wavelength is preferably ranging between 400 nm and 800 nm, particularly between 450-700 nm, more particularly between 480-650 nm. This is particularly, based on the unexpected insight of the inventors that photocurable materials to be used for manufacturing the at least one optical which facilitate manufacturing optical elements with good optical properties for being used in an AR device and/or VR device can require a second wavelength in one of the aforementioned ranges.

Even though the aforementioned preferred ranges of the first wavelength and second wavelength are indeed overlapping, the method can, when being implemented with a first and a second wavelength, use a second wavelength which is different from the first wavelength.

In such exemplary embodiments, irradiating the photocurable resin with the light of the first wavelength can cause one or more photoinitiator molecules of the photocurable resin to transfer from an initial state into an intermediate state with changed optical properties compared to the initial state, such that the photoinitiator molecules of the one or more photoinitiators in the intermediate state can absorb the light of the second wavelength which results in that the photoinitiator molecules of the one or more photoinitiators are transferred from the intermediate state to a reactive state by absorption of light of the second wavelength which locally triggers the polymerization of the photocurable resin to form the at least one optical element.

As an example, the photocurable resin can be a photocurable monomer resin or a photocurable oligomer resin, which may e.g. include acrylates, methacrylates, thiol+ene, epoxides, oxiranes, oxetanes, or vinylethers, for instance. Multi-color photopolymerization can comprise multi-photon photopolymerization, particularly dual-photon photopolymerization, of the photocurable resin. Photopolymerization of the photocurable resin is typically effected by irradiating the photocurable resin with the light of the first wavelength and, particularly simultaneously, the light of the second wavelength, which is different from the first wavelength, which results in that photoinitiator molecules of the one or more photoinitiators of the photocurable resin are converted, e.g., due to the absorption of the light of the first wavelength, from an initial state in which the molecules of the one or more photoinitiators (substantially) do not absorb the light of the second wavelength, into an intermediate state with changed optical properties compared to the initial state, such that the photoinitiator molecules of the one or more photoinitiators in the intermediate state absorb the light of the second wavelength which results in that the molecules of the one or more photoinitiators are transferred from the intermediate state to a reactive state which locally triggers the polymerization of the photocurable resin to form at least one optical element.

A back reaction of the photoinitiator molecules of the one or more photoinitiators from the intermediate state into the initial state can be thermally induced, for instance. Hence, the intermediate state may return thermally at the printing temperature of the photocurable resin to the initial state. Preferably, the intermediate state may return thermally at the respective printing temperature to the initial state in a reaction or reaction sequence with one or more rate constants with the highest rate constant higher than k=0.01 s⁻¹. Especially preferably, at least one rate constant for the thermal back reaction is higher than 0.02 s⁻¹, more preferably higher than 0.05 s⁻¹, even more preferably higher than 0.1 s⁻¹, still more preferably higher than 1.0 s⁻¹, most preferably higher than 5.0 s⁻¹. Hence, the rate constant may be in the range of 0.05 s⁻¹ and 1.0 s⁻¹, or any other range which may be formed from the values above. A high rate constant may result in an improved resolution of the printed optical element.

Alternatively, the intermediate state may substantially not return thermally at the respective printing temperature of the photocurable resin to the initial state. Preferably, the intermediate state may return thermally at the printing temperature to the initial state in a reaction or reaction sequence with one or more rate constants with at least one rate constant lower than k=100 s⁻¹. Especially preferably, at least one rate constant for the thermal back reaction is lower than 1 s⁻¹, more preferably lower than 0.1 s⁻¹, even more preferably lower than 0.01 s⁻¹, still more preferably lower than 0.001 s⁻¹, most preferably lower than 0.0001 s⁻¹. Hence, the rate constant may be in the range of 0.1 s⁻¹ and 0.0001 s⁻¹, or any other range which may be formed from the values above.

Further alternatively, the intermediate state may substantially not return thermally at the printing temperature of the photocurable resin to the initial state. Preferably, the intermediate state may return thermally at the printing temperature to the initial state in a reaction or reaction sequence with one or more rate constants with the highest rate constant lower than k=100 s⁻¹. Especially preferably, the highest rate constant for the thermal back reaction is lower than 1 s⁻¹, more preferably lower than 0.1 s⁻¹, even more preferably lower than 0.01 s⁻¹, still more preferably lower than 0.001 s⁻¹, most preferably lower than 0.0001 s⁻¹. Hence, the rate constant may be in the range of 0.1 s⁻¹ and 0.0001 s⁻¹, or any other range which may be formed from the values above.

According to another exemplary embodiment, the photocurable resin can have non-Newtonian flow properties, i.e. shear-thinning flow properties and/or has a yield point that is greater than the static shear stress caused by the three-dimensional object. The yield point of the photocurable resin can be determined, for example, by rotational rheometry (e.g. via a plate-plate rheometer) under quasi-static load via a ‘creep test’ or by running a slow shear stress ramp.

A corresponding yield point of the photocurable resin, which is greater than the static shear load from the object, is typically greater than or equal to 0.1 Pa, particularly greater than or equal to 0.2 Pa, more particularly greater than or equal to 0.3 Pa, more particularly greater than or equal to 0.4 Pa, more particularly greater than or equal to 0.5 Pa, more particularly greater than or equal to 0.6 Pa, more particularly greater than or equal to 0.75 Pa, more particularly greater than or equal to 1 Pa. A corresponding yield point of the photocurable resin can therefore in particular be at least 0.1 Pa per cm³ of the working volume. For a working volume of 1 cm³, the yield point of the photocurable resin can be at least 0.1 Pa. For a working volume of 2 cm³, the yield point of the photocurable resin can be at least 0.2 Pa.

The static shear stress caused by the three-dimensional object depends in particular on the geometry and size of the three-dimensional object and can be less or greater than 0.5 Pa, depending on the geometry and size of the three-dimensional object. In order to realize corresponding rheological properties of the monomer mixture or the oligomer mixture, generally of the photocurable resin, it may be expedient to allow the monomer mixture or the oligomer mixture, generally the photocurable resin, to rest before optical processing, i.e. before printing. The photocurable resin can thus, in particular after being filled into a container defining the working volume, be left to rest for a certain time, in particular at least one hour, in particular at least six hours, in particular at least twelve hours.

A respective yield point of photocurable resin can be set by admixing oligomers and polymers with non-Newtonian flow properties and/or by admixing additives (rheological modifiers), for instance. Experiments have surprisingly shown that the use of a photocurable resin having respective non-Newtonian flow properties can be beneficial for the volumetric printing process and can result in improved properties of optical elements printed with the volumetric printing process. Particularly, the use of a photocurable resin having a respective non-Newtonian rheological behavior can facilitate manufacturing a three-dimensional object which remains (substantially) fixed in position within the working volume during formation which typically improves the result of the volumetric printing process.

Exemplary suitable photocurable resins and exemplary suitable photoinitiators of a respective photocurable resin are e.g. known from U.S. Pat. No. 5,230,986A, WO2020245456A1, WO2023034398A1, WO2023034404A1, WO2023034402A1, WO2023220461A1, WO2023220463A1, the contents of which are incorporated herein by reference.

Further exemplary suitable photocurable resins comprise photocurable resins that are based on or comprise at least one of: an acrylate or methacrylate, particularly a phenol-based acrylate or phenol-based methacrylate, more particularly a bisphenol-based acrylate or a bisphenol-based methacrylate, a urethane, particularly a thio-urethane or urethane acrylate or a urethane methacrylate, a carbonate, an aromatic, a thiol, particularly a thiol-ether or a thiol-diether. Notably, the inventors have found that such photocurable resins typically exhibit only a small change of its optical properties, such as particularly its absorptive, refractive, diffractive, or transmissive properties, or (substantially) no change of its optical properties, such as particularly its absorptive, refractive, diffractive, or transmissive properties during the polymerization of the photocurable resin during the volumetric printing process.

As mentioned above, the photocurable resin can comprise properties, particularly mechanical properties, optical properties, thermal properties, water absorption properties, etc., of known injection molding materials, such as cyclic olefin polymers, cyclic olefin copolymers, polycarbonates, polymethylmethacrylates, polyesters, etc., or articles molded therefrom. Particularly, the photocurable resin can comprise high mechanical properties, such as e.g. high tensile strength, combined with high optical properties, such as e.g. high transmission, low birefringence, etc. As an example, the photocurable resin can have same or similar properties as a polycarbonate grade commercially available under the tradename “Makrolon”; such a polycarbonate grade can e.g. comprise an Abbe number of 30 and a refractive index of 1.58. As another example, the photocurable resin can have same or similar properties as a cyclic olefin copolymer commercially under the tradename “Topas”, “Apel”, or “Zeonex”; such a cyclic olefin copolymer grade can e.g. comprise an Abbe number of 56 and a refractive index of 1.53.

Generally, the at least one optical element can be made from a photocurable resin which exhibits only a small change of its optical properties, such as particularly its absorptive, refractive, diffractive, or transmissive properties, or (substantially) no change of its optical properties, such as particularly its absorptive, refractive, diffractive, or transmissive properties during the polymerization of the photocurable resin during the volumetric printing process. More particularly, the at least one optical element can be made from a photocurable resin which exhibits a maximum change of 10% its optical properties during the polymerization of the photocurable resin during the volumetric printing process. The degree of change of the respective optical properties can be measured via digital light scattering or UV vis spectroscopy, for example.

As such, the at least one optical element can be made from a photocurable resin comprising sulfur atoms and/or aromatic moieties, particularly thioether groups, diphenyl sulfide groups, carbamoylthio groups, fluorene groups, thiophene groups, thiazole groups, bisphenoyl A groups, thiophenyl groups, more particularly at least one of the following compounds:

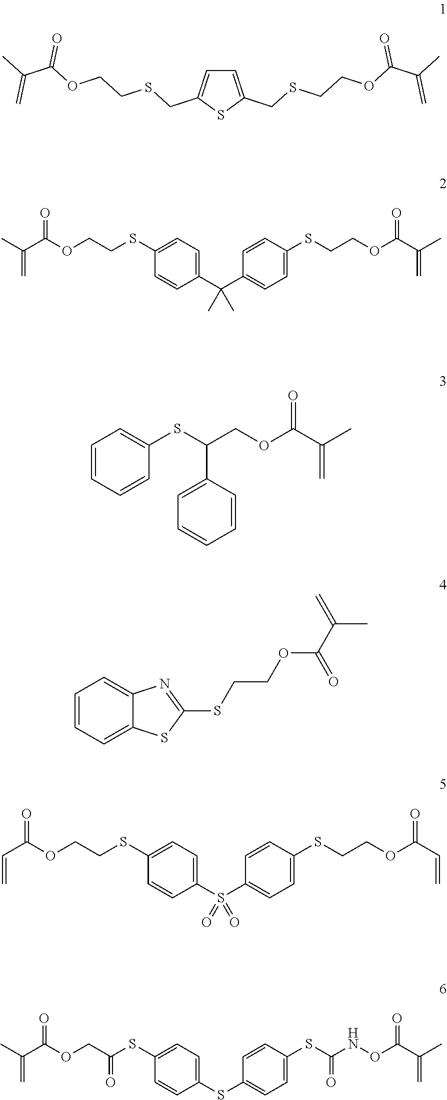

More concrete examples of compounds which can be comprised in a respective photocurable resin are described in at least one of WO2008101806A2, WO2020225685A1, WO2023203845A1, WO2018075848A1, U.S. Pat. No. 6,528,601B1, the contents of which are incorporated herein by reference.

Particularly, the at least one optical element can be made from a photocurable resin which exhibits only a small degree of hazing or no hazing during the polymerization of the photocurable resin during the volumetric printing process. More particularly, the at least one optical element can be made from a photocurable resin which exhibits only a degree of hazing during the polymerization of the photocurable resin, wherein the degree of hazing before the polymerization differs from the degree of hazing after the polymerization not more than 10%, particularly not more than 1%, more particularly not more than 0.1%. The degree of hazing can be measured via digital light scattering, for example.

Particularly, the at least one optical element can be made from a photocurable resin which exhibits only a small degree of polymerization-induced phase separation or no polymerization-induced phase separation during the polymerization of the photocurable resin during the volumetric printing process. More particularly, the at least one optical element can be made from a photocurable resin which exhibits small degree of polymerization-induced phase separation during the polymerization of the photocurable resin, wherein the degree of hazing before the polymerization differs from the degree of polymerization-induced phase separation after the polymerization not more than 10%, particularly not more than 1%, more particularly not more than 0.1%. The degree of polymerization-induced phase separation can be measured via digital light scattering, for example.

Particularly, the at least one optical element can be made from a photocurable resin which has a refractive index of at least 1.30, particularly at least 1.32, more particularly at least 1.34, more particularly at least 1.36, more particularly at least 1.38, more particularly at least 1.40, more particularly at least 1.42, more particularly at least 1.44, more particularly at least 1.46, more particularly at least 1.48, more particularly at least 1.50, more particularly at least 1.52, more particularly at least 1.54, more particularly at least 1.56, more particularly at least 1.58, more particularly at least 1.59, more particularly at least 1.60, more particularly at least 1.62, more particularly at least 1.64, more particularly at least 1.66, more particularly at least 1.68, more particularly at least 1.70, more particularly at least 1.72, more particularly at least 1.74, more particularly at least 1.76, more particularly at least 1.78. The refractive index can be measured with any suitable refractometer, for instance.

As such, the at least one optical element which has been manufactured in accordance with the method described herein can generally comprise a refractive index of at least 1.30, particularly at least 1.31, more particularly at least 1.32, more particularly at least 1.33, more particularly at least 1.34, more particularly at least 1.35, more particularly at least 1.36, more particularly at least 1.37, more particularly at least 1.38, more particularly at least 1.39, more particularly at least 1.40, more particularly at least 1.41, more particularly at least 1.42, more particularly at least 1.43, more particularly at least 1.44, more particularly at least 1.45, more particularly at least 1.46, more particularly at least 1.47, more particularly at least 1.48, more particularly at least 1.49, more particularly at least 1.50, more particularly at least 1.51, more particularly at least 1.52, more particularly at least 1.53, more particularly at least 1.54, more particularly at least 1.55, more particularly at least 1.56, more particularly at least 1.57, more particularly at least 1.58, more particularly at least 1.59, more particularly at least 1.60, more particularly at least 1.62, more particularly at least 1.64, more particularly at least 1.66, more particularly at least 1.68, more particularly at least 1.70, more particularly at least 1.72, more particularly at least 1.74, more particularly at least 1.76, more particularly at least 1.78. The aforementioned values can, mainly depend on the photocurable resin processed in the volumetric printing process, and can relate to the optical element after completion of the volumetric printing process, or can relate to the optical element after completion of a post-processing process which is done after completion of the volumetric printing process.

Particularly, the at least one optical element can be made from a photocurable resin which can comprise at least one additive which enhances one or more optical properties of the at least one optical element.

Generally, the at least one additive can be or comprise a solid. Particularly, the at least one additive can comprise particles. As such, the at least one additive can be or comprise a particulate material which can e.g. ease preparing, e.g. by stirring, a mixture—a respective mixture can be a colloid or a dispersion, for instance—of the photocurable resin and the at least one additive with a desired distribution of the additive particles within the photocurable resin. A desired distribution is typically a homogenous distribution of the additive particles within the photocurable resin.

As an example, respective particles of the at least one additive can comprise at least one of the following shapes: a spherical shape or a non-spherical shape, particularly a plate-like shape or a longitudinal shape or an ellipsoid shape. Also the shape of the particles can be (in addition to other parameters such as e.g. its type, chemistry, size, etc.) a parameter for influencing and customizing, respectively, the properties of an optical element to be printed and will thus, be typically selected with respect to a concrete intended use of the optical element to be printed.

As an example, respective particles of the at least one additive can comprise a spatial extension of less than 100 nm, particularly less than 90 nm, more particularly less than 80 nm, more particularly less than 70 nm, more particularly less than 60 nm, more particularly less than 50 nm, more particularly less than 40 nm, more particularly less than 30 nm, more particularly less than 20 nm, more particularly less than 10 nm, more particularly less than 7.5 nm, more particularly less than 5 nm, more particularly less than 1 nm. The expression “spatial extension” can depend on the shape or base shape, respectively of the respective particles. For particles having a spherical shape or spherical base shape, respectively, the expression “spatial extension” can refer to a diameter, particularly a mean diameter, for particles having an ellipsoid shape or ellipsoid base shape, respectively, the expression “spatial extension” can refer to the long diameter or the short diameter, particularly the long diameter, of the particles. For particles having a plate-like shape or plate-like base shape, respectively, having a longitudinal axis, the expression “spatial extension” can refer to an extension along the longitudinal axis. For particles having a longitudinal shape or longitudinal base shape, respectively, the expression “spatial extension” can refer to an extension along the longitudinal axis of a respective particle or to the maximum distance between the edges of a respective particle. Generally, the expression “spatial extension” can refer to the maximum distance between two points arranged on opposite sides of a respective particle.

Specifically, the particles of the at least one additive can be or comprise nano-particles which can be of advantage for the at least one irradiation process as issues with undesired interactions of the light with the at least one inorganic additive can be avoided. As such, the size of the particles can generally, be in the nanometer-range.

Particularly, the at least one additive can be or comprise at least one of the following: one or more nano-particles, particularly functionalized nano-particles, to increase the refractive index of the photocurable resin, one or more UV-blocking agents, particularly one or more UV-blocking agents absorbing below 400 nm, for example. More particularly, the at least one optical element can be made from a photocurable resin which can comprise at least one additive which increases or decreases the refractive index and/or which increases the Abbe number of the at least one optical element. The at least one additive which increases the refractive index and/or which increases the Abbe number can be or comprise nano-particles.

As an example, the at least one additive can be or comprise a material having a refractive index of at least 1.30, particularly at least 1.31, more particularly at least 1.32, more particularly at least 1.33, more particularly at least 1.34, more particularly at least 1.35, more particularly at least 1.36, more particularly at least 1.37, more particularly at least 1.38, more particularly at least 1.39, more particularly at least 1.40, more particularly at least 1.41, more particularly at least 1.42, more particularly at least 1.43, more particularly at least 1.44, more particularly at least 1.45, more particularly at least 1.46, more particularly at least 1.47, more particularly at least 1.48, more particularly at least 1.49, more particularly at least 1.50, more particularly at least 1.51, more particularly at least 1.52, more particularly at least 1.53, more particularly at least 1.54, more particularly at least 1.55, more particularly at least 1.56, more particularly at least 1.57, more particularly at least 1.58, more particularly at least 1.59, more particularly at least 1.60, more particularly at least 1.62, more particularly at least 1.64, more particularly at least 1.66, more particularly at least 1.68, more particularly at least 1.70, more particularly at least 1.72, more particularly at least 1.74, more particularly at least 1.76, more particularly at least 1.78, in a wavelength range between 400 nm and 800 nm, particularly between 450 nm and 700 nm, more particularly between 480 nm and 650 nm, for instance. Non-limiting examples of respective particles comprise particles based on Ti, Zn, Zr, Si, or C, such as e.g. TiO₂, ZnO, ZnS, ZrO₂, SiO₂, diamond. The refractive index can be measured with any suitable refractometer, for instance.

As another example, the at least one additive can be or comprise a material having a refractive index of at most 1.40. Non-limiting examples of respective particles comprise particles based on F, such as e.g. MgF₂, BeF₂, or NasAIF₆, or silica. The refractive index can be measured with any suitable refractometer, for instance.

As another example, the at least one additive can be or comprise a material having an Abbe number of at least 20, particularly of at least 40, more particularly of at least 50, more particularly of at least 70, in a wavelength range between 400 nm and 800 nm, particularly between 450 nm and 700 nm, more particularly between 480 nm and 650 nm, for instance.

As another example, the photocurable resin can have an Abbe number of at least 20, particularly of at least 30, more particularly of at least 40, more particularly of at least 50, more particularly of at least 60, more particularly of at least 70, in a wavelength range between 400 nm and 800 nm, particularly between 450 nm and 700 nm, more particularly between 480 nm and 650 nm, for instance.

Generally, the at least one optical element can be made from a photocurable resin which can comprise at least one additive which is present an amount of at least 5 wt.-%, particularly at least 10 wt.-% more particularly at least 15 wt.-%, more particularly at least 20 wt.-%, more particularly at least 25 wt.-%, more particularly at least 30 wt.-%, more particularly at least 35 wt.-%, more particularly at least 40 wt.-%, more particularly at least 45 wt.-%, more particularly at least 50 wt.-%, more particularly at least 55 wt.-%, more particularly at least 60 wt.-%, more particularly at least 65 wt.-%, more particularly at least 70 wt.-%, more particularly at least 75 wt.-%, more particularly at least 80 wt.-%, more particularly at least 85 wt.-%, more particularly at least 90 wt.-%, for example. The aforementioned values can form part of lower or upper thresholds of one or more intervals.

The at least one additive can be or comprise a dielectric material, a semiconducting material, or metal oxide material, for example. Exemplary materials can include, but are not limited to: titanium dioxide (TiO₂), silicon (Si), silicon oxide (SiO₂), germanium (Ge), gallium phosphide (GaP), gallium arsenide (GaAs), zirconium dioxide (ZrO₂), aluminum gallium arsenide (AlₓGa₁₋ₓAs), tellurium (Te).

The at least one additive can comprise at least one functionalization which hinders or at least reduces agglomeration and/or aggregation of the at least one additive. Notably, the at least one additive can be or comprise a particulate material, particularly a nano-particulate material. As such, a respective functionalization can hinder or at least reduce agglomeration and/or aggregation of respective particles. An example of a respective functionalization is the provision of a coating, particularly molecules or molecule structures, to the surface of respective particles which hinder or at least reduce the agglomeration or aggregation of the particle with other particles.

According to another exemplary embodiment, the at least one irradiation process can comprise irradiating the photocurable resin with light from at least two different (spatial) directions, particularly such that one or more volume elements of the photocurable resin are irradiated with light from at least two different angles. Hence, the at least one irradiation process can comprise that the photocurable resin is irradiated from a first direction and at least one second direction, which is different from the first direction. The first direction can be or comprise a direction transverse to a formation direction of the or an optical element to be printed and the second direction can be a direction parallel to the formation direction of the or an optical element to be printed. As such, a respective first direction can be related with a respective first angle and a respective second direction can be related with a respective second angle which can be 90° relative to the first angle, for instance. In either case, the light from a respective first direction can intersect with the light of a respective second direction in the or a formation zone. As mentioned above, the formation zone is typically the zone in which the photopolymerization of the photocurable resin takes place which results in photocuring and/or solidification, respectively of the photocurable resin and forming at least a cross-section of the at least one optical element to be printed.

According to another exemplary embodiment, at least one of: the photocurable resin, an irradiation device emitting the light of the at least one wavelength, and a formation zone within the photocurable resin, which is irradiated with the light of the at least one wavelength during the at least one irradiation process, is moved during the at least one irradiation process. A respective motion of at least one of: the photocurable resin, the irradiation device emitting the light of the at least one wavelength, or the formation zone within the photocurable resin, which is irradiated with the light of the at least one wavelength, can enable a highly efficient printing process and high printing speeds, respectively. As such, the method can particularly, comprise that the or a formation zone can be moved along at least one direction, particularly relative to a respective container (as indicated above) comprising the photocurable resin. The at least one direction can comprise the or a formation direction of the optical element to be printed. Motion of the at least one formation zone can e.g. be relative to at least one functional component of a volumetric printing apparatus used for implementing the method, for instance. A respective functional component of a respective volumetric printing apparatus can be a respective container or an irradiation device, for instance. As such, during the at least one irradiation process, the at least one formation zone can be actively moved, e.g. via a coupling with a drive device, such as e.g. a motor, along the at least one direction, particularly the formation direction, e.g. at a nominal motion rate, through at least one part of the container volume, while the container is stationary. Alternatively, a light sheet of the light of the first wavelength can be actively moved, e.g. via an optical control of the irradiation device and/or via a control of a movable irradiation device or a movable support of the irradiation device, along the at least one direction, particularly the formation direction, e.g. a nominal motion rate, through at least one part of the container volume, while the container is stationary. Alternatively, during the at least one irradiation process, the container can be actively moved, e.g. via a coupling with a drive device, such as e.g. a motor, along the at least one direction, particularly the formation direction, while the at least one formation zone is stationary. Further alternatively, at least two of the at least one formation zone, the light sheet, and the container can be actively moved, wherein the motion can be in the same direction or in opposite directions. Also, the nominal motion rate and/or motion direction at which the at least one formation zone and/or the container is moved along the at least one direction, particularly relative to the container, can be varied. Additionally or alternatively, the or a second irradiation apparatus of a dual-color irradiation device can be actively moved along the at least one direction, particularly the formation direction, while at least one of the container or the at least one formation zone is actively moved or not actively moved. Actively moving the or a second irradiation apparatus of a dual-color irradiation device can be a means to implement a focus correction of the light of the second wavelength, for instance. As such, also embodiments are contemplated in which each of the or a second irradiation apparatus of a dual-color irradiation device, the at least one formation zone and the container are actively moved before, during or after the at least one irradiation process. Respective active motions can be controlled by the or a controller of an apparatus used for implementing the method, for instance.

According to another exemplary embodiment, the method can comprise at least one post-processing process, which is typically performed after completion of the at least one irradiation process. The at least one post-processing process can generally, comprise at least one of: a thermal post-processing step, a mechanical post-processing step, an optical post-processing step, a chemical post-processing step. In the at least one post-processing process, the at least one optical element resulting from the at least one irradiation process undergoes at least one measure to change at least one property, particularly at least one of the following properties: the structural properties, particularly the mechanical properties, the optical properties, the thermal properties, the electrical properties, the geometric properties, etc. Notably, an optical element which directly results from the at least one irradiation process can be a green component (or green body), i.e. an intermediate component which does not exhibit all desired properties of the respective optical element which are required for its intended use for an AR device and/or a VR device. As an example, a respective intermediate component can show lower optical or mechanical properties, such as e.g. lower transmission, higher absorption, lower hardness, lower stiffness, etc., of a respective optical element which are required for its intended use for an AR device and/or a VR device. As such, the at least one post processing process can comprise that the as printed optical element (green component) is turned into a brown component. A respective post-processing process can thus, comprise at least one measure which enables post-curing of the as printed optical element (green component), particularly to transfer it into at least a brown component. A respective measure can comprise at least one of the following: subjecting the as printed optical element to a solvent, e.g. by washing the as printed optical element with a solvent; subjecting the as printed optical element to elevated temperatures, e.g. by placing it in a heating device, such as e.g. an oven in which it undergoes post-curing; subjecting the as printed optical element to radiation exposure, e.g. by placing it in at least one radiation device in which it is irradiated with radiation to undergo post-curing; subjecting the as printed optical element to a chemically reactive atmosphere, e.g. by placing it in a chemical reactor in which it can react with a reaction agent to undergo post-curing, etc. As another example, a respective intermediate component can show geometric deviations, such as e.g. in size and/or shape, relative to a respective optical element which are required for its intended use for an AR device and/or a VR device. A respective post-processing process can thus, comprise at least one measure which enables adjusting the size and/or shape to the respective target size and/or shape, e.g. by one or more subtractive processes, such as e.g. machining processes. At least one of the aforementioned post-processing steps can comprise a coating step in which at least one coating is applied to at least one surface of a respective green component and/or brown component, wherein the at least one coating influences, particularly improves one or more properties, such as e.g. mechanical properties, e.g. via improved scratch resistance, optical properties, e.g. via improved transmission, etc.

According to another exemplary embodiment, the method can comprise at least two post-processing processes, wherein a first post-processing process is carried out which induces a chemical reaction of the photocurable resin which forms the at least one optical element, and thereafter at least one second post-processing process is carried which does not induce a chemical reaction of the photocurable resin which forms the at least one optical element. The at least one second post-processing process can be or comprise an additive process in which at least one material is added on at least one surface of the at least one optical element and/or at least one subtractive process in which material is removed from the surface of the at least one optical element. Examples of respective additive processes can comprise coating processes, such as e.g. hard coating or anti-reflectance coating processes. Examples of respective subtractive processes can comprise cutting, machining, such as e.g. milling, grinding, lapping, diamond turning, etc., e.g. to provide a desired surface. A further example of a respective second post-processing process can be a finishing process, such as e.g. a surface finishing process, e.g. by polishing. Particularly, the at least two post-processing processes can comprise a combination of at least one subtractive process, e.g. to adjust a desired size and/or shape, followed by at least one additive process, e.g. to provide desired surface properties.

According to another exemplary embodiment, the method can comprise spatially and/or temporally varying at least one printing parameter, particularly at least one printing parameter influencing the curing or the curing behavior of the photocurable resin, during the at least one irradiation process. The at least one irradiation process can thus, be concertedly and deliberately spatially and/or temporally controlled which can comprise a concertedly and deliberately controlled variation of at least one printing parameter, particularly of at least one printing parameter influencing the curing behavior of the photocurable resin, during the at least one irradiation process. A respective spatial and/or temporal variation of at least one printing parameter can also comprise a variation of the focus of the light of the first wavelength and/or a variation of the size of one or more images or one or more image elements, such as e.g. pixels, of the light of the second wavelength, and/or a variation of the number of irradiation steps in which one or more volume elements, e.g. voxels, of the photocurable resin are irradiated with the light of the or a respective first wavelength and/or light of the or a respective second wavelength, and/or a variation of the motion direction and/or motion rate of the photocurable resin, particularly relative to a light sheet formed of the light of the first wavelength. Based on the spatial and/or temporal variation of at least one printing parameter, the at least one irradiation process can thus, comprise that at least one first portion of the optical element to be printed (first object portion) is printed with at least one different printing parameter relative to at least one further portion of the optical element to be printed (further object portion). A respective first object portion can comprise one or more first volume elements, e.g. voxels, of the photocurable resin which are located at one or more first positions within the photocurable resin. A respective further object portion can comprise one or more further volume elements, e.g. voxels, of the photocurable resin which are located at one or more further positions within the photocurable resin. Respective further volume elements can be volume elements which are located behind respective first volume elements in the formation direction.

The spatial and/or temporal variation of at least one printing parameter can comprise that each volume element of the photocurable resin can be irradiated with individual printing parameters, particularly printing parameters which influence e.g. the amount of energy, energy density, energy intensity, etc. the respective volume element is exposed to during the at least one irradiation process. The printing parameters for a respective volume element of the photocurable resin can be chosen under consideration of the position of the respective volume element within the photocurable resin and within the optical element to be printed, respectively. As an example, one or more volume elements of the photocurable resin which are located adjacent or in proximity to uncured or not to be cured photocurable resin can be irradiated with different printing parameters than one or more volume elements of the photocurable resin which are adjacent or in proximity to cured or to be cured photocurable resin. In such a manner, the spatial and/or temporal variation of at least one printing parameter can particularly be implemented to consider the so-called proximity-effect which causes that a volume element in proximity to another volume element which has already been cured exhibits a specific curing behavior, e.g. an easier or faster curing, which is different from the curing behavior of a volume element which is not in proximity to another volume element which has already been cured or photopolymerized, respectively. Notably, the proximity-effect oftentimes causes undesired structural anisotropy and related undesired shrinkage and deformation, respectively of three-dimensional objects in conventional volumetric printing methods. As such, the method can, in accordance with respective embodiments, enable, based on the spatial and/or temporal variation of at least one printing parameter during the at least one irradiation process, printing optical elements with higher structural isotropy and lower undesired shrinkage and deformation, respectively such that the resulting optical elements show high (er) geometrical accuracy and structural fidelity, respectively.

According to another exemplary embodiment, spatially and/or temporally varying the at least one printing parameter can comprise that the photocurable resin is irradiated with the light of the or a first wavelength before it is irradiated with the light of the or a second wavelength. Hence, a variation of at least one printing parameter can comprise that the photocurable resin is spatially and/or temporally irradiated with the light of the or a first wavelength before it is irradiated with the light of the or a second wavelength. In other words, the at least one irradiation process can comprise that one or more volume elements can be (only) irradiated with the light of the first wavelength spatially and/or temporally before subsequent volume elements are irradiated with the light of the first wavelength (and typically also with the light of the second wavelength). Irradiating volume elements of the photocurable resin with the light of the first wavelength only can result in a pre-activation of these volume elements which results in improved curing of these volume elements resulting in improved structural properties of the respective optical element to be printed.

An example of irradiating the photocurable resin with the light of the first wavelength (spatially) before it is irradiated with the light of the second wavelength can comprise that irradiating the photocurable resin with the light of the first wavelength starts at a first position p1 and that irradiating the photocurable resin with the light of the second wavelength starts at a second position p2, wherein the second position p2 is located behind the first position p1 in the formation direction. The second position is typically a position within a volume of the photocurable resin which forms the respective optical element to be printed and thus, a position inside the respective optical element to be printed. Particularly, the second position can be a position within a volume of the photocurable resin which forms an outer boundary or edge of the respective optical element to be printed and thus, a position at a surface of the respective optical element to be printed. As such, the optical element to be printed can comprise portions which are located behind the second position with respect to the formation direction or the optical element is formed behind the second position with respect to the formation direction, respectively. Hence, the second position can comprise the first volume element, such as e.g. the first voxel, of the optical element to be printed with respect to the formation direction. The first position can also be a position within a volume of the photocurable resin which forms the respective optical element to be printed and thus, a position inside the respective optical element to be printed. Particularly, the first position is a position within a volume of the photocurable resin which does not form the respective optical element to be printed and thus, a position outside the respective optical element to be printed. Another example of irradiating the photocurable resin with the light of the or a first wavelength (temporally) before it is irradiated with the light of the or a second wavelength can comprise that irradiating the photocurable resin with the light of the first wavelength starts at a first time t1 and that irradiating the photocurable resin with the light of the second wavelength starts at a second time t2, wherein t2>t1. The second time typically corresponds to a time at which a volume of the photocurable resin which forms the respective optical element to be printed is irradiated. Particularly, the second time can correspond to a time at which a volume of the photocurable resin which forms an outer boundary or edge of the respective optical element to be printed and thus, a position at a surface of the respective optical element to be printed is irradiated. As such, the optical element to be printed can comprise portions which are to be printed after the second time or the printing of the optical element is completed after the second time, respectively. Hence, the second time can comprise a time at which the first volume element, such as e.g. the first voxel, of the optical element to be printed is printed with respect to the formation direction. The first time can also correspond to a time at which a volume of the photocurable resin which forms the respective optical element to be printed is irradiated. Yet, the first time can also correspond to a time at which a volume of the photocurable resin which does not form the respective optical element to be printed is irradiated.

According to another exemplary embodiment, spatially and/or temporally varying the at least one printing parameter, can comprise that the photocurable resin is irradiated with the light of the first wavelength after it is irradiated with the light of the second wavelength. Hence, the variation of at least one printing parameter can comprise that the photocurable resin is spatially and/or temporally irradiated with the light of the first wavelength after it is irradiated with the light of the second wavelength. As such, one or more volume elements of the optical element to be printed can be irradiated with the light of the first wavelength after these volume elements have been irradiated with the light of the second wavelength. Respective one or more volume elements of the photocurable resin can particularly, comprise the last volume elements of the optical element to be printed. In other words, the at least one irradiation process can comprise that one or more volume elements can be (only) irradiated with the light of the first wavelength spatially and/or temporally after previous volume elements have been irradiated with the light of the second wavelength (and typically also the light of the first wavelength). Irradiating volume elements of the photocurable resin with the light of the first wavelength only can result in a post-activation of these volume elements which results in further curing of these volume elements resulting in improved structural properties of the respective optical element to be printed.

An example of irradiating the photocurable resin with the light of the or a first wavelength (spatially) after it is irradiated with the light of the or a second wavelength can comprise that irradiating the photocurable resin with the light of the second wavelength ends at a third position p3 and that irradiating the photocurable resin with the light of the first wavelength ends at a fourth position p4, wherein the fourth position p4 is behind the third position p3 in the formation direction. The third position is typically a position within a volume of the photocurable resin which forms the respective optical element to be printed and thus, a position inside the respective optical element to be printed. Particularly, the third position can be a position within a volume of the photocurable resin which forms an outer boundary or edge of the respective optical element to be printed and thus, a position at a surface of the respective optical element to be printed. As such, the optical element to be printed can comprise portions which are located in front of the third position with respect to the formation direction or the optical element is formed in front of the third position with respect to the formation direction, respectively. Hence, the third position can comprise the last volume element, such as e.g. the last voxel, of the optical element to be printed with respect to the formation direction. The fourth position can also be a position within a volume of the photocurable resin which forms the respective optical element to be printed and thus, a position inside the respective optical element to be printed. Particularly, the fourth position is a position within a volume of the photocurable resin which does not form the respective optical element to be printed and thus, a position outside the respective optical element to be printed. Another example of irradiating the photocurable resin with the light of the or a first wavelength (temporally) after it is irradiated with the light of the or a second wavelength can comprise that irradiating the photocurable resin with the light of the second wavelength ends at a third time t3 and that irradiating the photocurable resin with the light of the first wavelength ends at a fourth time t4, wherein t4>t3. The third time typically corresponds to a time at which a volume of the photocurable resin which forms the respective optical element to be printed is irradiated. Particularly, the third time can correspond to a time at which a volume of the photocurable resin which forms an outer boundary or edge of the respective optical element to be printed and thus, a position at a surface of the respective optical element to be printed is irradiated. As such, the optical element to be printed can comprise portions which are to be printed before the third time or the printing of the optical element is completed before the third time, respectively. Hence, the third time can comprise a time at which the last volume element, such as e.g. the last voxel, of the optical element to be printed is printed with respect to the formation direction. The fourth time can also correspond to a time at which a volume of the photocurable resin which forms the respective optical element to be printed is irradiated. Yet, the fourth time can also correspond to a time at which a volume of the photocurable resin which does not form the respective optical element to be printed is irradiated.

As such, spatially and/or temporally varying the at least one printing parameter can comprise that the photocurable resin is irradiated with the light of the first wavelength, particularly only with the light of the first wavelength, in a volume separate, particularly adjacent, more particularly directly adjacent, to the volume in which the optical element is to be printed, particularly wherein the volume is spatially and/or temporally before and/or behind the volume in which the optical element is to be printed with respect to the at least one formation direction of the optical element. In such a manner, pre- or post-activating the photocurable resin can be effected which can positively influence the structural properties of the optical element to be printed. Thus, spatially and/or temporally irradiating the photocurable resin with the light of the or a first wavelength before or after it is irradiated with the light of the or a second wavelength can generally comprise that volume elements of the photocurable resin which volume elements do not form part of an optical element to be printed can be irradiated (only) with the light of the first wavelength. Such volume elements can be positioned, with respect to the formation direction of an optical element to be printed, before or in front of the volume elements which form part of the respective optical element to be printed, preferably before or in front of the first volume element of the optical element to be printed with respect to the formation direction, or after or behind the volume elements which form part of the respective optical element to be printed, preferably behind or after the last volume element of the optical element to be printed with respect to the formation direction. It is also conceivable though that volume elements of the photocurable resin which do not form part of an optical element to be printed can be irradiated (only) with the light of the second wavelength such that the above remarks can also accordingly apply to the light of the second wavelength.

According to another exemplary embodiment, spatially and/or temporally varying the at least one printing parameter can comprise irradiating the photocurable resin with the light of the or a first wavelength and/or the or a second wavelength and spatially and/or temporally varying the energy, particularly the energy intensity, of the light of the first wavelength and/or the second wavelength, along the at least one direction. As such, problems based on different degrees of curing of different volume elements of an optical element to be printed, which typically also lead to undesired structural anisotropy of the optical element, can be overcome or at least reduced. Likewise, the proximity-effect (as explained further above) can be overcome or at least reduced because one or more volume elements in proximity to other volume elements which have already been cured or photopolymerized, respectively can be irradiated with a different energy relative to one or more volume elements which are not in proximity to other volume elements which have already been cured or photopolymerized, respectively.

Particularly, spatially and/or temporally varying the energy or energy intensity, respectively can comprise that the energy level of the light of the or a first wavelength can be varied from a first energy level to at least a second energy level, the at least one second energy level being higher or lower than the first energy level. Hence, the energy or energy intensity, respectively of the light of the first wavelength can be dynamically or gradually spatially and/or temporally increased or decreased during the at least one irradiation process, particularly with respect to a nominal value which can be, but is not limited to, a minimum or maximum energy or energy intensity, respectively. Additionally or alternatively, spatially and/or temporally varying the energy or energy intensity, respectively of the second wavelength can comprise that the energy level of the light of the or a second wavelength can be varied from a first energy level to at least a second energy level, the at least one second energy level being higher or lower than the first energy level. Hence, the energy or energy intensity, respectively of the light of the second wavelength can be dynamically or gradually spatially and/or temporally increased or decreased during the at least one irradiation process, particularly with respect to a nominal value which can be, but is not limited to, a minimum or maximum energy level or energy intensity level, respectively.

According to another exemplary embodiment, the method can comprise printing at least one auxiliary object. Particularly, spatially and/or temporarily varying the at least one printing parameter can be realized by printing at least one auxiliary object. Printing the at least one auxiliary object can be spatially and/or temporarily started before the at least one optical element which is actually to be manufactured is printed, and can be completed before the printing of the at least one optical element is started. In either case, the at least one auxiliary object can be printed in a first volume of the container and the at least one optical element to be printed can be printed a second volume of the container, wherein the second volume is located spatially and/or temporarily behind and/or after the first volume. As such, printing of the at least one auxiliary object can comprise that a light sheet of the light of first wavelength is first moved through the first volume along the at least one direction, particularly relative to a respective container (as indicated above) comprising the photocurable resin, to generate the at least one auxiliary object by multi-color photopolymerization (as specified above) and then the light sheet of the light of first wavelength is moved through the second volume. When the light of first wavelength is moved through the second volume, the intensity of the light of the second wavelength can be zero or at least (significantly) reduced such that the photocurable resin in the second volume is (essentially) only subject to the light of the first wavelength.

The at least one optical element can be printed with one or more target properties, which are typically defined with respect to its intended application or use. As an example, the at least one optical element can have a target shape or optical properties, which are defined with respect to an intended application or use of the three-dimensional object as an optical element. The at least one auxiliary object can differ in at least one property from the one or more target properties. The at least one auxiliary object can thus, deviate from the intended shape or have lower optical properties than the at least one optical element to be printed. As such, the quality requirements for the at least one auxiliary object can be lower than the quality requirements for the at least one optical element to be printed.

The at least one auxiliary object can have a longitudinal shape having a spatial extension direction along the motion direction of the light sheet through the container. As an example, the at least one auxiliary object can be or comprise a stick-shape having a spatial extension direction along the motion direction of the light sheet through the container. In either case, the volume of the at least one auxiliary object can be smaller than the volume of the at least one optical element to be printed. As an example, the volume of the at least one auxiliary object can be at least one of: ½, ⅓, ¼, ⅕, ⅙, 1/7, ⅛, 1/9, 1/10, etc., of the volume of the at least one optical element to be printed.

The at least one auxiliary object can be or comprise a sacrificial object, which can be discarded after printing.

The at least one auxiliary object can be physically connected to the at least one optical element to be printed via one or more connection portions, such as e.g. one or more connection points, one or more connection lines, or one or more connection areas, etc. Respective connection portions can comprise predetermined separation or breaking structures which enable, removing the at least one auxiliary object, e.g. via breaking, after printing of the at least one optical element is completed. Alternatively, the at least one auxiliary object can also be adjacently arranged, i.e. spatially offset, relative to the at least one optical element to be printed such that there are no connection portions. The distance between the at least one auxiliary object and the at least one optical element to be printed can be small, preferably <10 mm, more preferably <5 mm, even more preferably below 1 mm, still more preferably <500 μm, most preferably <100 μm.

As an example, spatially and/or temporally varying the energy, particularly the energy intensity, of the light of the or a second wavelength along the at least one direction can comprise that one or more image elements, e.g. pixels, of respective images corresponding to a cross-sectional geometry of an optical element to be printed are spatially and/or temporally varied with respect to their energy or energy density, respectively. In other words, a respective projection of one or more images can comprise image elements of different energy or energy density, respectively. Varying the energy or energy density, respectively of respective image elements can comprise energy levels or energy density levels, respectively between minimum energy levels or minimum energy density levels, respectively and maximum energy levels or maximum energy density levels, respectively. Likewise, varying the energy or energy density, respectively of respective lines or points can comprise varying the energy levels or energy density levels, respectively between minimum energy levels or minimum energy density levels, respectively and maximum energy levels or maximum energy density levels, respectively. Varying the energy or energy density, respectively of respective image elements or points or lines, respectively can be effected by controlling a respective irradiation device used for generating respective projections of images or points or lines, respectively.

As another example, spatially and/or temporally varying the energy, particularly the energy intensity, of the light of the or a second wavelength along the at least one direction can comprise that one or more image elements, e.g. pixels, of respective images which correspond to a cross-sectional geometry of an optical element to be printed and/or one or more image elements, e.g. pixels, of respective images which do not correspond to a cross-sectional geometry of an optical element to be printed can be spatially and/or temporally varied such that the energy or energy intensity, respectively does not effect curing of the photocurable resin. Hence, spatially and/or temporally varying the energy, particularly the energy intensity, of the light of the second wavelength can comprise that the energy or energy intensity, respectively can be spatially and/or temporally set to a level which does not result in curing of the photocurable resin or to a level which results in undercuring of the photocurable resin. Yet, it is also conceivable that spatially and/or temporally varying the energy, particularly the energy intensity, of the light of the second wavelength can comprise that the energy or energy intensity, respectively can be spatially and/or temporally set to a level which results in overcuring of the photocurable resin. Particularly, spatially and/or temporally varying the energy, particularly the energy intensity, of the light of the second wavelength along the at least one direction can comprise that the first volume elements of the optical element to be printed with respect to the formation direction are irradiated with light of the second wavelength having a higher intensity than further volume elements of the optical element to be printed. In such a manner, a means for compensating the proximity-effect is given.

According to another exemplary embodiment, spatially and/or temporally varying the energy of the light of the or a second wavelength can comprise varying the energy or energy distribution of at least a part, e.g. a pixel, of at least one projected image corresponding to a cross-sectional geometry of an optical element to be printed or of at least one point or line of at least one light beam corresponding to a cross-sectional geometry of an optical element to be printed. Particularly, the energy of the light of the second wavelength can be varied along the at least one direction such that, with respect to the formation direction, upstream portions of the optical element to be printed are exposed to different energy levels of the light of the second wavelength as downstream portions of the optical element to be printed. As indicated above, spatially and/or temporally varying the energy of the light of the second wavelength can lead to optical elements with less structural anisotropy and improved structural properties.

According to another exemplary embodiment, the method can comprise a step of conducting at least one measure to modify the optical properties of the optical element. The method can thus, comprise in addition to a first step which comprises at least one volumetric printing process in which a photopolymerizable material is irradiated with light of at least one wavelength to form at least one optical element, a separate second step of conducting at least one measure to modify the optical properties of the optical element after the first step in which the optical element has been printed. However, it is also conceivable that the one measure to modify the optical properties of the optical element is performed concurrently with the at least one volumetric printing process. The method therefore, enables deliberately modifying the optical properties, particularly the absorption properties, of the optical element which result from the volumetric 3d-printing process in the visible wavelength range. As such, an optical element can generally be provided with modified optical properties, particularly modified absorption properties, after completion of the first step. As an example, an optical element can initially have a first color or coloring, respectively resulting from the volumetric printing process and is transparent, i.e. has no color or coloring, respectively after completion of the second step. Particularly, the resulting optical properties, particularly the resulting absorption properties, of the optical element after completion of the second step may result in that the optical element is transparent in the visible wavelength range. Hence, the optical element can show no or only little absorption in the visible wavelength range after completion of the second step. Transparency in the visible wavelength range typically means that the transmission of the optical element in the visible wavelength range is above 80% or absorbance of the optical element in the visible wavelength range is below 0.5, particularly below 0.3, respectively. The absorption and/or transmission of the optical element object can be determined/measured with a UV-Vis-NIR spectrophotometer of the type “Cary 50” available from Agilent Technologies, Inc., for instance.

The second step and thus, the at least one measure of conducting at least one measure to modify the optical properties of the optical element, can be implemented with at least one device configured to perform the second step and thus, the at least one measure of conducting at least one measure to modify the optical properties of the optical element as specified herein.

Particularly, the at least one measure of conducting at least one measure to modify the optical properties of the optical element can comprise modifying the optical properties of the optical element resulting in that an average transmission or an integral of the transmission between 300 nm and 2000 nm, particularly 350 nm and 900 nm, more particularly 400 nm and 800 nm, is increased by at least 1%, particularly at least 2%, more particularly at least 3%, more particularly at least 4%, more particularly at least 5%, more particularly at least 7.5%, more particularly at least 10%, more particularly at least 15%, more particularly at least 20%, more particularly at least 25%, more particularly at least 30%, more particularly at least 35%, more particularly at least 40%, more particularly at least 40%, more particularly at least 60%, more particularly at least 80%, more particularly at least 90%, particularly relative to a state of the optical element before it has undergone the at least one measure.

Particularly, the at least one measure of conducting at least one measure to modify the optical properties of the optical element can comprise modifying the optical properties of the optical element resulting in that an average absorption or an integral of the absorption between 300 nm and 2000 nm, particularly 350 nm and 900 nm, more particularly 400 nm and 800 nm, is decreased by at least 1%, particularly at least 2%, more particularly at least 3%, more particularly at least 4%, more particularly at least 5%, more particularly at least 7.5%, more particularly at least 10%, more particularly at least 15%, more particularly at least 20%, more particularly at least 25%, more particularly at least 30%, more particularly at least 35%, more particularly at least 40%, more particularly at least 40%, more particularly at least 60%, more particularly at least 80%, more particularly at least 90%, particularly relative to a state of the optical element before it has undergone the at least one measure. Alternatively, an optical element can initially have a first color or coloring, respectively resulting from the volumetric 3d-printing process and have a second color or coloring, respectively, the second color or coloring, respectively having a reduced absorption in the visible wavelength range relative to the first color or coloring, respectively, after completion of the second step. Hence, the optical element can show reduced absorption in the visible wavelength range after completion of the second step as compared to its absorption in the visible wavelength range after completion of the first step.

Particularly, any absorption and/or transparency value can refer to a thickness of the optical element of 1 mm. Alternatively, any absorption and/or transparency value can refer to the maximum path length of the light passing through the optical element.

The second step is conducted when the first step has been completed. Completion of the first step, i.e. completion of the printing process of an optical element is typically given when no further photopolymerization is effected in the working volume of a respective volumetric printing apparatus by irradiating the photopolymerizable material in the working volume of the volumetric printing apparatus with at least one radiation device of the volumetric printing apparatus for forming the optical element or a green state of the optical element. Particularly, completion of the printing process of an optical element is given when the printed optical element has a pre-defined geometric configuration, particularly a pre-defined shape, or the green state of the optical element has a pre-defined shape. A respective green state typically represents the pre-defined geometric configuration, i.e. all geometric features and the base shape, of the optical element, however the green state can have different dimensions and a lower degree of polymerization than the final optical element. As such, after completion of the first step, the printed optical element can still be disposed in the working volume of the volumetric printing apparatus in which it has been printed. Hence, the second step can be conducted when the optical element which has been printed in the first step is still within the working volume of the volumetric printing apparatus used for carrying out the first step.

Further, the at least one measure can comprise an optical treatment of the optical element which optical treatment comprises irradiating the optical element with light of at least one specific wavelength for a specific time with a specific light intensity. Particularly, the specific time can range between 0.5 min and 180 min, particularly between 5 min and 60 min and/or the at least one specific wavelength can range between 350 nm and 1000 nm, particularly between 400 nm and 800 nm, more particularly between 350 nm and 500 nm or between 420 nm and 800 nm.

Further, the optical element can be irradiated for the specific time and light intensity with the light of the at least one specific wavelength while the optical element is in a working volume in which it has been formed in the first step.

Further, the optical element can be subject to tempering after irradiating the optical element for the specific time with light of the at least one specific wavelength, wherein the tempering particularly comprises heating the optical element to a temperature ranging between 50° C. and 150° C. for a time ranging between 1 min and 60 min, particularly 5 min and 30 min.

According to a further exemplary embodiment, the method can comprise the following steps:
a) performing a volumetric printing process to manufacture at least one optical element on basis of data comprising information of a geometric model of the at least one optical element to be manufactured, wherein the volumetric printing process is performed on basis of a number of process parameters;
b) determining at least one property of the at least one optical element and generating a determination information indicative of the at least one determined property of the at least one optical element;
c) comparing the at least one determined property of the at least one optical element with at least one reference property, particularly a target property, of a reference optical element, particularly a target optical element, and generating a comparison information indicative of the comparison result;
d) determining if the comparison result indicates that a deviation between the determined at least one property of the at least one optical element and the at least one reference property of the reference optical element exceeds a threshold value; and if the comparison result indicates that a deviation between the determined at least one property of the at least one optical element and the at least one reference property of the reference optical element exceeds the threshold value, changing at least one of: at least one parameter of the geometric model of the at least one optical element to be manufactured, at least one process parameter of the volumetric printing process, at least one process parameter of a post-processing process; and
e) repeating steps a)-d) with the changed at least one parameter of the geometric model of the at least one optical element to be manufactured and/or with the changed parameter of the at least one process parameter of the volumetric printing process and/or with the changed parameter of the at least one process parameter of the post-processing process until the comparison result indicates that the deviation between the determined at least one property of the at least one optical element and the at least one reference property of the reference optical element does not exceed the threshold value.

Particularly, determining at least one property of the at least one optical element and generating the determination information indicative of the at least one determined property of the at least one optical element can comprise determining at least one chemical and/or physical property of the at least one optical element. As an example, the at least one chemical property is or comprises a chemical composition of the at least one optical element, a chemically reactive state of the at least one optical element, particularly a polymerization state of the at least one optical element. As an example, the at least one physical property can be or comprise at least one of: an acoustic property, an optical property, a geometric property, a mechanical property, a surface property, an electric property, a thermal property, a magnetic property of the at least one optical element.

Particularly, the at least one determined property of the at least one optical element can be indicative of a deformation of the at least one optical element relative to the reference optical element.

Particularly, the at least one property of the at least one optical element can be determined via a measurement device configured to measure at least one chemical and/or physical property of the at least one optical element.

Particularly, changing the at least one parameter of the geometric model of the at least one optical element to be manufactured can comprise changing information of a CAD-file, particularly a STL-file, concerning the model of the at least one optical element to be manufactured. As an example, at least one image parameter, particularly a pixel, a voxel, or a vertex, of the model of the at least one optical element to be manufactured can be changed.

Particularly, changing the at least one process parameter of the volumetric printing process can comprise changing at least one of: at least one parameter, e.g. irradiation time, irradiation intensity, wavelength of irradiation light, of an irradiation process of irradiating a photocurable resin within a working volume, printing speed, a printing direction, an orientation of the at least one optical element within the working volume a motion path along which the working volume is moved during the irradiation process, at least one parameter of the photocurable resin used for volumetric printing the at least one optical element, at least one parameter of handling the at least one optical element, e.g. for transferring it from a volumetric printing device to a post-processing device.

Particularly, changing the at least one process parameter of the post-processing process can comprise changing at least one of: post-processing time, post-processing intensity.

Particularly, step b) can be performed via a determination device, particularly an optical determination device, more particularly a scanner, a microscope, a profilometer, and/or via a testing device configured to perform a test of at least one property of the at least one optical element with respect to an intended application and/or function of the at least one optical element.

Particularly, step c) can be performed via a controller, particularly via a comparison algorithm of a controller, which is configured to compare the at least one determined property of the at least one optical element with at least one reference property, particularly a target property, of a reference optical element, particularly a target optical element, and generating a comparison information indicative of the comparison result.

Particularly, the method can comprise determining a surface model of the at least one optical element to be manufactured, such as e.g. via a hardware- and/or software-embodied surface model determination unit or a controller, and altering the surface model.

Particularly, the method can comprise assigning specific energy inputs to one or more surface elements or volume elements to which originally no energy input has been assigned and/or assigning zero energy inputs to one or more surface elements to which originally a zero energy input has been assigned. As an example, the method can comprise changing the z-coordinates of a surface model of the at least one optical element to be manufactured by addition or subtraction of respective values obtained in a correction matrix, wherein the correction matrix can be composed of the difference in height of the at least one optical element and a determination, e.g. via a measurement, of the surface profile of the actual optical element for each individual x- and y-coordinate. As another example, the method can comprise that for each x-, y-coordinate of the surface model of the at least one optical element to be manufactured, the corresponding z-coordinate of the surface model of the other geometrical body can be added or subtracted to/from the z-coordinate of the surface model of the at least one optical element to be manufactured to generate an altered surface model of the at least one optical element to be manufactured.

Particularly, the method can comprise determining a surface model of the at least one optical element to be manufactured, such as e.g. via a hardware- and/or software-embodied surface model determination unit, wherein the surface model can comprise a surface profile of the at least one optical element to be manufactured in a specific direction, such as e.g. in the formation direction or a direction opposite thereto; and changing at least one coordinate of at least one surface element of the multiple surface elements. As an example, a z-coordinate of at least one surface element of the multiple surface elements can be changed. As another example, changing the at least one coordinate can be implemented, e.g. in the course of a computational preparation of a printing process, via a data processing means, such as e.g. algorithms, software, etc., wherein a respective data processing means can be or comprise a machine learning algorithm or model which is trained, e.g. based on evaluation of previously printed optical elements, to improve the properties, such as e.g. the geometric accuracy, of at least one printed optical element.

A second aspect of the invention relates to at least one optical element manufactured in accordance with the method of the first aspect. All annotations concerning the method of the first aspect of the invention apply to the at least one optical element of the second aspect of the invention and vice versa.

A third aspect of the invention relates to the use of at least one optical element manufactured in accordance with the method of the first aspect of the invention in an AR device and/or in a VR device. All annotations concerning the method of the first aspect of the invention and the at least one optical element of the second aspect of the invention apply to the use of at least one optical element of the third aspect of the invention and vice versa.

Particularly, the at least one optical element can be used as a light beam source or part of a light beam source, or a light image source, such as e.g. projection device, or as part of a light image source, or as a light sensor element, particularly forming part of a camera, or as a part of a light sensor element.

A fourth aspect of the invention relates to a method for manufacturing an AR device and/or VR device. All annotations concerning the method of the first aspect of the invention, the at least one optical element of the second aspect of the invention, and the use of the optical element of the third aspect of the invention apply to the method of the fourth aspect of the invention and vice versa.

Particularly, the method comprises the steps of: providing at least one optical element or at least one optical element assembly manufactured in accordance with the method; providing at least one functional and/or structural element of the AR device and/or VR device; and connecting the at least one optical element or the at least one optical element assembly with the at least one functional and/or structural element of the AR device and/or VR device. The step of connecting the at least one optical element or the at least one optical element assembly with the at least one functional and/or structural element of the AR device and/or VR device can comprise any connection technique which enables connecting the at least one optical element or the at least one optical element assembly with the at least one functional and/or structural element of the AR device and/or VR device. Exemplary connection techniques can comprise assembling, molding, fastening, mounting, etc. As such, a respective connection technique can also be or comprise an assembling technique, molding technique, a fastening technique, a mounting technique, etc.

Particularly, the at least one functional and/or structural element can be or comprise at least one of: a frame element of an AR device and/or VR device or a part thereof, a light beam source or a part thereof, a light image source or a part thereof, a light outputting element or a part thereof, a display or a part thereof, a light sensor or a part thereof, particularly forming part of a camera, a light guiding element or a part thereof, such as e.g. a waveguide, etc.

The AR device and/or VR device can e.g. be a portable AR device and/or VR device, a head-worn AR device and/or VR device, a head-mounted AR device and/or VR device, etc. Particularly, the device and/or VR device can e.g. be or comprise glasses, particularly smart glasses, headsets, smartphones, tablets, laptops, televisions, particularly smart televisions, etc.

A fifth aspect of the invention relates to an apparatus for volumetric printing at least one optical element by photopolymerization, particularly by multi-color photopolymerization, of a photocurable resin. The apparatus comprises an irradiation device for performing an irradiation process of irradiating, particularly on basis of a plurality of printing parameters, a photocurable resin with light of at least one wavelength to form, by photopolymerization, particularly by multi-color photopolymerization, more particularly by dual-color photopolymerization, at least one optical element. The apparatus can be configured to implement the method of the first aspect of the invention such that all remarks made in connection with the method of the first aspect of the invention also apply to the apparatus of the fifth aspect of the invention, and vice versa.

The apparatus typically comprises a hardware- and/or software-embodied controller which can be configured to spatially and/or temporally vary at least one printing parameter, particularly a printing parameter influencing the curing (behavior) of the photocurable resin, during the at least one irradiation process.

The apparatus can be configured to form at least one optical element via volumetric printing based on photopolymerization, particularly multi-color photopolymerization, more particularly dual-color polymerization, of a photocurable resin. The term “optical element” thus, particularly refers to an optical element which is generally ready to be used (except for possible post-processing steps).

The apparatus can be or comprise a volumetric 3d-printing apparatus, particularly a xolography apparatus, i.e. an apparatus configured to perform the base principles of xolography. The base principles of xolography are specified in WO 2020/245456 A1, the contents of which are incorporated herein by reference. Likewise, the apparatus can be or comprise an apparatus configured to implement a so-called, computed axial lithography, CAL, process, particularly a CAL process using a rotating periscope, for instance. Likewise, the apparatus can be or comprise an apparatus as specified in WO2024163474A1, the contents of which are incorporated herein by reference, for instance. Likewise, the apparatus can be or comprise an apparatus configured to implement cone beam lithography or parallax manufacturing as specified above.

The apparatus typically comprises a container for receiving photocurable resin. The container can be moveably supported in at least one direction. The at least one direction can be or comprise the formation direction of a respective optical element to be printed.

The apparatus can further comprise a dual-color irradiation device configured to irradiate a photocurable resin inside the or a respective container. The dual-color irradiation device is configured to irradiate the photocurable resin with light of a first wavelength and, particularly simultaneously, with light of a second wavelength different from the first wavelength. The dual-color irradiation device can comprise at least one first irradiation apparatus comprising at least one first light source for generating the light of the first wavelength and at least one second irradiation apparatus comprising at least one second light source for generating the light of the second wavelength. The dual-color irradiation device can be configured to generate a light sheet from the light of the first wavelength, wherein the light sheet extends in a light sheet plane. Further, the dual-color irradiation device can be configured to generate a light projection of the light of the second wavelength, wherein the light projection intersects with the light sheet at an intersection angle, particularly an intersection angle of (ca.) 90°. A light projection of the light of the second wavelength can be generated with multiple light beams of the second wavelength which are emitted simultaneously or sequentially. As such, a light projection of the light of the second wavelength can comprise at least one of the following: an image of the light of the second wavelength which image can comprise image elements, such as e.g. pixels, of different intensities which results in an inhomogeneous or homogeneous intensity distribution of the image; or a sequential hatching of different locations, which can comprise e.g. points or lines, which result in an image of the light of the second wavelength which image can comprise image elements, such as e.g. pixels, of different intensities which results in an inhomogeneous or homogeneous intensity distribution of the image.

The at least one first irradiation apparatus can thus, comprise at least one light source configured to irradiate light of a first wavelength towards the photocurable resin to generate at least one first light projection forming a light sheet. A respective light sheet can comprise multiple light beams extending in a common plane. The at least one first irradiation apparatus can be built as or comprise a laser or light emitting diode, for instance. The at least one first irradiation apparatus can further comprise at least one optical element which can e.g. comprise at least one of: a Powell-lens, a cylindrical lens, a diffractive optical element, a beam expanding element, a collimating optical element, etc. Additionally or alternatively, the at least one first irradiation apparatus can comprise a light deflection unit, such as e.g. a (moveable or rotatable) mirror, a galvo-scanner, or a polygon scanner, for deflecting light towards the photocurable resin. The at least one first irradiation apparatus can be configured to vary the focus or at least one focus parameter, particularly at least one of: the focus position, the focal length, the depth of focus, or the depth of field, of at least one respective first light projection within the working volume. Particularly, the at least one first irradiation apparatus can be configured to vary the focus or at least one focus parameter with respect to the size of the formation zone. The at least one first irradiation apparatus can comprise one or more controllers configured to vary the focus or at least one focus parameter, particularly at least one of: the focus position, the focal length, the depth of focus, or the depth of field, of at least one respective first light projection within the working volume. Additionally or alternatively, the at least one first irradiation apparatus can comprise one or more optical elements, such as e.g. lenses, particularly adaptable or adjustable lenses, which are configured to vary the focus or at least one focus parameter, particularly at least one of: the focus position, the focal length, the depth of focus, or the depth of field, of at least one respective first light projection within the working volume. The light emitted or irradiated by the at least one first irradiation apparatus can comprise a wavelength in the range of: 350 nm-500 nm, particularly 375 nm-450 nm, more particularly 385 nm-440 nm, more particularly 395 nm-420, more particularly 400 nm-410 nm, for instance. The light of the first wavelength can comprise a spectrum of wavelengths, particularly at least partly covering the respective ranges. As an example, the first wavelength can be ca. 375 nm. Typically, the first wavelength will be chosen at least under consideration of the photochemical properties, particularly the photochromic properties, of molecules of a photoinitiator of the photocurable resin.

The at least one second irradiation apparatus can thus, comprise at least one second light source configured to continuously project a projection of images corresponding to a cross-sectional geometry of at least one optical element to be printed or a plurality of points or lines corresponding to a cross-sectional geometry of at least one optical element to be printed. The second irradiation apparatus can be built as or comprise an image projection device, particularly a digital light projection device, or a directed light emission device, for instance. The at least one second irradiation apparatus can further comprise one or more light projection optics. The at least one second irradiation apparatus can be configured to change the size of at least one image of the projection of images or of at least one image element, such as e.g. a pixel, of at least one image of the projection of images. The at least one second irradiation apparatus can comprise one or more controllers configured to change the size of at least one image of the projection of images or of at least one image element, such as e.g. a pixel, of at least one image of the projection of images. Additionally or alternatively, the at least one second irradiation apparatus can comprise one or more optical elements, such as e.g. lenses, which are configured to change the size of at least one image of the projection of images or of at least one image element, such as e.g. a pixel, of at least one image of the projection of images. The light emitted or irradiated by the at least one second irradiation apparatus can comprise a wavelength in the range of: 400 nm-1000 nm, particularly 425-750 nm, more particularly 450-675 nm, more particularly 500-650 nm, for instance. The light of the second wavelength can comprise a spectrum of wavelengths, particularly at least partly covering the respective ranges. Typically, the second wavelength will be chosen at least under consideration of the photochemical properties, particularly the photochromic properties, of molecules of a photoinitiator of the photocurable resin.

As indicated above, the dual-color irradiation device can be configured to generate a projection of images from the light of the second wavelength, wherein the light projection intersects with the light sheet at an intersection angle, particularly an intersection angle of (ca.) 90°. The dual-color irradiation device can thus, be generally configured to irradiate the light of the first wavelength at a first angle, particularly an angle of 0-180°, and the light of the second wavelength at a second angle, particularly an angle of 0-180°, relative to the main extension plane of the at least one formation zone. Respective angles can particularly, range between 15 and 165°, more particularly between 3° and 150°, more particularly between 9° and 150° or between 3° and 90°. Particularly, the light of the second wavelength can be irradiated with respect to the light of the first wavelength at an angle of 90°.

A sixth aspect of the invention relates to a computer program product comprising instructions to cause the or a controller of the apparatus of the fifth aspect of the invention to execute the steps of the method of the first aspect of the invention such that all remarks made in connection with the method of the first aspect of the invention also apply to the computer program product of the sixth aspect of the invention, and vice versa.

### BRIEF DESCRIPTION OF THE DRAWINGS

With these and other advantages and features that will become hereinafter apparent, a more complete understanding of the invention can be obtained by referring to the following description of the appended drawings in which:

FIG. 1 shows a principle drawing of an apparatus for printing an optical element according to an exemplary embodiment,

FIGS. 2 and 3 each show principle drawings of an optical element manufactured in accordance with exemplary embodiments of the method;

FIG. 4 shows a flow diagram of a method for manufacturing an optical element for an AR device and/or a VR device in accordance with an exemplary embodiment;

FIG. 5 shows a flow diagram of a method for manufacturing an AR device and/or a VR device in accordance with an exemplary embodiment, and

FIGS. 6 and 7 each show a principle drawing of an AR device and/or a VR device in accordance with an exemplary embodiment.

### DETAILED DESCRIPTION OF THE DRAWINGS

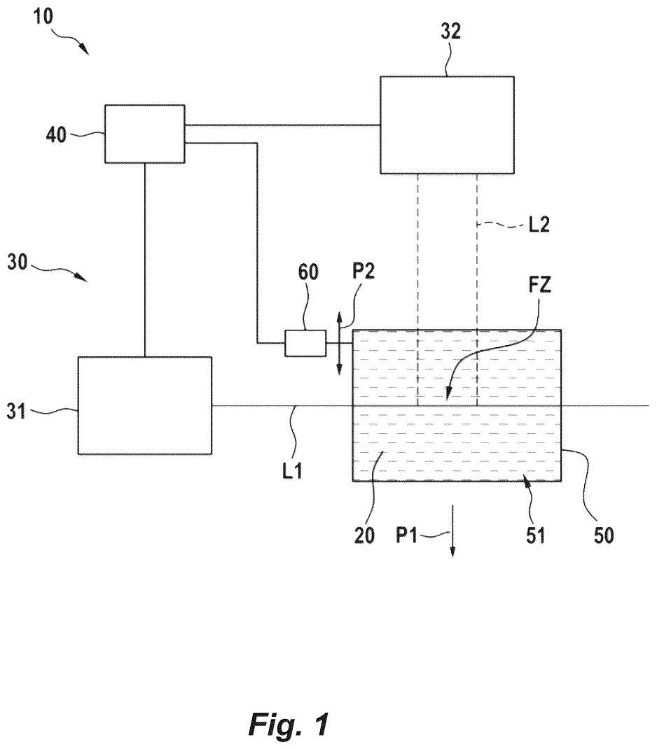

FIG. 1 shows a principle drawing of an apparatus 10 for printing at least one three-dimensional object, namely an optical element OE for an AR device and/or a VR device according to an exemplary embodiment in a schematic top-view.

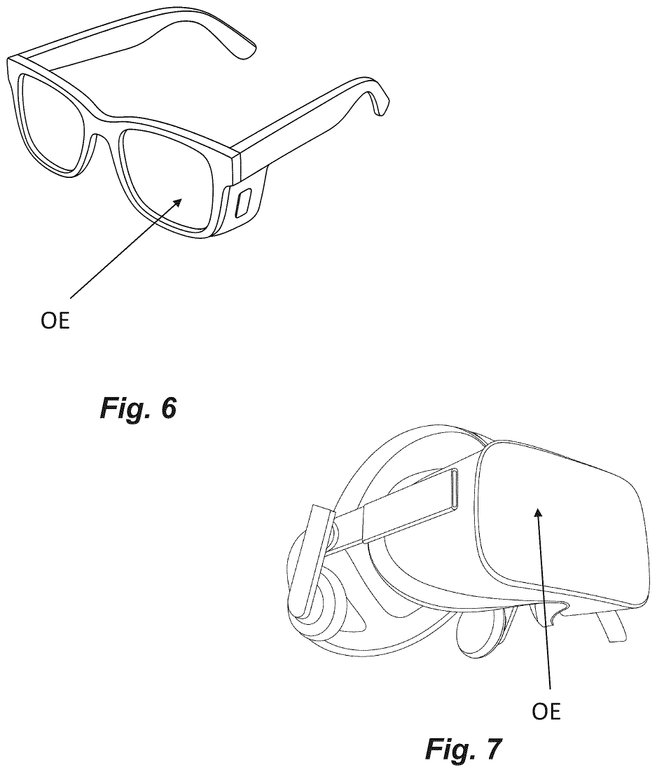

Non-limiting examples of a respective AR device and/or VR device generally comprise portable AR devices and/or VR devices, head-worn AR devices and/or VR devices, head-mounted AR devices and/or VR devices, etc. More concrete, yet still non-limiting examples of a respective AR device and/or VR device comprise glasses, particularly smart glasses, headsets, smartphones, tablets, laptops, televisions, particularly smart televisions, etc. Exemplary embodiments of an AR device and/or a VR device are provided in the principle drawings of FIGS. 6 and 7.

The apparatus 10 is configured for volumetric printing at least one optical element OE for an AR device and/or a VR device by dual-color photopolymerization of a photocurable resin 20 and comprises an irradiation device 30 for performing an irradiation process of irradiating a photocurable resin 20 with light L1 of a first wavelength and light L2 of a second wavelength, different from the first wavelength, to form, by dual-color photopolymerization, at least one optical element OE in at least one direction. The direction is indicated by arrow P1 in FIG. 1 and can be or comprise the formation direction of at least one optical element OE to be printed. As is apparent from FIG. 1, the light L1 of the first wavelength and the light L2 of the second wavelength intersect in a formation zone FZ.

The light L1 of the first wavelength can comprise a light sheet comprising a plurality of light beams extending through the photocurable resin 20. Respective light beams can intersect in one or more intersection points; respective intersection points can be (substantially) arranged in a common plane which can form a light plane. Additionally or alternatively, respective light beams can comprise a light plane, for instance. A light plane can be or comprise a light plane in which the or a plurality of light beams, particularly (substantially) parallel light beams, extend adjacent such that there is no intermediate space between directly adjacent light beams. Notably, at least some of the directly adjacent light beams can also partially overlap. Alternatively, a light plane can be or comprise a light plane in which the or a plurality of light beams extend adjacent such that there is an intermediate space between directly adjacent light beams. Respective light beams can be generated by a directed light emission device, such as e.g. a laser device, which can form part of an irradiation device of a volumetric printing apparatus used for implementing the method, for instance.

The light L2 of the second wavelength can comprise a projection of images corresponding to a cross-sectional geometry of the at least one optical element OE to be printed or a plurality of points or lines corresponding to a cross-sectional geometry of the at least one optical element OE to be printed. Respective points or lines can form a pattern, such as e.g. a hatch pattern. A respective projection can be generated by a light projection device, such as e.g. a digital light projection device, which can form part of an irradiation device of a volumetric printing apparatus used for implementing the method. The light projection device can be or comprise a digital micromirror device (DMD) or a liquid-crystal display (LCD) configured to generate the different images corresponding to a cross-sectional geometry of an optical element which can form part of the irradiation device 30 of the apparatus 10. Additionally or alternatively, a respective point or line can be generated by a directed light emission device, such as e.g. a laser device, which can form part of the irradiation device 30 of the apparatus 10. Both the light projection device and the directed light emission device can be examples of a second irradiation apparatus 32 as will be explained further below.

The apparatus 10 comprises a hardware- and/or software-embodied controller 40 configured to spatially and/or temporally vary at least one printing parameter, particularly a printing parameter influencing the curing (behavior) of the photocurable resin 20, during the irradiation process.

The apparatus 10 can be or comprise a volumetric 3d-printing apparatus, particularly a xolography apparatus, i.e. an apparatus configured to perform the base principles of xolography. The base principles of xolography are specified in WO 2020/245456 A1, the contents of which are incorporated herein by reference. Likewise, the apparatus 10 can be or comprise an apparatus configured to implement a so-called, computed axial lithography, CAL, process, for instance. Likewise, the apparatus 10 can be or comprise an apparatus as specified in WO2024163474A1, the contents of which are incorporated herein by reference. Likewise, the apparatus can be or comprise an apparatus configured to implement cone beam lithography or parallax manufacturing as specified above.

The apparatus 10 can comprise a container 50 for receiving photocurable resin 20. The container 50 delimits a container volume 51 which can comprise a working volume in which at least one optical element can be printed. One or more walls of the container 50 can be made of a material which enables irradiating the photocurable resin inside the container 50 with the light L1, L2 of the first and the second wavelength. A respective material can thus be a transparent material with respect to the light L1, L2 of the first and second wavelength. A respective transparent material can be or comprise glass or a polymer, such as e.g. polycarbonate, polymethylmethacrylate, cyclic olefin polymer, or cyclic olefin copolymer, for instance.

The container 50 can be moveably supported in at least one direction (indicated by double-arrow P2 in FIG. 1) e.g. via an associated drive device 60, e.g. an electric motor. As is apparent from FIG. 1, the at least one direction can be or comprise the formation direction of a respective optical element to be printed. The drive device 60 could also be associated with a first irradiation apparatus 31 of the irradiation device 30 of the apparatus 10 to move the first irradiation apparatus 31 in analogous manner in at least one direction.

The apparatus 10 further comprises the irradiation device 30 which can be a dual-color irradiation device configured to irradiate the photocurable resin inside the container 50 with the light L1, L2 of the first and second wavelength. Particularly, the irradiation device 30 can be configured to simultaneously irradiate the photocurable resin 20 inside the container 50 with the light L1, L2 of the first and second wavelength. The irradiation device 30 can be configured to generate a light sheet from the light L1 of the first wavelength, wherein the light sheet extends in a light sheet plane. Further, the irradiation device 30 can be configured to generate e.g. a light projection from the light L2 of the second wavelength, wherein the light projection intersects with the light sheet at an intersection angle, particularly an intersection angle of (ca.) 90°.

As is apparent from the exemplary embodiment of FIG. 1, the irradiation device 30 can comprise a first irradiation apparatus 31 comprising at least one first light source for generating and emitting the light L1 of the first wavelength and a second irradiation apparatus 32 comprising at least one second light source for generating and emitting the light L2 of the second wavelength.

The first irradiation apparatus 31 can comprise at least one light source configured to generate and irradiate light L1 of the first wavelength towards the photocurable resin 20 to generate a light sheet. The first irradiation apparatus 31 can be built as or comprise a laser or light emitting diode, for instance. The first irradiation apparatus 31 can further comprise at least one optical element which can e.g. comprise at least one of: a Powell-lens, a cylindrical lens, a diffractive optical element, a beam expanding element, a collimating optical element, etc. Additionally or alternatively, the first irradiation apparatus 31 can comprise a light deflection unit, such as e.g. a (moveable, particularly rotatable) mirror, a galvo-scanner, or a polygon scanner, for deflecting light towards the photocurable resin 20. The first irradiation apparatus 31 can be configured to vary the focus or focus parameter, particularly at least one of: the focus position, the focal length, the depth of focus, or the depth of field, of at least one respective first light projection within the working volume. Particularly, the first irradiation apparatus 31 can be configured to vary the focus or at least one focus parameter with respect to the size of the formation zone. The first irradiation apparatus 31 can comprise one or more controllers configured to vary the focus or a focus parameter, particularly at least one of: the focus position, the focal length, the depth of focus, or the depth of field, of at least one respective first light projection within the working volume. Additionally or alternatively, the first irradiation apparatus 31 can comprise one or more optical elements, such as e.g. lenses, particularly adaptable or adjustable lenses, which are configured to vary the focus or a focus parameter, particularly at least one of: the focus position, the focal length, the depth of focus, or the depth of field, of at least one respective first light projection within the working volume. The light L1 generated by the first irradiation apparatus 31 can comprise a wavelength in the range of: 350 nm-500 nm, particularly 375 nm-450 nm, more particularly 385 nm-440 nm, more particularly 395 nm-420, more particularly 400 nm-410 nm, for instance. The light L1 of the first wavelength can comprise a spectrum of wavelengths, particularly at least partly covering the respective ranges. As an example, the first wavelength can be ca. 375 nm. Typically, the first wavelength will be chosen at least under consideration of the photochemical properties, particularly the photochromic properties, of molecules of a photoinitiator of the photocurable resin 20.

The second irradiation apparatus 32 can comprise at least one second light source configured to continuously emit images of light L2 of the second wavelength towards the photocurable resin 20, wherein each image can correspond to a specific cross-section of at least one optical element OE to be printed, or a plurality of points or lines corresponding to a cross-sectional geometry of at least one optical element OE to be printed. The second irradiation apparatus 32 can be built as or comprise an image projection device, particularly a digital light projection device, or a directed light emission device, for instance. The second irradiation apparatus 32 can further comprise one or more light projection optics. The second irradiation apparatus 32 can thus generate image elements, such as e.g. voxels, having a specific focus and/or size, for instance. The second irradiation apparatus 32 can be configured to change the size of at least one image of the projection of images or of at least one image element, such as e.g. a pixel, of at least one image of the projection of images. The second irradiation apparatus 32 can comprise one or more controllers configured to change the size of at least one image of the projection of images or of at least one image element, such as e.g. a pixel, of at least one image of the projection of images. Additionally or alternatively, the second irradiation apparatus 32 can comprise one or more optical elements, such as e.g. lenses, which are configured to change the size of at least one image of the projection of images or of at least one image element, such as e.g. a pixel, of at least one image of the projection of images. The light L2 emitted or irradiated by the second irradiation apparatus 32 can comprise a wavelength in the range of: 400 nm-1000 nm, particularly 425-750 nm, more particularly 450-675 nm, more particularly 500-650 nm, for instance. The light L2 of the second wavelength can comprise a spectrum of wavelengths, particularly at least partly covering the respective ranges. Typically, the second wavelength will be chosen at least under consideration of the photochemical properties, particularly the photochromic properties, of molecules of a photoinitiator of the photocurable resin 20.

As is apparent from above, the irradiation device 30 can be generally configured to irradiate the light L1 of the first wavelength at a first angle, particularly an angle of 0-180°, and the light L2 of the second wavelength at a second angle, particularly an angle of 0-180°, relative to the extension direction of the light L1 of the first wavelength. Respective angles can particularly, range between 15 and 165°, more particularly between 3° and 150°, more particularly between 9° and 150° or between 3° and 90°. Particularly, the light L2 of the second wavelength can intersect the light L1 of the first wavelength at an angle of 90° (as is exemplarily shown in FIG. 1).

Irradiating the photocurable resin 20 with the light L1 of the first wavelength can cause one or more photoinitiator molecules of the photocurable resin 20 to transfer from an initial state into an intermediate state with changed optical properties compared to the initial state, such that the molecules of the one or more photoinitiators in the intermediate state can absorb the light L2 of the second wavelength which results in that the molecules of the one or more photoinitiators are transferred from the intermediate state to a reactive state by absorption of light L2 of the second wavelength which locally triggers the polymerization of the photocurable resin 20 to form at least one optical element OE.

The photocurable resin 20 can be a photocurable monomer resin or a photocurable oligomer resin, which may include acrylates, methacrylates, thiol+ene, epoxides, oxiranes, oxetanes, or for vinylethers, instance. Multi-color photopolymerization can comprise multi-photon photopolymerization, particularly dual-photon photopolymerization, of the photocurable resin 20. Photopolymerization of the photocurable resin 20 is thus, effected by irradiating the photocurable resin 20 with the light L1 of the first wavelength and, particularly simultaneously, the light L2 of the second wavelength which results in that molecules of the one or more photoinitiators of the photocurable resin 20 are converted, e.g., due to the absorption of the light L1 of the first wavelength, from an initial state in which the molecules of the one or more photoinitiators (substantially) do not absorb the light L2 of the second wavelength, into an intermediate state with changed optical properties compared to the initial state, such that the molecules of the one or more photoinitiators in the intermediate state absorb the light L2 of the second wavelength which results in that the molecules of the one or more photoinitiators are transferred from the intermediate state to a reactive state which locally triggers the polymerization of the photocurable resin 20 to form at least one three-dimensional object. Suitable photoinitiators of a respective photocurable resin 20 are e.g. known from U.S. Pat. No. 5,230,986A, WO2020245456A1, WO2023034398A1, WO2023034402A1, WO2023220461A1, WO2023220463A1, the contents of which are incorporated herein by reference.

Further exemplary suitable photocurable resins comprise photocurable resins that are based on or comprise at least one of: an acrylate, particularly a phenol-based acrylate, more particularly a bisphenol-based acrylate, a urethane, particularly a thio-urethane, a carbonate, an aromatic, or a thiol, particularly a thiol-ether or a thiol-diether.

Generally, the at least one optical element OE can be made from a photocurable resin which exhibits only a small change of its optical properties, such as particularly its absorptive, refractive, diffractive, or transmissive properties, or (substantially) no change of its optical properties, such as particularly its absorptive, refractive, diffractive, or transmissive properties during the polymerization of the photocurable resin during the volumetric printing process. More particularly, the at least one optical element can be made from a photocurable resin which exhibits a maximum change of 10% its optical properties during the polymerization of the photocurable resin during the volumetric printing process. The degree of change of the respective optical properties can be measured via digital light scattering, for example.

As such, the at least one optical element OE can be made from a photocurable resin can comprise at least one halogenated monomer, for example. The at least one halogenated monomer can comprise at least one acrylic or methacrylic group and halogenated monomer having a C₆-C₂₀ backbone, preferably C₆-C₁₂ aryl, more preferably a halogenated phenyl. The halogenated aryl can comprise at least one, preferably at least two, more preferably at least three halogen atoms. The halogen atoms can be Brom-atoms or lodine-atoms, preferably lodine-atoms. Further, at least one halogenated monomer can comprise at least two acrylic or methacrylic groups.

Particularly, the at least one optical element can be made from a photocurable resin which exhibits only a small degree of hazing or no hazing during the polymerization of the photocurable resin during the volumetric printing process. More particularly, the at least one optical element can be made from a photocurable resin which exhibits only a degree of hazing during the polymerization of the photocurable resin, wherein the degree of hazing before the polymerization differs from the degree of hazing after the polymerization not more than 10%. The degree of hazing can be measured via digital light scattering, for example.

Particularly, the at least one optical element can be made from a photocurable resin which exhibits only a small degree of polymerization-induced phase separation or no polymerization-induced phase separation during the polymerization of the photocurable resin during the volumetric printing process. More particularly, the at least one optical element can be made from a photocurable resin which exhibits small degree of polymerization-induced phase separation during the polymerization of the photocurable resin, wherein the degree of hazing before the polymerization differs from the degree of polymerization-induced phase separation after the polymerization not more than 10%. The degree of polymerization-induced phase separation can be measured via digital light scattering, for example.

Particularly, the at least one optical element can be made from a photocurable resin which has a refractive index of at least 1.30, particularly at least 1.32, more particularly at least 1.34, more particularly at least 1.36, more particularly at least 1.38, more particularly at least 1.40, more particularly at least 1.42, more particularly at least 1.44, more particularly at least 1.46, more particularly at least 1.48, more particularly at least 1.50, more particularly at least 1.52, more particularly at least 1.54, more particularly at least 1.56, more particularly at least 1.58, more particularly at least 1.59. The refractive index can be measured with any suitable refractometer, for instance.

As such, the at least one optical element which has been manufactured in accordance with the method described herein can generally comprise a refractive index of at least 1.30, particularly at least 1.31, more particularly at least 1.32, more particularly at least 1.33, more particularly at least 1.34, more particularly at least 1.35, more particularly at least 1.36, more particularly at least 1.37, more particularly at least 1.38, more particularly at least 1.39, more particularly at least 1.40, more particularly at least 1.41, more particularly at least 1.42, more particularly at least 1.43, more particularly at least 1.44, more particularly at least 1.45, more particularly at least 1.46, more particularly at least 1.47, more particularly at least 1.48, more particularly at least 1.49, more particularly at least 1.50, more particularly at least 1.51, more particularly at least 1.52, more particularly at least 1.53, more particularly at least 1.54, more particularly at least 1.55, more particularly at least 1.56, more particularly at least 1.57, more particularly at least 1.58, more particularly at least 1.59. Alternatively, the at least one optical element which has been manufactured in accordance with the method described herein can generally comprise a refractive index of at most 1.30. The aforementioned values can, mainly depend on the photocurable resin processed in the volumetric printing process, and can relate to the optical element after completion of the volumetric printing process, or can relate to the optical element after completion of a post-processing process which is done after completion of the volumetric printing process.

Particularly, the at least one optical element can be made from a photocurable resin which comprises properties, particularly mechanical properties, optical properties, thermal properties, water absorption properties, etc., of known injection molding materials, such as cyclic olefin polymers, cyclic olefin copolymers, polycarbonates, polymethylmethacrylates, polyesters, etc., or articles molded therefrom. Particularly, the photocurable resin processed in the volumetric printing process can comprise high mechanical properties, such as e.g. high tensile strength, combined with high optical properties, such as e.g. high transmission, low birefringence, etc. The same applies to the at least one optical element manufactured in accordance with the method.

Particularly, the at least one optical element can exhibit birefringence lower than 0,1, particularly lower than 0,075, more particularly lower than 0,05, more particularly lower than 0,025, more particularly lower than 0,01, more particularly lower than 0.001, more particularly lower than 0,0001, more particularly lower than 0,00001, more particularly substantially zero. Likewise, the at least one optical element manufactured with the method can exhibit birefringence lower than 0,1, particularly lower than 0,075, more particularly lower than 0,05, more particularly lower than 0,025, more particularly lower than 0,01, more particularly lower than 0.001, more particularly lower than 0,0001, more particularly lower than 0,00001, more particularly substantially zero. The aforementioned values relate to the maximum difference between the two refractive indices exhibited by the photocurable resin.

Particularly, the at least one optical element exhibits birefringence lower than 50 nm/cm, particularly lower than 30 nm/cm, more particularly lower than 10 nm/cm, more particularly lower than 5 nm/cm, more particularly lower than 2 nm/cm, more particularly lower than 1 nm/cm, more particularly lower than 0.5 nm/cm, more particularly lower than 0.1 nm/cm, more particularly substantially zero.

Particularly, the at least one optical element can be made from a photocurable resin which contains sulfur or a sulfur-compound of at least 5 wt.-%, particularly of a least 10 wt.-%, more particularly of at least 15 wt.-%, more particularly of at least 20 wt.-%, more particularly of at least 25 wt.-%. A respective sulfur content of at least 5 wt.-%, particularly of a least 10 wt.-%, more particularly of a least 15 wt.-%, more particularly of a least 20 wt.-%, more particularly of a least 25 wt.-%, which was surprisingly identified as having a positive effect on the properties, particularly optical properties, of the at least one optical element manufactured with the method.

Particularly, the at least one optical element can contain sulfur of at least 5 wt.-%, particularly of a least 10 wt.-%, more particularly of at least 15 wt.-%, more particularly of at least 20 wt.-%, more particularly of at least 25 wt.-%. A respective sulfur content of at least 5 wt.-%, particularly of a least 10 wt.-%, more particularly of a least 15 wt.-%, more particularly of a least 20 wt.-%, more particularly of a least 25 wt.-%, which was surprisingly identified as having a positive effect on the properties, particularly optical properties, of the at least one optical element manufactured with the method.

Particularly, the at least one optical element can be made from a photocurable resin which can comprise at least one additive which enhances one or more optical properties of the at least one optical element.

Generally, the at least one additive can be or comprise a solid. Particularly, the at least one additive can comprise particles. As such, the at least one additive can be or comprise a particulate material which can e.g. ease preparing, e.g. by stirring, a mixture—a respective mixture can be a colloid or a dispersion, for instance—of the photocurable resin and the at least one additive with a desired distribution of the additive particles within the photocurable resin. A desired distribution is typically a homogenous distribution of the additive particles within the photocurable resin.

As an example, respective particles of the at least one additive can comprise at least one of the following shapes: a spherical shape or a non-spherical shape, particularly a plate-like shape or a longitudinal shape or an ellipsoid shape. Also the shape of the particles can be (in addition to other parameters such as e.g. its type, chemistry, size, etc.) a parameter for influencing and customizing, respectively, the properties of an optical element to be printed and will thus, be typically selected with respect to a concrete intended use of the optical element to be printed.

As an example, respective particles of the at least one additive can comprise a spatial extension of less than 100 nm, particularly less than 90 nm, more particularly less than 80 nm, more particularly less than 70 nm, more particularly less than 60 nm, more particularly less than 50 nm, more particularly less than 40 nm, more particularly less than 30 nm, more particularly less than 20 nm, more particularly less than 10 nm, more particularly less than 7.5 nm, more particularly less than 5 nm, more particularly less than 1 nm. The expression “spatial extension” can depend on the shape or base shape, respectively of the respective particles. For particles having a spherical shape or spherical base shape, respectively, the expression “spatial extension” can refer to a diameter, particularly a mean diameter, for particles having an ellipsoid shape or ellipsoid base shape, respectively, the expression “spatial extension” can refer to the long diameter or the short diameter, particularly the long diameter, of the particles. For particles having a plate-like shape or plate-like base shape, respectively, having a longitudinal axis, the expression “spatial extension” can refer to an extension along the longitudinal axis. For particles having a longitudinal shape or longitudinal base shape, respectively, the expression “spatial extension” can refer to an extension along the longitudinal axis of a respective particle or to the maximum distance between the edges of a respective particle.

Specifically, the particles of the at least one additive can be or comprise nano-particles which can be of advantage for the at least one irradiation process as issues with undesired interactions of the light with the at least one inorganic additive can be avoided. As such, the size of the particles can generally, be in the nanometer-range.

Particularly, the at least one additive can be or comprise at least one of the following: one or more nano-particles, particularly functionalized nano-particles, to increase the refractive index of the photocurable resin, one or more UV-blocking agents, particularly one or more UV-blocking particles, for example. More particularly, the at least one optical element can be made from a photocurable resin which can comprise at least one additive which increases the refractive index and/or which increases the Abbe number of the at least one optical element. The at least one additive which increases the refractive index and/or which increases the Abbe number can be or comprise nano-particles.

As an example, the at least one additive can be or comprise a material having a refractive index of at least 1.30, particularly at least 1.31, more particularly at least 1.32, more particularly at least 1.33, more particularly at least 1.34, more particularly at least 1.35, more particularly at least 1.36, more particularly at least 1.37, more particularly at least 1.38, more particularly at least 1.39, more particularly at least 1.40, more particularly at least 1.41, more particularly at least 1.42, more particularly at least 1.43, more particularly at least 1.44, more particularly at least 1.45, more particularly at least 1.46, more particularly at least 1.47, more particularly at least 1.48, more particularly at least 1.49, more particularly at least 1.50, more particularly at least 1.51, more particularly at least 1.52, more particularly at least 1.53, more particularly at least 1.54, more particularly at least 1.55, more particularly at least 1.56, more particularly at least 1.57, more particularly at least 1.58, more particularly at least 1.59, in a wavelength range between 400 nm and 800 nm, particularly between 450 nm and 700 nm, more particularly between 480 nm and 650 nm, for instance. The refractive index can be measured with any suitable refractometer, for instance.

As another example, the at least one additive can be or comprise a material having an Abbe number of at least 0.3, particularly of at least 0.4, more particularly of at least 0.5, more particularly of at least 0.6, in a wavelength range between 400 nm and 800 nm, particularly between 450 nm and 700 nm, more particularly between 480 nm and 650 nm, for instance.

Generally, the at least one optical can be made from a photocurable resin which can comprise at least one additive which is present an amount of at least 5 wt.-%, particularly at least 10 wt.-% more particularly at least 15 wt.-%, more particularly at least 20 wt.-%, more particularly at least 25 wt.-%, more particularly at least 30 wt.-%, more particularly at least 35 wt.-%, more particularly at least 40 wt.-%, more particularly at least 45 wt.-%, more particularly at least 50 wt.-%, more particularly at least 55 wt.-%, more particularly at least 60 wt.-%, more particularly at least 65 wt.-%, more particularly at least 70 wt.-%, more particularly at least 75 wt.-%, more particularly at least 80 wt.-%, more particularly at least 85 wt.-%, more particularly at least 90 wt.-%, for example. The aforementioned values can form part of lower or upper thresholds of one or more intervals.

The at least one additive can be or comprise a dielectric material, a semiconducting material, or metal oxide material, for example. Exemplary materials can include, but are not limited to: titanium dioxide (TiO₂), silicon (Si), silicon oxide (SiO₂), germanium (Ge), gallium phosphide (GaP), gallium arsenide (GaAs), zirconium dioxide (ZrO₂), aluminum gallium arsenide (AlₓGa₁₋ₓAs), tellurium (Te).

The at least one additive can comprise at least one functionalization which hinders or at least reduces agglomeration and/or aggregation of the at least one additive. Notably, the at least one additive can be or comprise a particulate material, particularly a nano-particulate material. As such, a respective functionalization can hinder or at least reduce agglomeration and/or aggregation of respective particles. An example of a respective functionalization is the provision of a coating, particularly molecules or molecule structures, to the surface of respective particles which hinder or at least reduce the agglomeration or aggregation of the particle with other particles.

Generally, the at least one additive can be present within the photocurable resin 20 in an amount ranging between 0.1 and 75 wt.-%, particularly in an amount ranging between 0.1 and 50 wt.-%, particularly in an amount ranging between 0.1 and 25 wt.-%. As indicated above, the amount of the inorganic additive can be (in addition to other parameters such as e.g. its type, chemistry, shape, size, etc.) a parameter for influencing and customizing, respective, the properties of the optical element OE to be printed and will thus, be typically selected with respect to a concrete intended use of the optical element OE to be printed.

Generally, the at least one additive can be or comprise a solid. Particularly, the at least one additive can comprise particles. As such, the at least one additive can be or comprise a particulate material which can e.g. ease preparing, e.g. by stirring, a mixture—a respective mixture can be a colloid or a dispersion, for instance—of the photocurable resin 20 and the at least one inorganic additive with a desired distribution of the inorganic additive particles within the photocurable resin 20. A desired distribution is typically a homogenous distribution of the additive particles within the photocurable resin 20.

As an example, respective particles of the at least one additive can comprise at least one of the following shapes: a spherical shape or a non-spherical shape, particularly a plate-like shape or a longitudinal shape or an ellipsoid shape. Also the shape of the particles can be (in addition to other parameters such as e.g. its type, chemistry, size, etc.) a parameter for influencing and customizing, respectively, the properties of an optical element OE to be printed and will thus, be typically selected with respect to a concrete intended use of the optical element OE to be printed.

As an example, respective particles of the at least one additive can comprise a spatial extension of less than 10 μm, particularly less than 9 μm, more particularly less than 8 μm, more particularly less than 7 μm, more particularly less than 6 μm, more particularly less than 5 μm, more particularly less than 4 μm, more particularly less than 3 μm, more particularly less than 2 μm, more particularly less than 1 μm, more particularly less than 100 nm, more particularly less than 10 nm, more particularly less than 1 nm. The expression “spatial extension” can depend on the shape or base shape, respectively of the respective particles. For particles having a spherical shape or spherical base shape, respectively, the expression “spatial extension” can refer to a diameter, particularly a mean diameter, for particles having an ellipsoid shape or ellipsoid base shape, respectively, the expression “spatial extension” can refer to the long diameter or the short diameter, particularly the long diameter, of the particles. For particles having a plate-like shape or plate-like base shape, respectively, having a longitudinal axis, the expression “spatial extension” can refer to an extension along the longitudinal axis. For particles having a longitudinal shape or longitudinal base shape, respectively, the expression “spatial extension” can refer to an extension along the longitudinal axis of a respective particle or to the maximum distance between the edges of a respective particle.

Specifically, the particles of the at least one additive can also be or comprise nano-particles which can be of advantage for the at least one irradiation process as issues with undesired interactions of the light L1, L2 with the at least one additive can be avoided. As such, the size of the particles can be in the nanometer-range.

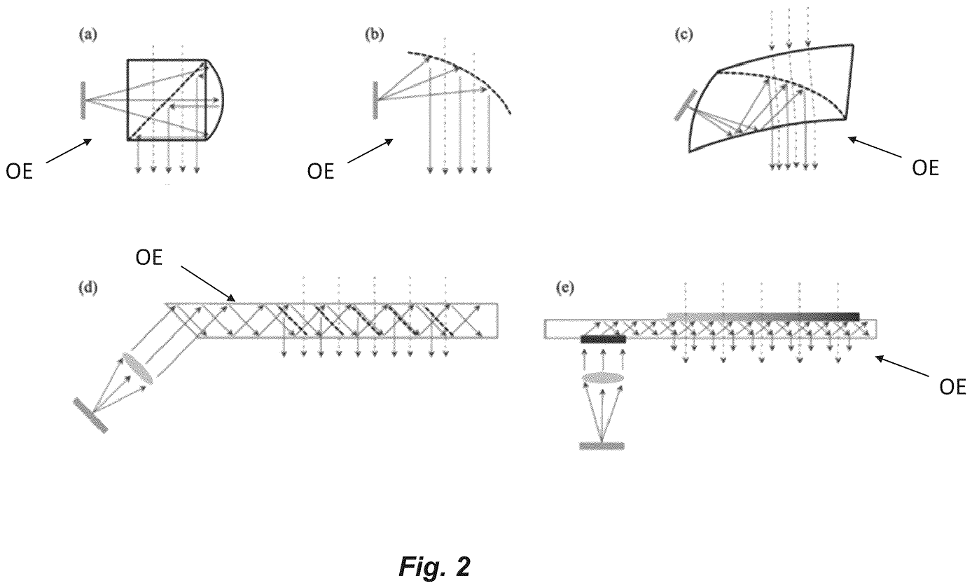

FIGS. 2 and 3 each illustrate principle drawings showing an exemplary embodiment of an optical element OE which can be manufactured with the apparatus 10 and with a method for volumetric printing implemented with the apparatus 10, respectively.

The exemplary embodiments of FIG. 2 show that optical element OE can be, comprise, or form part of at least one of the following: a prism formed of two polygons (see view (a) of FIG. 2), a curved mirror (see view (b) of FIG. 2), a prism formed of two elements having curved surfaces (see view (c) of FIG. 2), a light guide element (see view (d) of view (e) of FIG. 2). Notably, in the exemplary embodiments of FIG. 2, the optical element OE can be used as a glass of an AR device and/or a VR device.

The arrows shown in views (a) to (e) of FIG. 2 indicate exemplary propagation paths of light and exemplary deflections via the respective optical elements OE. Notably, the dotted lines indicate light which propagates through the respective optical element OE without deflection, whereas the non-dotted lines indicate light which is reflected at at least one surface of the respective optical element OE.

The exemplary embodiments of FIG. 3 show that the optical element OE can be, comprise, or form part of at least one of the following optical lenses: a converging lens, such as e.g. a biconvex lens (see view (a) of FIG. 3), a plano-convex lens (see view (b) of FIG. 3), a positive meniscus lens (see view (c) of FIG. 3), or a diverging lens, such as e.g. a negative meniscus lens (see view (d) of FIG. 3), a plano-concave lens (see view (e) of FIG. 3), a biconcave lens (see view (f) of FIG. 3).

Particularly, the at least one optical element OE which can be manufactured in accordance with the method described herein is, comprises, or forms part of at least one of the following: an optical lens of a light beam source of a respective AR device and/or VR device, an optical lens of a light image source of a respective AR device and/or VR device, an optical lens of a light sensor, such as e.g. a camera, etc.

A respective optical lens can e.g. have at least one of the following dimensions: a maximum diameter ranging between 1-100 mm, a maximum thickness ranging between 0,1-10 mm, a maximum radius of curvature ranging between 50-1100 mm.

Typically, the dimensions of the at least one optical lens will be determined by an intended application and/or an intended use of the at least one optical lens and thus, based on the actual constructive and/or functional configuration of an AR device and/or VR device equipped with or to be equipped with the at least one optical lens. As an example, for an optical lens to be used in an optical sensor device, such as e.g. a camera, the maximum diameter of the optical lens can be 10 mm, for example. As another example, for an optical lens to be used in a light image source, such as e.g. a light projector device, the maximum diameter of the optical lens can be 20 mm, for example. As another example, for an optical glass to be used in smart glasses, the maximum diameter of the optical glass can be 80 mm, for example. Similarly, the thickness of the at least one optical element and particularly, the thickness of a respective optical lens, respectively will typically depend from the actual configuration of the at least one optical element and from the optical properties, particularly the refractive index, of the material forming the at least one optical element. As an example, the at least one optical element, particularly a respective optical lens, can have a thickness ranging between 0.25 mm-25 mm.

The at least one optical element OE which can be manufactured in accordance with the method can generally have a high transmission (optical transmission) in a wavelength range between 400 nm and 800 nm, particularly between 450 nm and 700 nm, more particularly between 480 nm and 650 nm. Particularly, the at least one optical element which can be manufactured in accordance with the method described herein can have a transmission (optical transmission) of at least 70%, particularly of at least 71%, more particularly of at least 72%, more particularly of at least 73%, more particularly of at least 74%, more particularly of at least 75%, more particularly of at least 76%, more particularly of at least 77%, more particularly of at least 78%, more particularly of at least 79%, more particularly of at least 80%, more particularly of at least 81%, more particularly of at least 82%, more particularly of at least 83%; more particularly of at least 84%, more particularly of at least 85%, more particularly of at least 86%, more particularly of at least 87%, more particularly of at least 88%, more particularly of at least 89%, more particularly of at least 90%, more particularly of at least 91%, more particularly of at least 92%, more particularly of at least 93%; more particularly of at least 94%, more particularly of at least 95%, more particularly of at least 96%, more particularly of at least 97%, more particularly of at least 98%, more particularly of at least 99%, in a wavelength range between 400 nm and 800 nm, particularly between 450 nm and 700 nm, more particularly between 480 nm and 650 nm, for instance. The aforementioned values can form part of lower or upper thresholds of one or more intervals.

The optical properties, particularly the resulting transmission properties, of the at least one optical element OE after completion of the volumetric printing process via the apparatus 10 may comprise a high transparency in the visible wavelength range. Hence, the at least one optical element OE can show no or only little absorption in the visible wavelength range after completion of the volumetric printing process. Transparency in the visible wavelength range typically means that the transmission of the at least one optical element in the visible wavelength range is above 80% and/or that the absorbance of the at least one optical element in the visible wavelength range is below 0.5, particularly below 0.4, more particularly below 0.3. The absorption and/or transmission of the at least one optical element object can generally be determined/measured with a UV-Vis-NIR spectrophotometer of the type “Cary 50” available from Agilent Technologies, Inc., for instance.

Further, at least one optical element OE which can be manufactured in accordance with the method can generally have a relatively high Abbe number in a wavelength range between 400 nm and 800 nm, particularly between 450 nm and 700 nm, more particularly between 480 nm and 650 nm. Particularly, the at least one optical element OE can have an Abbe number of at least 0.3, particularly of at least 0.4, more particularly of at least 0.5, more particularly of at least 0.6, in a wavelength range between 400 nm and 800 nm, particularly between 450 nm and 700 nm, more particularly between 480 nm and 650 nm, for instance. The aforementioned values can form part of lower or upper thresholds of one or more intervals. The Abbe number of the at least one optical element object OE can generally be determined/measured with any suitable refractometer, for instance.

As is apparent from at least some of the exemplary embodiments of FIGS. 2 and 3, the at least one optical element OE can be, comprise, or form part of a reflective optical element, such as e.g. a mirror, a refractive optical element, or a diffractive optical element. The at least one optical element can thus, have reflective optical properties, refractive optical properties, or diffractive optical properties, for example.

The at least one optical element OE can be formed with a surface structuring, particularly a regular or irregular surface structuring. A respective surface structuring can comprise a regular, partly regular, irregular, or partly irregular arrangement of recessed portions and/or elevated surface portions with respect to reference plane. A respective surface structuring can enable or enhance specific optical properties of the at least one optical element OE. As an example, a respective surface structuring can enable or enhance reflective optical properties, refractive optical properties, or diffractive optical properties of the at least one optical element OE.

As a further example, the at least one optical element OE be, comprise, or form part of an optical deflection element (exemplary embodiments of which are also indicated at least in FIG. 2). A respective optical deflection element comprises at least one deflection surface. The at least one deflection surface can be configured to deflect incident light, such as e.g. an incident light beam. The at least one deflection surface can be formed by at least one coating, structuring, etc. which enables deflecting incident light, such as e.g. an incident light beam. The at least one deflection surface can be, comprise, or form part of a curved surface, particularly a concave or convex surface. Further, the at least one deflection surface can be, comprise, or form part of at least one inclined surface, particularly an inclined surface which is inclined relative to the propagation direction of an incident light beam. An inclination angle of the at least one inclined surface can e.g. be an acute angle or an obtuse angle relative to an axis parallel to the propagation direction of an incident light beam.

As a further example, the at least one optical element OE can be, comprise, or form part, of at least one light splitting element (exemplary embodiments of which are also indicated at least in FIG. 2). The at least one optical element OE can thus, generally have, e.g. based on its shape and/or material, light splitting properties which enable that at least one light beam is split into at least two light beams.

As a further example, the at least one optical element OE can be, comprise, or form part, of at least one light combining element (exemplary embodiments of which are also indicated at least in FIG. 2). The at least one optical element OE can thus, generally have, e.g. based on its shape and/or material, light splitting properties which enable that at least two light beams are combined into at least one light beam.

As a further example, the at least one optical element OE can be, comprise, or form part of a prism (exemplary embodiments of which are also indicated at least in FIG. 2). A prism typically comprises at least two non-parallel surfaces. As a concrete example, a prism can be a triangular prism. A prism having dispersive optical properties (dispersive prism) can be a more concrete example of a light splitting element. A prism having dichroic properties (dichroic prism) can be a more concrete example of a light combining element.

As a further example, the at least one optical element OE can be, comprise, or form part of at least one optical guiding element, particularly a light guiding element (exemplary embodiments of which are also indicated at least in FIG. 2). The at least one optical element OE can thus, generally have, e.g. based on its shape and/or material, light splitting properties which enable that at light can enter at an inlet, propagate therethrough, and exit at an outlet. The at least one optical guiding element can generally, comprise at least one inlet via which light, such as e.g. polarized or non-polarized light, can enter the at least one optical guiding element and at least one outlet via which light that has propagated through the at least one optical guiding element can exit the at least one optical guiding element. The at least one optical guiding element can thus, define, particularly between a respective inlet and a respective outlet, a propagation path along which light can propagate through the at least one optical guiding element.

As a first more concrete example, the at least one optical element OE can be, comprise, or form part of at least one glass of a spectacle (spectacles glass). The spectacle can comprise smart glasses or form part of smart glasses. As such, the method can be used to manufacture glass of a spectacle, wherein the spectacle comprises smart glasses or forms part of smart glasses. A principle drawing of an exemplary embodiment of respective smart glasses is shown in FIG. 6.

A respective glass of a spectacle can e.g. have the following dimensions: a maximum diameter ranging between 1-100 mm, a maximum thickness ranging between 0,1-10 mm, a maximum radius of curvature ranging between 50-1100 mm.

Typically, the dimensions of the at least one glass of a spectacle will be determined by an intended application and/or an intended use of the at least one glass of a spectacle and thus, based on the actual constructive and/or functional configuration of an AR device and/or VR device equipped with or to be equipped with the at least one glass of a spectacle. As an example, for a glass to be used in smart glasses, the maximum diameter of the optical glass can be 80 mm, for example. Similarly, the thickness of the at least one optical element and particularly, the thickness of a respective glass, respectively will typically depend from the actual configuration of the at least one optical element and from the optical properties, particularly the refractive index, of the material forming the at least one optical element. As an example, the at least one optical element, particularly a respective glass, can have a thickness ranging between 0.25 mm-25 mm.

The method can comprise manufacturing two or more optical elements OE for an AR device and/or VR device via the volumetric printing process. The method can thus, comprise performing a volumetric printing process to manufacture at least two optical elements OE for an AR device and/or VR device, wherein the volumetric printing process comprises at least one irradiation process which comprises irradiating a photocurable resin with light of a first wavelength and light of a second wavelength, which is different from the first wavelength, to form at least two optical elements for AR device and/or VR device. The at least two optical elements OE can thus, be formed in the same container 50 and working volume, respectively of a volumetric printing apparatus 10 used for implementing the method. In other words, one single volumetric printing process can be used to manufacture a plurality of optical elements OE for an AR device and/or VR device. Particularly, one single volumetric printing process can be used to manufacture a plurality of optical elements OE forming an optical arrangement, such as e.g. a stacked optical arrangement, of an AR device and/or VR device. This can be beneficial since two, more than two, or all optical elements OE of an optical arrangement an AR device and/or VR device can be manufactured in one single volumetric printing process which can enables a highly efficient manufacturing possibility for manufacturing a respective optical arrangement.

Generally, the at least two optical elements OE which are manufactured in the same volumetric printing process can comprise same or different properties as the properties of the respective optical elements OE manufactured in the same volumetric printing process can be adjusted by deliberately changing one or more printing parameters of the volumetric printing process.

As such, the at least two optical elements OE which are manufactured in the same volumetric printing process can be equal or different e.g. in at least one of the following properties: optical properties, particularly optical absorptive properties with respect to light of a specific wavelength range, transmissive properties with respect to light of a specific wavelength range, reflective properties with respect to light of a specific wavelength range, diffractive properties with respect to light of a specific wavelength range, or refractive properties with respect to light of a specific wavelength range.

As a more concrete example for at least two optical elements OE which have different optical properties, the refractive index of at least a first optical element can be different from the refractive index of at least second optical element. Hence, the refractive index of at least a first optical element can be n1, and the refractive index of at least a second optical element can be n2, wherein n1≥n2+0.01, for instance. As a further example, a first optical element can have a first refractive index n1 and a first Abbe number V1, and a second optical element can have a second refractive index n2 and a second Abbe number V2, wherein n1≥n2 and V2≥V1, for instance. In such a manner, an arrangement of optical elements with outstanding optical properties can be manufactured as possible drawbacks of a first material of a first optical element which has a relatively high refractive index, which is related with an undesired coloring of the first optical element though, can be compensated with a second material of a second optical element which has a relatively high Abbe number.

The at least two optical elements OE can be connected with each other or are isolated from each other. As such, the volumetric printing process can be used to manufacture at least two optical elements OE which are connected with each other (i.e. connected at at least one connection portion, which can e.g. be or comprise a connection point, a connection line, or a connection area) or are isolated from each other (i.e. not connected). Any connection of the at least two optical elements OE can be or comprise a provisional connection, i.e. a connection which is to be later removed, or a non-provisional connection, i.e. a connection which is not to be removed. In either case, a respective connection can enable that the at least two optical elements OE can be provided in a defined spatial arrangement and/or orientation relative to each other. Notably, such a defined spatial arrangement and/or orientation of at least two optical elements OE relative to each other can be the actual spatial arrangement and/or orientation of the at least two optical elements OE as required for a specific AR device and/or VR device. As such, defined stacks of at least two optical elements OE can be manufactured in one single volumetric printing process with respect to a specific AR device and/or VR device, for example.

If two or more optical elements OE are isolated from each other, they can be connected separately, e.g. after completion of the volumetric printing process. A respective connection can be facilitated by chemical or physical connection technique. Examples of a respective chemical connection technique can comprise adhesive connection techniques, i.e. the use of one or more adhesives to connect two or more optical elements OE with each other via one or more adhesives. Respective adhesives can particularly, be or comprise adhesives having a refractive index which is matched with the refractive index of at least one of the at least two optical elements OE. Examples of a respective physical connection technique can comprise mechanical connection techniques, such as e.g. pressing, positive locking, screwing, etc. As such, it is possible to connect two or more optical elements OE to form an arrangement of optical elements OE, particularly a stack of optical elements OE. If two or more optical elements OE of such an arrangement are to be connected with each other, the connection can be established via an adhesive, particularly an adhesive which comprises a refractive index matching the refractive index of at least one of the two or more optical elements OE.

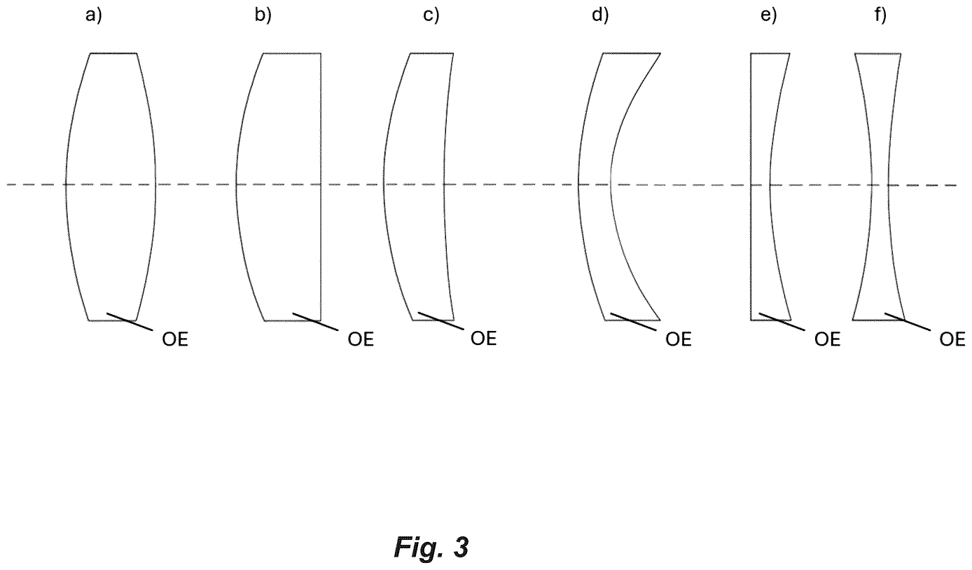

FIG. 4 is a flow diagram of an exemplary method for manufacturing at least one optical element OE for an AR device and/or a VR device.

The exemplary embodiment of the method of FIG. 4 comprises as a first step S1 which comprises performing a volumetric printing process to manufacture at least one optical element for an augmented and/or virtual reality device, wherein the volumetric printing process comprises at least one irradiation process which comprises irradiating a photocurable resin with light of a first wavelength and light of a second wavelength, which is different from the first wavelength, to form at least one optical element for an augmented or virtual reality device. The respective annotations concerning volumetric printing processes provided above can apply to the volumetric printing process of the first step S1.

The exemplary embodiment of the method further comprises a second step S2 which comprises performing a post-processing process. The second step S2 is typically performed after completion of the first step S1. The at least one post-processing process can generally, comprise at least one of: a thermal post-processing step, a mechanical post-processing step, an optical post-processing step, a chemical post-processing step. In the at least one post-processing process, the at least one optical element OE resulting from the first step S1 undergoes at least one measure to change at least one property, particularly at least one of the following properties: the structural properties, particularly the mechanical properties, the optical properties, the thermal properties, the electrical properties, etc. Notably, an optical element OE which directly results from the at least one irradiation process can be a green component (or green body), i.e. an intermediate component which does not exhibit all desired properties of the respective optical element S1 which are required for its intended use for an AR device and/or a VR device. As an example, a respective intermediate component can show lower optical or mechanical properties, such as e.g. lower transmission, higher absorption, lower hardness, lower stiffness, etc., of a respective optical element which are required for its intended use for an AR device and/or a VR device. As such, the at least one post processing process can comprise that the as printed optical element (green component) is turned into a brown component. A respective post-processing process can thus, comprise at least one measure which enables post-curing of the as printed optical element (green component), particularly to transfer it into at least a brown component. A respective measure can comprise at least one of the following: subjecting the as printed optical element to elevated temperatures, e.g. by placing it in a heating device, such as e.g. an oven in which it undergoes post-curing; subjecting the as printed optical element to radiation exposure, e.g. by placing it in at least one radiation device in which it is irradiated with radiation to undergo post-curing; subjecting the as printed optical element to a chemically reactive atmosphere, e.g. by placing it in a chemical reactor in which it can react with a reaction agent to undergo post-curing, etc.

FIG. 4 further shows that the method can comprise at least two post-processing processes, wherein a first post-processing process (see step S2) is carried out which induces a chemical reaction of the photocurable resin which forms the at least one optical element, and thereafter at least one second post-processing process (see optical step S3) is carried which does not induce a chemical reaction of the photocurable resin which forms the at least one optical element. The at least one second post-processing process can be or comprise an additive process in which at least one material is added on at least one surface of the at least one optical element and/or at least one subtractive process in which material is removed from the surface of the at least one optical element. Examples of respective subtractive processes can comprise cutting, machining, such as e.g. milling, grinding, lapping, etc., e.g. to provide a desired surface. A further example of a respective second post-processing process can be a finishing process, such as e.g. a surface finishing process, e.g. by machining, polishing, etc.

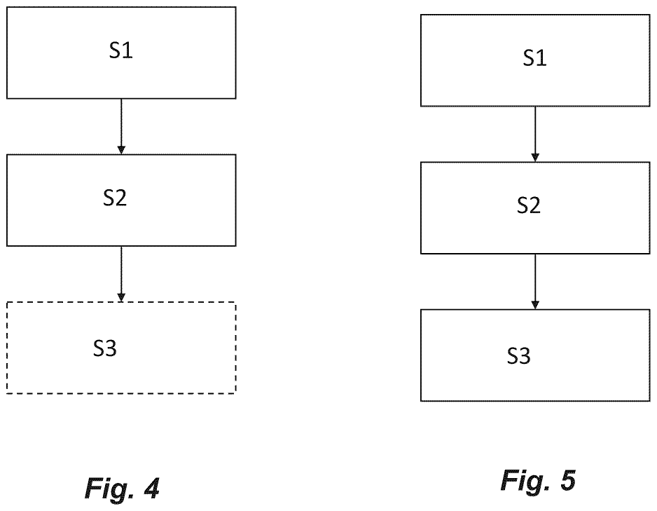

FIG. 5 is a flow diagram of an exemplary method for manufacturing an AR device and/or a VR device.

The exemplary method of FIG. 5 particularly, comprises the steps of: providing at least one optical element manufactured in accordance with the exemplary method of e.g. FIG. 4 (see step S1); providing at least one functional and/or structural element of the AR device and/or VR device (see step S2); and connecting the at least one optical element OE with the at least one functional and/or structural element of the AR device and/or VR device (see step S3). The step of connecting the at least one optical element OE with the at least one functional and/or structural element of the AR device and/or VR device can comprise any connection technique which enables connecting the at least one optical element with the at least one functional and/or structural element of the AR device and/or VR device. Exemplary connection techniques can comprise assembling, molding, fastening, mounting, etc. As such, a respective connection technique can also be or comprise an assembling technique, molding technique, a fastening technique, a mounting technique, etc.

As an example, the at least one functional and/or structural element can be or comprise at least one of: a frame element of an augmented and/or virtual reality device or a part thereof, a light beam source or a part thereof, a light image source of a part thereof, a light outputting element or a part thereof, a display or a part thereof, a light sensor, particularly forming part of a camera, or a part thereof, a light guiding element, such as e.g. a waveguide, or a part thereof, etc.

FIGS. 6 and 7 each show a principle drawing of an AR device and/or a VR device in accordance with an exemplary embodiment.

In the exemplary embodiment of FIG. 6, smart glasses are illustrated as an example of an AR device and/or a VR device. Such smart glasses can comprise one or more optical elements OE manufactured in accordance with the method specified herein.

In the exemplary embodiment of FIG. 7, a head worn example, namely a headset, of an AR device and/or a VR device. Such a headset can comprise one or more optical elements OE manufactured in accordance with the method specified herein. Particularly, at least one optical element OE can be used as a light beam source or part of a light beam source, or a light image source, such as e.g. projection device, or as part of a light image source, or as a light sensor element, particularly forming part of a camera, or as a part of a light sensor element.

The headset may be configured to integrate visual information into a user's field of view to enhance their surroundings or allow them to step into immersive three-dimensional environments. The headset can be utilized for gaming and other entertainment purposes, for purposes outside of recreation, for training simulations, for surgery practice, or as other visualization aids, e.g. in engineering.

One, more, or all aspects mentioned in connection with at least one embodiment can be combined with one, more, or all aspects mentioned in connection with at least one other embodiment.

We claim:

1. A method for manufacturing at least one optical element for an augmented and/or virtual reality device, wherein the method comprises:
performing a volumetric printing process to manufacture at least one optical element for an augmented and/or virtual reality device, wherein the volumetric printing process comprises at least one irradiation process which comprises irradiating a photocurable resin at least with light of a first wavelength to form at least one optical element for an augmented or virtual reality device.

2. The method of claim 1, wherein the at least one optical element has a transmission of at least 70%, particularly at least 80%, more particularly at least 90%, in a wavelength range between 400-800 nm, particularly between 450-700 nm, more particularly between 480-650 nm.

3. The method of claim 1, wherein the photocurable resin or the at least one optical element contains sulfur or a sulfur-compound of at least 5 wt.-%.

4. The method of claim 1, wherein the at least one optical element is, comprises, or forms part of a glass of a spectacle.

5. The method of claim 1, wherein the at least one optical element is, comprises, or forms part of an optical lens, particularly an optical lens of a light beam source or a light image source or an optical lens of a light sensor element, particularly forming part of a camera.

6. The method of claim 1, wherein the at least one optical element exhibits birefringence lower than 0,1, particularly lower than 0,075, more particularly lower than 0,05, more particularly lower than 0,025, more particularly lower than 0,01, more particularly lower than 0.001, more particularly lower than 0,0001, more particularly lower than 0,00001, more particularly substantially zero, wherein values relate to a maximum difference between two refractive indices exhibited by the at least one optical element.

7. The method of claim 1, wherein the at least one optical element exhibits birefringence lower than 50 nm/cm, particularly lower than 30 nm/cm, more particularly lower than 10 nm/cm, more particularly lower than 5 nm/cm, more particularly lower than 2 nm/cm, more particularly lower than 1 nm/cm, more particularly lower than 0.5 nm/cm, more particularly lower than 0.1 nm/cm, more particularly substantially zero.

8. The method of claim 1, comprising manufacturing two or more optical elements, particularly an optical element assembly comprising two or more optical elements, for an augmented and/or virtual reality device via the volumetric printing process.

9. The method of claim 8, wherein at least the two optical elements are connected with each other, particularly via a connection element, more particularly via a connection element having light guiding properties, such as e.g. a waveguide, or wherein at least the two optical elements are isolated from each other.

10. The method of claim 1, wherein the at least one optical element is made from a photocurable resin which comprises a yield strength greater than or equal to 0.1 Pa, in particular 0.2 Pa, more particularly 0.3 Pa, more particularly 0.4 Pa, more particularly 0.5 Pa, more particularly 0.6 Pa, more particularly 0.75 Pa, more particularly 1 Pa.

11. The method of claim 1, wherein the at least one optical element undergoes a post-processing, particularly a post-curing, wherein the optical properties, particularly the scatting properties or the haze of the at least one optical element differs not more than 10% from a state before the post-processing to a state after the post-processing.

12. The method of claim 1, wherein the at least one optical element or a green body preceding the at least one optical element undergoes at least one of the following processes: machining, particularly grinding, polishing, and coating.

13. The method of claim 1, wherein the photocurable resin comprises at least one additive and wherein the at least one additive is or comprises at least one of the following: one or more nano-particles, particularly functionalized nano-particles, to increase a refractive index of the photocurable resin, one or more UV-blocking agents.

14. The method of claim 1, wherein the volumetric printing process comprises at least one of the following: a parallax volumetric manufacturing process, a dual-color volumetric printing process, a computed axial lithography process, wherein optical projections are directed towards a working volume at different angles, and/or wherein a rotating periscope, particularly a periscope rotatable about a propagation axis of the light emitted by the at least one radiation device, is used.

15. The method of claim 1, wherein the first wavelength is at least 400 nm, and/or wherein the photocurable resin is further irradiated with light of a second wavelength, wherein the second wavelength is between 400-800 nm, particularly between 450-700 nm, more particularly between 480-650 nm.

16. The method of claim 1, wherein the volumetric printing process comprises gray-scaling.

17. A use of an optical element manufactured in accordance with the method of claim 1 in an augmented and/or virtual reality device.

18. The use of claim 17, wherein the optical element is used as part of a light beam source or part of a light beam source, or a light image source, such as e.g. projection device, or as part of a light image source, or as a light sensor element, particularly forming part of a camera, or as a part of a light sensor element.

19. The method of claim 1, wherein the method comprises:
a) performing the volumetric printing process to manufacture the at least one optical element on basis of data comprising information of a geometric model of the at least one optical element to be manufactured, wherein the volumetric printing process is performed on basis of a number of process parameters;
b) determining at least one property of the at least one optical element and generating a determination information indicative of the at least one determined property of the at least one optical element;
c) comparing the at least one determined property of the at least one optical element with at least one reference property, particularly a target property, of a reference optical element, particularly a target optical element, and generating a comparison information indicative of a comparison result;
d) determining if the comparison result indicates that a deviation between the determined at least one property of the at least one optical element and the at least one reference property of the reference optical element exceeds a threshold value; and if the comparison result indicates that a deviation between the determined at least one property of the at least one optical element and the at least one reference property of the reference optical element exceeds the threshold value, changing at least one of: at least one parameter of the geometric model of the at least one optical element to be manufactured, at least one process parameter of the volumetric printing process, at least one process parameter of a post-processing process; and
e) repeating steps a)-d) with the changed at least one parameter of the geometric model of the at least one optical element to be manufactured and/or with the changed parameter of the at least one process parameter of the volumetric printing process and/or with the changed parameter of the at least one process parameter of the post-processing process until the comparison result indicates that the deviation between the determined at least one property of the at least one optical element and the at least one reference property of the reference optical element does not exceed the threshold value.

20. A method for manufacturing an augmented and/or virtual reality device, the method comprising the steps of:
providing at least one optical element manufactured in accordance with the method;
providing at least one functional and/or structural element of the augmented and/or virtual reality device; and
connecting the at least one optical element with the at least one functional and/or structural element of the augmented and/or virtual reality device.

21. The method of claim 20, wherein the at least one functional and/or structural element is at least one of: a frame element of an augmented and/or virtual reality device or a part thereof, a light beam source or a part thereof, a light image source or a part thereof, a light outputting element or a part thereof, a display or a part thereof, a light sensor or a part thereof, particularly forming part of a camera, a light guiding element, such as e.g. a waveguide, or a part thereof.

22. The method of claim 21, wherein the augmented and/or virtual reality device is or comprises glasses, a headset, a smartphone, a tablet, a laptop.

23. An apparatus for manufacturing a three-dimensional object via volumetric printing, the apparatus comprising:
a container for receiving a photocurable resin;
a volumetric printing device for performing a volumetric printing process to manufacture at least one optical element wherein the volumetric printing process comprises at least one irradiation process which comprises irradiating a photocurable resin with light of a first wavelength and light of a second wavelength, which is different from the first wavelength, to form at least one optical element; and
a controller.
